(19) United States
(12) Patent Application Publication
(10) Pub. No.: US 2008/0120312 A1
(43) Pub. Date: May 22, 2008

(54) System and Method for Creating a New Title that Incorporates a Preexisting Title

(75) Inventors: Ogden Cartwright Reed, Philadelphia, PA (US); Thomas W. Newbern, Egg Harbor City, NJ (US)

Correspondence Address: TECHNOLOGY, PATENTS AND LICENSING, INC., 2003 South EASTON ROAD, SUITE 208, DOYLESTOWN, PA, 18901, US

(73) Assignee: iofy Corporation

(21) Appl. No.: 11/932,668

(22) Filed: Oct. 31, 2007

Related U.S. Application Data
(63) Continuation-in-part of application No. 11/100,774, filed on Apr. 7, 2005.
(60) Provisional application No. 60/885,687, filed on Jan. 19, 2007.

(51) Int. Cl. G06F 17/30

(52) U.S. Cl. 707/100; 707/E17.143

(57) ABSTRACT

The present invention relates to a system and method for interacting with digital media that permits creating, editing, combining, producing, and using digital media content. In one aspect of the invention, these features are implemented using a “virtual container” or unit that contains structured information. This structured information includes the software, metadata and content required to use the content on a wide array of platforms, without software installations and without required net access or complex DRM interaction. Additional aspects of the invention extend the above described functionality and universality by enabling new ways to use the platform and link interested and connected parties so that consumers can interact with the product, create or mashup new products, or monetize their content.

### CROSS REFERENCE TO RELATED APPLICATION

This application is a continuation-in-part of U.S. patent application Ser. No. 11/100,774; filed Apr. 7, 2005 (Attorney Docket No. IOF-001-1), published Dec. 15, 2005 as Pub. No. US 2005/0276570, entitled Systems, Processes and Apparatus for Creating, Processing and Interacting with Audiobooks and Other Media, the entire disclosure of which is incorporated herein by reference.

This application claims priority to U.S. Patent Application No. 60/885,687; filed Jan. 19, 2007; (Attorney Docket No. IOF-002-PV) entitled A Method, System, and Device for Linking User Generated Data, the entire disclosure of which is incorporated herein by reference.

This application is related to co-pending U.S. patent application Ser. No. ______, entitled A System and Method for Providing Data to be Used in a Presentation on a Device, filed Oct. 31, 2007 Attorney Docket No. IOF-002-1; U.S. patent application Ser. No. ______, entitled A Device and Method for Protecting Unauthorized Data from Being Used in a Presentation on a Device, filed Oct. 31, 2007 Attorney Docket No. IOF-002-2; U.S. patent application Ser. No. ______, entitled An Apparatus and Method for Utilizing an Information Unit to Provide Navigation Features on a Device, filed Oct. 31, 2007 Attorney Docket No. IOF-002-3; U.S. patent application Ser. No. ______, entitled A Device and System for Utilizing an Information Unit to Present Content and Metadata on a Device, filed Oct. 31, 2007 Attorney Docket No. IOF-002-4; U.S. patent application Ser. No. ______, entitled A System and Method for Linking User Generated Data Pertaining to Sequential Content, filed Oct. 31, 2007 Attorney Docket No. IOF-002-5; U.S. patent application Ser. No. ______, entitled A System and Method for Correlating a First Title with a Second Title, filed Oct. 31, 2007 Attorney Docket No. IOF-002-6; and U.S. patent application Ser. No. ______, entitled A System and Method for Offering a Title for Sale Over the Internet, filed Oct. 31, 2007 Attorney Docket No. IOF-002-7, the entire disclosures of which are incorporated herein.

### SUMMARY

The present invention relates to a system and method for interacting with digital media that permits creating, editing, combining, producing, and using digital media content. In one embodiment of the invention, these features are implemented using a “virtual container” or unit that contains structured information. This structured information comprises the software, metadata and content required to use the content on a wide array of platforms, without software installations and without required net access or complex DRM interaction.

In further embodiments, the invention provides extensions of the above described functionality and universality by enabling new ways to use the platform and link interested and connected parties so that consumers can interact with the product, create or mashup new products, or monetize their content.

### DEFINITIONS

As used herein:

“Audiobook” is a recorded spoken audio work. For example, an Audiobook may be a narrated book of fiction or a spoken textbook, magazine, tutorial or other non-fiction book or work.

“CEA2003,” “CEA2003A” and “CEA2003B” are versions of the audiobook metadata standard created by a committee of members of the Consumer Electronics Association and of the Audio Publishers Association.

“Client Application” is software, firmware, or other executable code for playing Content on at least one Player. A Client Application may include one or more of the following: (1) one or more Codecs, (2) software to read and use Metadata, (3) software to Navigate, (4) software to Journal, and (5) software to encrypt the Content and/or Metadata.

“Codec” is a compressor-decompressor for data, including Content.

“Compression Ratio” is the ratio of the size of a digital file before it is compressed to the size of the file after it is compressed.

“Content” is multimedia data which entertains, educates, and/or in general provides information to a user. Examples are an Audiobook, music, games, videos, movies or software.

“Content Chain” is the group of individuals or parties having access (modifiable or non-modifiable) to the Content in the various parts of the creation, distribution, commenting, and sales processes.

“Correlate” means to establish a matching between or among two or more Identifiers or other elements such that the matching results in identification of one or more relationships between the elements or Identifiers.

“Identifier” is a Unique Identifier, Particular Identifier, or other value used for identification purposes.

“Information Unit” is a container in which the Content and Metadata are stored.

“Journaling” is creating a history of the use of Content on a Player. Journaling may include one or more of: (1) time-stamped user interaction with one or more segments of Content; (2) bookmarks; (2) Metadata for the Content; and (3) Scripts based on (1), (2) and (3).

“Memory Card” is a handheld, portable, or miniaturized medium for storing data. Examples of memory Cards are MMC cards, SD cards, SDIO cards or similar devices.

“Metadata” is data about Content. By way of example, in the context of an Audiobook, Metadata may include a table of contents, information about the creation of the Audiobook, publisher data, and author; and in the context of music, Metadata may include information about the composer, genre, arrangement, performer and instrumentation.

“Navigation” is a user's interaction with Content. By way of example, in the context of an Audiobook, user interactions may include movement between pages or chapters, setting bookmarks, and adjusting playback speed. In the context of music, user interactions may include the creation of playlists, adjustment of frequency range (such as increasing the bass), or initiating randomized playback of different musical tracks.

“Particular Identifier” is an alphanumeric or other series of characters which is specific to a category of Storage Devices, Client Applications, Content, or Players such as the identification of (1) the company that manufactures, produces or distributes a given Storage Device, Client Application, Content, or Player and/or (2) the model or serial number for a Storage Device or Player, Client Application, or Content.

“Platform” is a Content storage, mastering and production system.

“Player” is an apparatus for Playing Content for a user. A Player may be dedicated to Playing Audiobooks only, such as the Player 100 described herein, or it may be a multipurpose apparatus, such as a computer, PDA, cellphone, combination PDA/cellphone, MP3 player or other apparatus, whether currently known or created in the future, which includes the capability of Playing Content. A Player may play one or more of Audiobooks, music, games, videos or software.

“Present”, “Presentation”, “Play” or “Playing” means to provide Content, with or without Metadata, to a user, and may optionally include permitting interaction by a user with the Content and associated Metadata, if any. By way of example, Present or Play includes playing an audiobook or music to hear, displaying an e-book to be read, displaying and playing a video to be seen and heard, displaying a video game to be seen, heard and interacted with, etc.

“Script” is list of instructions which define the flow of operations of a Player in response to different user inputs.

“Slices” are Content segments created by Slicing.

“Slicing” is choosing optimal Content segments to be Tokenized.

“Sovereign Link” is a unique and authoritative link for parties in the Content Chain (e.g., author, publisher, renter, customer, etc.) that enables tracking back of at least some Content changes (e.g., those changes in Content that have been defined by the creator of the link as being permitted).

“Storage Device” is any medium for storing data. For example, Storage Devices are Memory Cards, computer hard drives, ROM, floppy disks, DVDs and CDs.

“Stripe” is a section of executable code (e.g. of a Client Application) or of data (e.g., Content) that is used to store a Particular or Unique Identifier.

“Striped” is having been incorporated with a Stripe.

“Striping” is creating a Stripe.

“Title” is the identity of a printed book or other material (an Audiobook could, for example, be based on magazine articles or teaching materials) from which an Audiobook is created. By way of example, “The Bible,” “The Grapes of Wrath” and “Caesar's Gallic Wars” are Titles.

“Token” is a representation of a segment of audio data created by Tokenizing.

“Tokenized” is the past tense of Tokenizing.

“Tokenizing” is the process of replacing data to be stored for later playback with a rule or formula, employed on playback to re-create the data. For example, in an Audiobook, a repeated word or set of words of spoken audio can be replaced by a rule that describes how to recreate the word or set of words. More specifically, if the set of words “He said” is used often in an Audiobook, each occurrence of “he said” in the stored file can be replaced with a Token. It should be noted that silence (absence of spoken words or pauses between words) can also be Tokenized. Tokenizing is used to reduce file size, replacing one file with a smaller (file size) Token.

“Unique Identifier” is an alphanumeric or other series of characters which uniquely identifies a Storage Device, a copy of Content, a copy of a Client Application, or a Player.

“Widget” (or “Web Widget”) is a portable piece of code that can be installed and executed within an HTML-based web page by an end user without requiring additional compilation.

### BRIEF DESCRIPTION OF THE DRAWINGS

FIG. 1a is a front elevation view of a preferred embodiment of A dedicated Audiobook Player of this invention;

FIG. 1b is a perspective view of the rear of a preferred embodiment of the dedicated Audiobook Player of this invention;

FIG. 2 is a front elevation view of an MMC card, a preferred Memory Card for use with this invention;

FIG. 3 is a block diagram showing the generic architecture common to a range of different implementations of an Audiobook processing system;

FIG. 4 is a block diagram of the audio mastering system (AMS) of FIG. 3;

FIG. 5 is one graphical user interface generated by the audio mastering system of FIG. 4 to enable the capture of Metadata information;

FIG. 6 is the packet format for audio data generated by the audiomastering system of FIG. 4;

FIG. 7 is a block diagram of the audio production system (APS) of FIG. 3;

FIG. 8 is a block diagram, showing one preferred implementation of the data stored on the Storage Device of FIG. 3;

FIG. 9 is a block diagram of a preferred implementation of the Audiobook Player of FIG. 3;

FIG. 10 is an optional user interface for the display of the Audiobook Player of FIG. 9;

FIG. 11 is a flow chart showing the Ping Pong algorithm described herein;

FIG. 12 illustrates the manner in which Content and Metadata are stored in one embodiment of the invention;

FIG. 13 is a Use Case Diagram depicting the creation of the Content and Metadata;

FIGS. 14A and 14B depict sequential Content relative to a timeline and how this Content can be accessed;

FIG. 15 illustrates an example of value being added to the Content as data is added to a Title via a Sovereign Link;

FIG. 16 is an Activity Diagram depicting a Title being purchased by a Consumer;

FIG. 17 is an Activity Diagram illustrative various exemplary interactions of various Actors in utilizing the current invention;

FIG. 18 is a top view of an embodiment of a player device according to the present invention;

FIG. 19 is a sleeve into which the player of FIG. 18 can be inserted in a further embodiment of the invention;

FIG. 20 is a ¾ top view of a player/sleeve combination; and

FIG. 21 is a side view of a player/sleeve combination in which a battery compartment area is further illustrated.

### DETAILED DESCRIPTION

### Generic Architecture

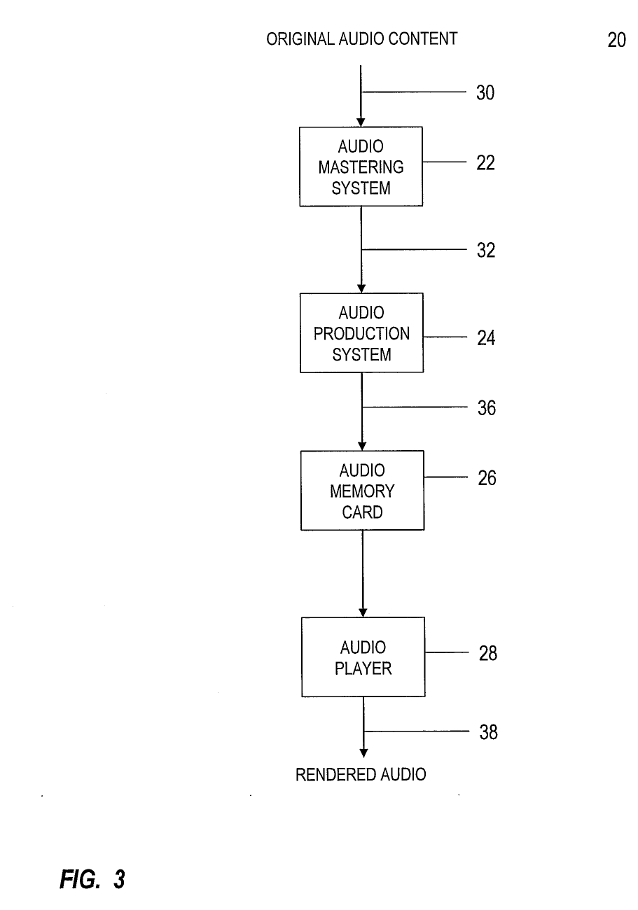

FIG. 3 shows the generic architecture common to a range of different implementations of an Audiobook processing system 20. Subsequent sections of this specification contain descriptions of a possible set of features that may be included in a basic implementation of the system 20, as well as descriptions of additional or alternative features that may be included in enhanced implementations of the system.

In general, audio processing system 20 is an end-to-end solution or Platform for the creation, production, and use of audio Content, such as Audiobooks. The Platform embodies technology for the development and delivery of Content, with special emphasis on audio-oriented Content, such as Audiobooks or audio games. The Platform provides advantages over current mastering procedures for other audio Content, such as the creation of MP3 files for an MP3 player. The Platform also enables the creation of Content that can be played, listened to, and interacted with using hardware devices and media that are less expensive and easier to use than current systems.

The features of this system enable the use of sound-alike Slicing and other features, which effectively create a Codec designed for one Title file. The invention lends itself to use with files of long duration, such as Audiobooks. In particular, this invention can deliver file compression that can exceed typical compression ratios of 10-to-1 by another order of magnitude, enabling Audiobooks to be made available commercially and economically on Memory Cards. In addition, most of the invention's features are complementary to commercial audio Codecs, so that applying such Codecs following the Slicing and Tokenizing procedures result in even greater compression.

As shown in FIG. 3, the generic audio processing system has four major elements: Audio mastering system (AMS) 22, audio production system (APS) 24, audio Memory Card 26, and audio player 28. Although audio media 26 is represented in FIG. 3 as a Memory Card, audio media 26 can also be implemented using other data storage-and-delivery technologies, including Internet-based solutions

As seen in FIG. 3, audio mastering system 22 receives and converts original audio content 30 into a compressed and encoded audio stream 32. In turn, audio stream 32 is input to audio production system 24, which, in addition to possibly modifying the audio stream, is responsible for storing the resulting audio stream 36 on Memory Cards 26. Each Memory Card 26 with stored audio stream 36 can then be configured to (e.g., physically mated with) an audio player 28, which, based on user-provided instructions, retrieves and processes the audio stream to render audio signals 38 for playback to the user of audio player 28, using standard connected or wireless earphones, a built-in speaker, a connected or wireless speaker or a radio through which the audio is played with a transmitter (usually an FM transmitter) which may be connected to the player

Overview

Audiobooks typically have a number of characteristics that are different from other types of audio Content:

1. Audiobooks are long, typically between 4 and 12 hours in duration

2. Audiobooks are typically listened to linearly (line by line, page by page, chapter by chapter) from beginning to end during several sessions over a period of several days. One of the most common times to use Audiobooks is while traveling, whether driving or traveling by public transportation, such as bus, train or plane.

3. Audiobook Content is very different from music Content. While audio quality is an important aspect of music storage and delivery, the high quality required of music is typically not required of Audiobooks. For example, many Audiobooks consist of one person talking for the entire period of the book. The individual words contained in an Audiobook are often highly structured and repetitive. Words like “the” may occur dozens of times on a single page of a book.

4. Audiobooks have a standardized format: line by line, page by page, chapter by chapter is read, and a successful narrator will create a smooth presentation, so that the listener will connect directly with the words, instead of thinking about the aural qualities of the narrator.

5. Audiobook readers have lowered expectations and needs for audio quality. For example, readers have tended to prefer lower audio quality Audiobooks on cassette over higher audio quality Audiobooks on CDs, because CDs do not retain the user's position in the Audiobook once they are removed from a CD player.

These characteristics of Audiobooks are addressed by a number of techniques that can drastically reduce the size of the digital file used to represent an Audiobook to be played. This drastic reduction in file size makes the storage of Audiobooks on flash memory or other solid-state storage devices commercially viable.

The different features of the system, process and apparatus of this invention can be used together or singly. In various embodiments of the invention, the following assumptions are made about the Content when Audiobooks are being produced:

Unlike the compression of audio for the Internet or in MP3 CD-ROMs, the compression of Audiobooks does not have to be either dynamic or generic. In particular, if audio is compressed using an MP3 encoder, the compression algorithm knows nothing about “meta” information related to the Content, such as the nature of the words spoken. Such generic encoders also do not take into account the more limited (compared to music) variations in the spoken voice of the narrator or narrators being used or the cyclical nature of the Content. For many audio applications, Codecs compress quickly without providing substantial audio compression. The techniques of this aspect of the invention are based on one or more of the following assumptions:
a. While the recording of an Audiobook should be an accurate representation of the text of the book and of the narrator's(s') performance, there is substantially more flexibility in the editing and compression of an Audiobook narration than in a musical performance. For example, in a musical performance, people often listen to each note. In an Audiobook, people often listen to each word. Because listeners to an Audiobook are focused on the unfolding of a story, the audio is simply a means to involve a listener in the story and precise voice production is less critical than with music. That is not to say that voice quality is not important with Audiobooks, but rather that it is less important than with music.
b. The compression used to compress an Audiobook can be specific to one class of recording or even one particular Title. The combination of a large uncompressed file with structured audio information suggests that a Codec designed for that single Title, series of Titles, or type of book, will compress the file more effectively than a general-purpose Codec. Even if a program file containing the specifically designed Codec is added to the result and shared with the compressed Audiobook Content, it may still be a worthwhile approach.
c. The nature of Audiobooks, with hours of relatively structured narrative, means that the repetition of words, voices, phrases, sentences, and/or silence may be modeled and tokenized. In one approach, once modeling is completed, repetitions are replaced with a model of the word or phrase that has been generated from an average of the repetitions, plus additional information from that particular version of the word or phrase that allows it to fit in the narrative passage.
d. Some audio Content, such as silent spaces, can be aggressively reduced by modeling, Tokenizing, or even removal, if that audio Content, or segment of the Content, is superfluous.
e. Some audio Content may be suitable for adjustment by reducing its duration while keeping the complete text, typically without adjusting audio frequency (i.e., the speakers will talk faster, but their voices won't be higher pitched).
f. Some audio Content may be suitable for Text-To-Speech (TTS) solutions, such as material that precedes or follows the actual narrative.
g. Some audio Content may support reduction of the frequency range or removal of components of the signal to ensure better compression. Alternatively, the range of signal strength may be substantially reduced in order to increase the use of silence Tokenizing as described in (d).
h. In the case of Audiobooks with music backgrounds or multiple tracks of information, compression may be improved by selectively compressing different tracks, or different portions of each track, with several different Codecs, each optimized for specific voices, sounds, or instruments. Codecs can be used sequentially and/or simultaneously.
i. Content compression can be optimized by making an adjustment of a specific compressor dynamically, based on the iteration of a simple test for audio quality as is described elsewhere in this document, to either reduce or increase compression. As each separate phrase is evaluated, the simple test is performed, and the result is used to ensure that the resulting quality is adequate. The same phrase is iterated again using the same Codec with different settings, or using a different Codec
j. Some audio Content could be reduced in size for delivery by employing Cellular Automata (CA). CA are now used for the modeling and compression of video streams, by storing Content as a series of numbered CA rules and associated iterations. It is possible to model and compress audio Content using CA. CA can model any complex signal by simply iterating a simple rule on initial conditions defined by a list of 0s and 1s. Some simple rules and initial conditions create what appear to be random progressions. An audio stream can thereby be represented at any particular time slice by an existing CA that has progressed through a certain number of iterations. Modeling each time slice by a particular CA doing a specific number of iteration can result in a drastic reduction of audio stream size.
k. Portions of audio Content, such as words, could be compressed by modeling their similarities to each other.
l. The number of samples of a particular repeated word used to model all of the instances of that word could be dynamically adjusted to increase or decrease streaming and/or file size.

Note that some of the compression techniques discussed in this specification have certain analogies to the process undertaken when a synthetic voice is created by sampling an actual voice. This process takes a set of recordings from a specific narrator and uses them to create a synthetic voice with as much of the audio quality of the original as possible. The audio quality of the synthetic voice is typically proportional to the number and duration of the real voice recordings used to build the model. A high-quality synthetic voice may rely on hundreds of megabytes of stored audio Content of one speaker. In the feature described in this section, the stored audio Content of the complete Audiobook and the features developed to create synthetic voices are used to create audio Content, where every word spoken by the narrator can be modeled on the actual narrator saying the exact same thing in the exact same context. As a result, the quality of the narration is far superior to any synthetic voice. Each of the features could be incorporated by human editing, scripted computer editing, or by hybrid means. An important part of the process is an evaluation of the resulting quality of the production, so that appropriate adjustments can be made. The investigation contemplates using as many of the above features as necessary or feasible to produce voice content of acceptable quality and file size.

Audio Content Creation

Today, thousands (if not tens of thousands) of Audiobooks have been created to serve the current cassette, CD and Internet download Audiobook market. Therefore, in many instances, it will only be necessary for the producer of an Audiobook in accordance with the system proposed herein to begin with an existing Audiobook, which will simplify the creation process by avoiding the need to create an initial Audiobook

However, the best-seller of the future may not have an Audiobook to begin with, or there may be other reasons for creating an Audiobook from an original Title. In those situations, a publisher typically selects a producer and a narrator to create a “reading” of the Audiobook. Unlike other media, the quality of an Audiobook, as perceived by the customer, is based on (1) the Content, (2) the voice characteristics of the narrator, and (3) the quality of the audio playback. Since the performance is often “made to order” for that Title, there are operations that the producer can undertake to optimize the results. Before recording, the proposed audio result needs to be reviewed to ensure that the resulting Content is optimal for compression and other file reduction techniques. In particular, one or more of the following procedures are followed:

1. Before deciding on a specific narrator, candidates can be tested, using a section of the Title. The sample should include a wide range of the audio output that the narrator will be expected to speak. For example, if the narrator is speaking dialogue for different characters, each character should be recorded separately. Audio excerpts of different parts of the book, such as forwards, sidebars, quotations, scenes that consist of dialog, for example, should be used. Once the sample has been procured, a suite of audio Codecs can be separately applied to the sample to ensure that there are no lacunae that could result in non-optimal compression or audio quality.

2. The complete text can be quantitatively analyzed to consider the most effective audio procedures for compression. The analysis can include some of the following items
a. Narration List: List of the narrators to be used for different characters
b. Characterization List: each narrator in turn has a list of the significantly differentiated voices that he or she will use in the recording. These may include different characters as well as any particular exaggerated or extreme narration of a particular character or characters at specific times. Each should be part of the list
c. Word Repetition List: A list of a specified number (e.g., 100) of the most-reused words and the corresponding number of repetitions of each of those words
d. Phrase Repetition List: A list of combinations of words that are repeated and how often
e. Homonym Repetition List: A list of similar-sounding words that are repeated and how often.
f. Sentence Repetition List: A list of entire sentences that are repeated and how often
g. Sound Effect Repetition List: A list of sound effects that are repeated and how often

At this point, the recording is produced. Audio Content is digitally recorded, initially at the highest possibly sound quality. Then, the audio data is reviewed carefully to remove transients and other information that will affect the preparation of the audio for delivery.

Initial evaluation of the compressibility of the data is preferably done in steps, by (1) compressing the entire Audiobook with several representative Codecs, including but not limited to: MP3 (or, more precisely, MPEG-1/2 Audio Layer 3), an audio compression algorithm by Fraunhofer capable of greatly reducing the amount of data required to reproduce music audio; Ogg Vorbis, an open and free audio compression project from the Xiph Foundation; or Speex, an audio compression targeted to greatly reducing file size for speech audio, unlike music. (2) compressing each chapter of the Title with each Codec, and (3) compressing sections of each chapter with each Codec. This way, each of the Codecs applied can be evaluated and the optimal Codec selected. Once the best compression solution for each section of a chapter is determined, initial decisions can be made whether or not to reduce the total quantity of data by (1) removing one or more channels of data, (2) removing space, and/or (3) Tokenizing silence in the Audiobook. It is useful (but more costly) to have alternate narrations of a Title, since some versions may be more compressible than others. Priority should be given to ensuring as consistent a delivery as possible by all narrators, to enable the Content to compress more smoothly.

Standard, commercially available speech recognition tools can be used in an automated or manual fashion to provide a mechanism for parsing the narration. The actual text on which the narration is based on can be used as a check for the results of the speech recognition tools, or separately as a means to manually or automatically optimize the Content by creating a “dictionary” of used words (or phonemes, phrases or sentences, etc.), along with the number of repetitions, locations of each occurrence, and the similarity of each word with other repetitions of the word.

Pre-Compression Editing and Optimization

In the editing phase of the creation of an Audiobook, the “macro” understanding of the Title can be used to employ features that substantially reduce the final size of the Audiobook prior to compression by a Codec.

One feature employed in the use of the method and system described herein is time-stamping a version of synthetically generated speech and comparing it with the time-stamps of the human narrator. Once a simple mapping of words and their positions in the Title is completed, the synthetic speech can be recreated using the timing of the human narration. The signal strength of each word can then be modeled, at a very basic level, with signal strength information for the beginning, middle and end of the word. Once timing and signal strength modeling have been employed, frequency modeling could by provided to the synthetic element to create standard frequency variations, such as the rise of a voice at the end of a sentence ending with a question. At this point, the two files and the index can be compared again.

Another feature of the method and system described herein is indexing repetitions of commonly used words, phrases, sentences, or sound effects throughout the audio file with their positions. Then, at least one sample of each indexed item is selected, and each of the original repetitions is removed and replaced with a Token indicating playback of a corresponding sample. The index can (optionally) contain “hinting” information that may adjust the audio characteristics for the sample when used in a particular position, including “envelope” information, such as attack, sustain, and decay (terms used by audio technicians to define the beginning, duration, and ending of a sound). Homonyms and similar-sounding compound words may also be added to the index. It may be appropriate to use this feature with a text-to-speech program, together with the hinting information described.

Other manipulations of the existing Audiobook samples can also be utilized, including, but not limited to: (1) abbreviated samples where plurals, suffixes, or prefixes could be handled separately, (2) extended samples where two or more samples are connected to model a larger section of speech, and (3) reversed samples where the sample is played in the reverse direction to model a section of speech.

Modeling phrases, or even sentences can be utilized, depending on the appropriateness of the feature to a specific sample for specific needs, such as substantial compression. For example, short phrases like “he said” or “she said” may be effective sampling candidates. Even longer spoken audio phrases can profitably be used if the Audiobook contains many phrases or sentences that are repeated many times, as in text books or legal documents.

In many cases, implementing the previous indexing suggestions prior to Codec compression would be time-consuming and difficult. Software can be used to evaluate the uncompressed file in other ways including but not limited to the following techniques:

Use of a program that relies on the repetition lists and the synthetic speech features described earlier. The program compares all sounds and models the difference for each usage. The envelope information for each invocation of a repeated word (or other audio portion) would be saved and paired with a Token considered most “representative.” That Token could be used as is or transformed into a data format that lends itself to the application of the hinting information.

Use of a program that uses Slicing to section pieces of audio and compare it with other audio pieces that have been analyzed. This is similar to the computer equivalent of using the similarly sounding items to reduce size. One extreme example is children's Audiobooks, which is audio Content in which the number of different words said is extremely small, and the narrator says things in a repetitive way, Examples are “The cat is on the mat.” or “Have you seen the cat? It's on the mat.” In such cases, simple software can tease out the similarities of “cat” “is” “on” “mat” by comparing sufficiently small chunks of audio

Use of an extension of the software described in the previous paragraph, given substantial time and processing power, the software could examine a minimum Content sample, e.g., 10 seconds, and create a database of all Slices. Then, using well known numeric methods, take a specific number of Slices and model all other Slices on whatever Slice is mathematically closest to it. Variations include changing the size of the sample to accommodate larger Slices of similar data. With sufficient processing power and time, alternative model Slices can be evaluated, slowly reducing the net size of the document prior to Codec compression. A similar approach can be used to encode and compress audio music, multimedia, or other media types.

Compression

The portions of the Audiobook file that have not been Tokenized during pre-compression may be compressed. Some features to ensure maximum compression are described above, such as the use of sequential or simultaneous Codecs that are specific to the Content being compressed.

One approach is to treat non-Tokenized sections of the Content with the Codec most appropriate for each section. This way, non-Tokenized Content will be compressed with the Codec that delivers for the best combination of reproduction quality and compression. Utilization of multiple Codecs thus offers the advantage of being able to optimally combine different compression techniques for space, reproduction quality, or combinations thereof.

If implemented as part of a system for creating Content, a series of different compression algorithms, such as MP3, Speex and Ogg Vorbis, can be used to compress all non-Tokenized sections, with the results stored in a database for later assembly, based on the resulting file size and reproduction quality.

Delivery

The data generated using the above-described compression method is different from the results of standard compression features. The output can include an index for each sample, a map of where each sample should be used, a Script that manages the playback or information, and one or more Codec components that are used to decode different parts of the Content, such as an Audiobook.

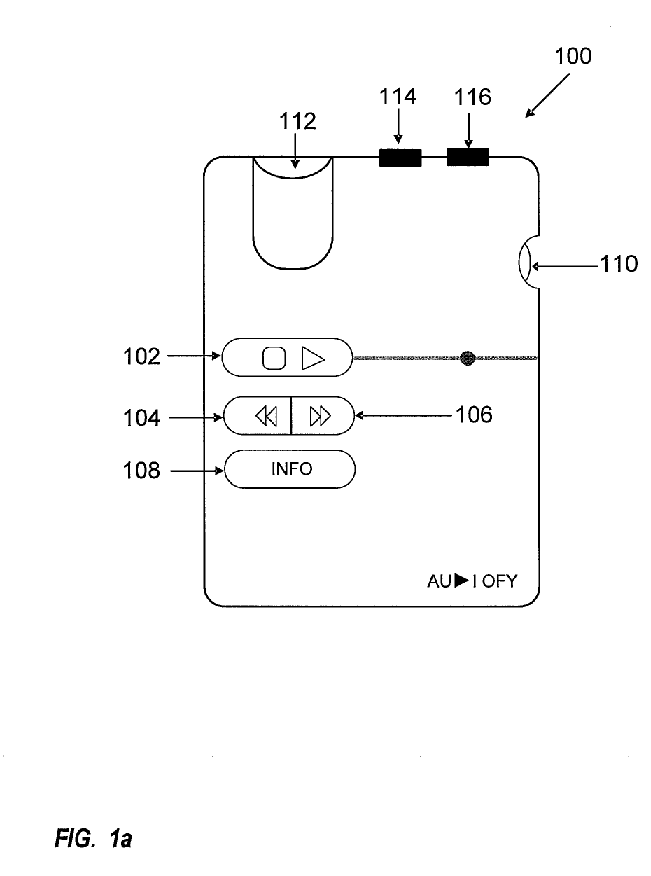

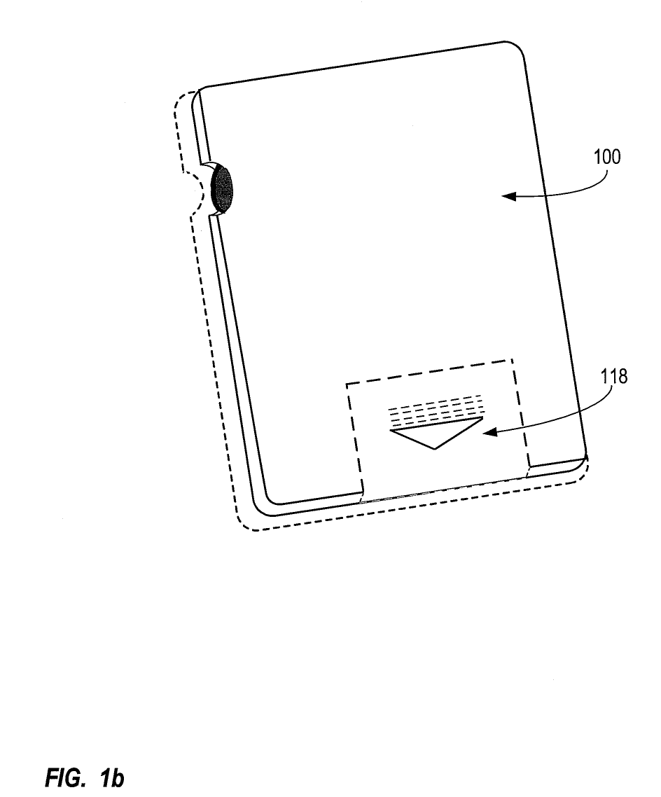

The delivery “system” can comprise a “dedicated” Player 100, as illustrated in FIGS. 1a and 1b, or a “generic” Player, such as a PDA or cellphone, so long as the system includes a Client Application that permits the Audiobook or other Content to be played on the Player. The delivery system that can play the resulting Audiobook is different from a standard MP3 player or CD player. A particular Audiobook Title created in accordance with this invention is not Codec-specific as in other systems. Each Content file is accompanied by a control file (which may, but need not be, in the Client Application) that determines playback order, playback Codec, decompression settings and other preferences.

The Content delivery system of this invention can be incorporated as a static file on a Memory Card, as used in a handheld device, or in a Storage Device other than a Memory Card, in a Player. The delivery system parses the control file that schedules use of Tokens, Codecs, and the implementation of data manipulation such as volume, frequency, and channel adjustment. Alternative delivery systems would include streamed audio or downloaded files. In these cases, the control file would be downloaded first to ensure that the Player could operate on the files properly.

Other Considerations

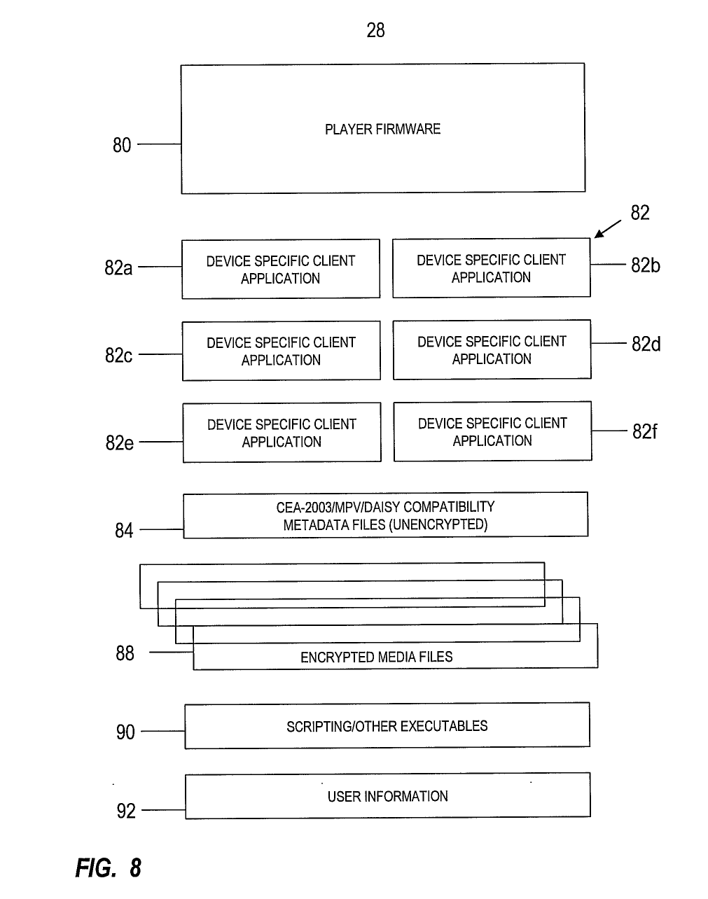

Various approaches may be used to reduce file size and/or increase presentation quality in a Content creation and management system. In one embodiment, the file format of the Content [as illustrated, for example, in FIG. 8] is different from the file format for most Content in that: (1) it is non-sequential; the audio files may not be simply read in sequence or by a user-defined playlist, but as components combined per the control file; (2) the file format is not limited to a specific compression or decompression feature; (3) Metadata information, containing both Navigation and table-of-contents types of information, are incorporated into the file format.

The system described above also lends itself to the creation of Script-based interactive systems, such as travel instructions, game systems, foreign language instruction, etc. In such Script-based systems, the Script could also access the basic hardware structure of the Player, to define the operations of different input options, including the functional specifications of buttons, the use of microphone input (e.g., for speech recognition), or other inputs and outputs, including small LEDs, LCDs, and wireless and wired communication systems. The Scripting system itself can be independent of the other components of this system for interacting with Content. For example, the Scripting system itself could use variants of PHP, Macromedia Flash, or other scripting systems. PHP (a recursive acronym derived from “PHP Hypertext Preprocessor”) is a popular Scripting language used for web services and can be readily applied to the systems and methods described herein. Macromedia Flash is a commercial multi-platform Scripting development environment created by Macromedia Corporation and may also be applied to the systems and methods described herein.

An Audiobook Player can also interact with the audio by using a variety of external signals to control the Script and/or timing in the Player. In particular, the Player can respond to biomedical, GPS, pager, email, RSS (Real Simple Syndication, a specification for data streaming that is popular with bloggers), or other specific data that are received by the device in which the audio player exists. In one embodiment a microphone jack to transmit heart rate monitor information is included, so as to support a variety of applications using that information. For example, a heart rate monitor can transmit heart rate to the audio player, synchronizing a specific music or Audiobook playback speed in the Player.

In one embodiment of Audio Processing System 20 of FIG. 3, the system can be based, in part, on open software libraries, although proprietary libraries can also be used to the extent that there is a cost or performance benefit. The basic system can create an Audiobook manually, with some testing being done to determine how much of the audio optimization can be done automatically. Metadata and Navigation tools are provided, to ensure rapid and error-free creation of the Metadata/navigation framework in a created Audiobook. This embodiment can contain more than a minimal set of features. In particular, other possible embodiments of Audio Processing System 20 might not have all of the features of the basic embodiment described in this section. For example, some Content may not require a Scripting module, or pre-compression optimization if unusual compression or Navigation is not required.

Audio Mastering System

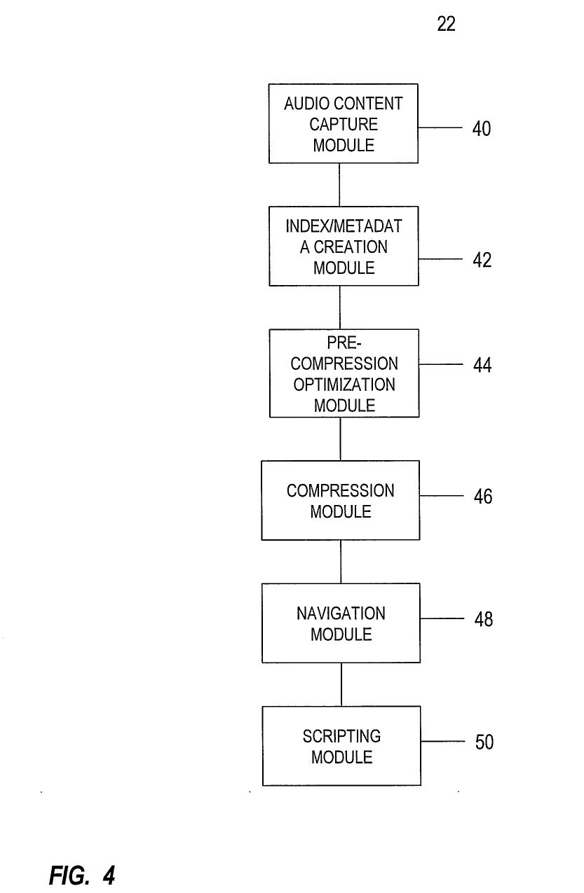

FIG. 4 shows a block diagram of the Audio Mastering System 22 of FIG. 3. This diagram starts with a pre-recorded Audiobook, either produced by the implementer of this invention as set forth above, or licensed or otherwise lawfully obtained in a pre-recorded form, as with the Audiobooks presently available on cassette, CD or on-line.

As shown in FIG. 4, Audio Mastering System 22, which may be implemented on a personal computer (PC) that provides Internet-based access, has the following six functional modules: (1) audio Content capture module 40, (2) index/Metadata creation module 42, (3) pre-compression optimization module 44 (this is optional), (4) compression module 46, (5) Navigation module 48, and (6) Scripting module 50 (which is also optional). In one embodiment, Audio Mastering System 22 supports only manual Content capture and manual adjustments of audio quality. Enhanced system embodiments can support automated capture and optimization of Content.

Audio content capture module 40 captures the audio Content for creating the Audiobook, just as well-known “ripping” software captures audio Content from a CD. The captured audio Content includes the actual audio stream and any additional relevant data contained on the source medium. Relevant data refers generally to descriptive audio or text, such as a textual representation of spoken audio or details that supplement the main audio passage.

When an Audiobook, which was first produced for cassette, CD and/or on-line distribution, before being utilized in accordance with this invention, is later processed for storage on a Storage Device in accordance with this invention, the Audiobook is provided on a compact audio disc (CD), although most media containing digital and/or analog audio information are acceptable. The first step is to “rip” the CD information, using well-known software which performs analog to digital conversion, onto a storage device (e.g., a hard drive) of the PC executing the audio mastering system. This is preferably done in a non-lossy fashion, to ensure the highest possible quality for further audio manipulation. Once the data is captured on the hard drive, the data may be concatenated since, in most cases, the Audiobook was created and stored on the CD in multiple tracks. The CD track information may be stored for later use by the index and Metadata creation module 42, described below. The audio Content is typically stored at this point to ensure that, if additional editing of the audio tracks is necessary, the audio can be edited at the highest resolution, avoiding artifacting and other audio distortion. At this point, the data is ready for indexing and pre-compression optimization.

Index/Metadata creation module 42 indexes the audio file before any additional audio manipulation is performed. In particular, manual and automated indexing features are used to identify and correlate Content structure and indicative information from the captured data and audio stream. Manual indexing requires an audio technician to listen to an audio stream and manually key in relevant information, such as chapter titles, starting time, ending time, etc. Automated indexing uses speech recognition technology to create structural information. For example as the audio is ripped, speech recognition will recognize the phrase “Chapter One”, and store the time location of the phrase. Key elements relating to the Audiobook, such as author, navigational cues, publisher information, chapter-specific information, etc., are extracted to facilitate non-linear navigational capabilities, Content details and background, Scripting (explained below), and other narrative features. These features involve the use of speech recognition to capture the audio navigation cues that are part of most CD and tape narrations at the beginning and the end of each file. Basic index information about the Audiobook, such as the title, author, chapter, and narrator information, is also stored in the mastering system.

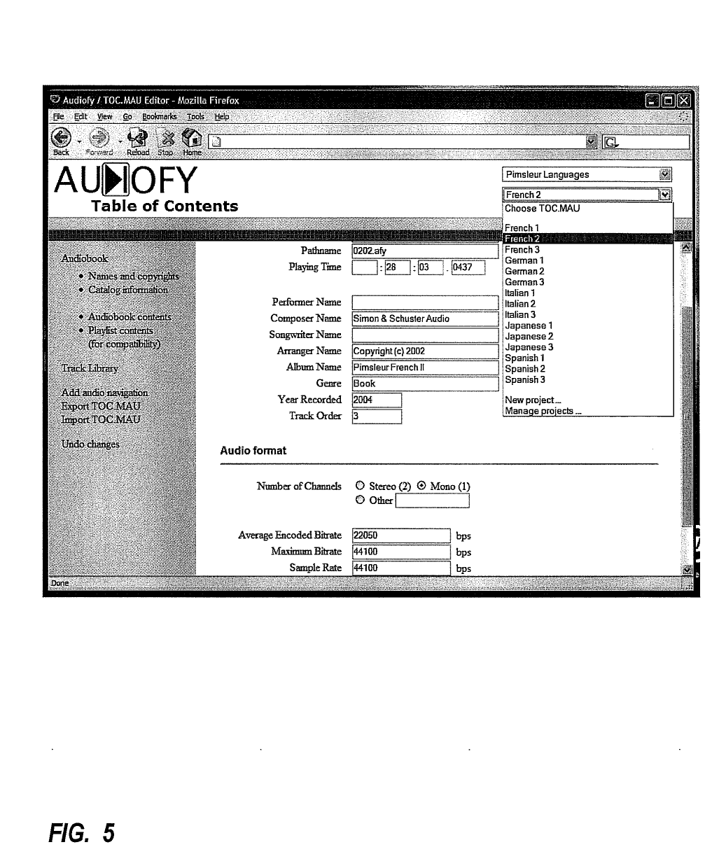

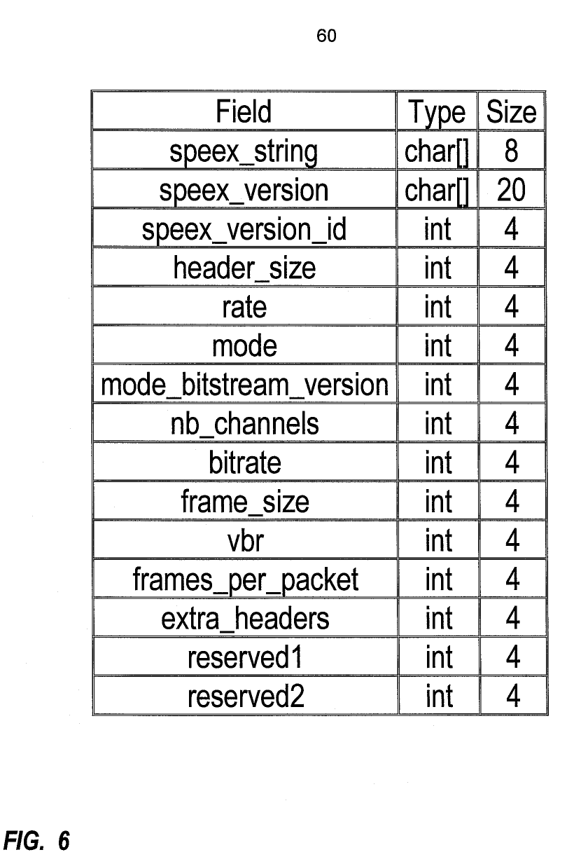

Index/Metadata creation module 42 can include additional Metadata in the audio file. In one embodiment, the types of Metadata available are those contained in standardized databases defined by the Consumer Electronics Association and the Audio Publishers Association as the CEA-2003 standard for audiobook metadata. Other embodiments use other types of standardized or proprietary Metadata. Metadata information is stored to support specific Content and therefore can be uniquely extended to support additional Content features for the listener. For example, Metadata could be used to enable the listener to request the definitions of words being read by the narrator. Other options might include an index that tracks the verses of a religious text, the footnotes of a scientific text or the sidebars of a business article. The Metadata structures the Content, allowing for non-linear playback of Content, and can deliver a far richer listening environment. Basic Metadata describing the Content can be manually entered through audio mastering system dialogs, and loaded in the computer which performs the mastering, as by use of the data collection screen forms illustrated in FIGS. 5, 6, and 7, and which are exemplary only and may readily be varied without departing from the spirit or scope of this invention. Metadata files are constructed from the extracted information in the completed forms, resulting in a compact and meaningful abstraction of the data. Typically, Metadata is supported by Scripts that connect user activities to the indexed Content. Scripts are created using Scripting module 50, described below.

In one implementation of this invention, the audio mastering system includes a speech processing system that uses well-known speech recognition software, such as Dragon NaturallySpeaking® from the ScanSoft Corporation or ViaVoice® from IBM, to automatically identify key Audiobook elements. Another use of speech recognition software is to isolate spoken words from other types of Content, such as music, which affords greater compression opportunities. Text-to-speech capabilities can be used to enable an audio player, such as Player 28 of FIG. 3, to convert Metadata cues and other textual information into spoken audio prompts.

FIG. 5 shows one form of graphical user interface (GUI) generated by Audio Mastering System 22, to enable the capture of global Metadata information useful in Navigation.

Pre-compression optimization module 44 passes the audio through a series of operations to reduce bandwidth and optimize audio quality for spoken audio playback by removing redundancies and/or irrelevancies from the audio signals. These operations, which include frequency reduction, high-pass and low-pass filters, signal normalization, and selected emphasis of certain frequency bands, are implemented and evaluated manually, but can be automated in enhanced implementations. During these operations, the audio file is reduced somewhat in size and prepared for compression. The goal of pre-compression optimization is to enable the digital audio data to be compressed (by compression module 46 described below) in a way that minimizes storage requirements, while providing high-quality audio sound during playback.

Pre-compression module 44 also enables diminution of the file size of digital Content to be compressed. It is first necessary to determine an optimum minimum size of a Slice. This is done by choosing a time duration, such as 5 or 10 seconds, or using a characteristic audio segment, such as a repeating word or phrase, and using this choice as the basis for determining Slice size.

The entire Content is then broken into Slices of predetermined size, creating a database of Slices. The Slices may be an arbitrarily determined size, which are experimented with and determined to produce a satisfactory result, such as a Slice size of 20 milliseconds. Alternatively, the audio could be analyzed to determine the best size Slices of audio, such as mapping and creating slices based on phonemes, words, sounds or phrases. Alternatively, more than one Slice size can be used, with the number of different sizes, and the determination of the number of particular Slices of each size are determined by the nature of the audio segments being sliced. The size, selection and slicing can be done manually, or it can be done automatically using a program created to review a given work, determine the nature of its Content, and determine on that basis the optimal way to Slice the Content, both by determining Slice sizes and which Content segments will be sliced into which size Slices.

Once the Content has been segmented into a database of Slices of one more sizes, depending upon the approach being chosen, the Content is recreated by stepping through the Slices chronologically, and then choosing the best Slice (or Slices, if there are multiple Slice sizes) for that section of the Content. Choosing the best Slice is done by comparing the audio quality and compressed size to the desired size and audio quality of the recreated Content.

Based on the given size of the uncompressed audio file and the target size of the resulting compressed audio file, as may be requested by the publisher, compression module 46 establishes the kind and level of compression to be done, and the audio file is compressed using a variety of features. A preferred implementation of the invention uses the Speex audio compression codec designed especially for speech compression. Speex is developed by the Xiph Foundation. The audio mastering system of this invention enables the adjustment of one or more Speex Codec settings, as appropriate to establish a satisfactory balance between audio quality and compression, determined as follows, by way of example:

Sampling rate. Choose three different sampling rates: 8 kHz, 16 kHz, and 32 kHz. These are respectively referred to as narrowband, wideband, and ultra-wideband.

Quality. A quality parameter that ranges from 0 to 10.

Complexity. A parameter that enables a trade-off between audio quality and processor performance.

Variable Bit-Rate (VBR). This parameter tells the Speex Codec to change bit-rate dynamically to adapt to the “difficulty” of the audio being encoded. In Speex, sounds like vowels and high-energy transients require a higher bit-rate to achieve good quality, while fricatives (e.g. “s” or “f” sounds) can be coded adequately with fewer bits.

Average Bit-Rate (ABR). This parameter dynamically adjusts VBR quality in order to meet a specific target bit-rate. Because the quality/bit-rate is adjusted in real-time (open-loop), the global quality will be slightly lower than that obtained by encoding in VBR with exactly the right quality setting to meet the target average bit-rate.

Voice Activity Detection (VAD). This parameter detects whether the audio being encoded is speech or silence/background noise. Speex detects non-speech periods and encodes them with just enough bits to reproduce the background noise.

Discontinuous Transmission (DTX). Discontinuous transmission is an addition to VAD/VBR operation that allows transmission to stop completely when the background noise is stationary.

Perceptual enhancement. Perceptual enhancement is a part of the decoder which, when turned on, tries to reduce (the perception of) the noise produced by the coding/decoding process. In most cases, perceptual enhancement makes the sound further from the original objectively (using signal-to-noise ratio), but, in the end, it still sounds better (subjective improvement).

In conformance with C2003B, the target size may be entered into the mastering computer, using the graphical user interface of FIG. 5. Compression is performed iteratively, as compression parameters and settings are varied, until optimal results are obtained. The result is a Codec derivation that is uniquely paired and delivered with the particular Content being mastered. Unique pairing means that the pre-processing and Codec processing modules of the audio mastering system are using settings that result in relatively high audio quality for the bit-rate or file size desired for that title. This approach not only maximizes the compression opportunities, by exploiting unique characteristics of the particular Content, but it also helps secure the Content once distributed. To qualify the effectiveness of the compression, the audio mastering system can use commercially available speech recognition software to compare the uncompressed result with the original Content. The result is typically an audio file with a bit rate between about 2 Kbs and about 32 Kbs, as compared to MP3 audio compression, which typically has a bit rate of 128 Kbs.

In the preferred embodiment, the Codec used in compression module 46 is the Speex Codec. This open platform Codec is a CELP (code excited linear prediction) variant that delivers excellent performance and lends itself to customization. While the audio mastering system could be implemented using other Codecs, such as MP3, WMA or Ogg Vorbis, the open source Speex Codec is specifically engineered for spoken audio compression.

Typically, the audio file for an Audiobook being processed by the mastering system of this invention is compressed multiple times, each time using a different set of compression settings. Settings details, found in Chapter 1 of The Speex Codec Manual, are described above. Different settings may provide widely varying results in terms of audio quality and file size. After each compression, the index file is attached to the compressed audio file, and the resulting combined Audiobook is manually reviewed for size and quality. If the size and the quality are both acceptable, using both automated and manual audio quality tests, the file is passed to navigation module 48, described below. If not, the compressed audio file is discarded, and the uncompressed audio file is recompressed with different settings of the Codec. Alternatively, the original audio files can be edited to reduce size, passed through the system and recompressed. Some audio Content added to Audiobooks can be removed without affecting the user's ability to listen to the Audiobook or the quality of the listening experience. For example, the audio at the beginning of an Audiobook, where the narrator names the Title and other prefatory information, can be deleted, since the audio processing system of this invention can replace that with a synthetic voice. Also, there may be additional cassette- or CD-based Navigation information at the end of each section of each CD or cassette; this can safely be removed.

Eventually, after one, two or more iterations, a successfully compressed file is passed to Navigation module 48, which adds Navigation information, creating a correspondence between user interaction and the buttons 102, 104, 106 and 108 of the dedicated Audiobook Player 100, or other input/output (I/O) devices that other Players may have. Navigational support is added to the Content, based on correlations between the target audio Player's (or Players', if the Memory Card is intended for use with different Players) user interface (UI) and the Metadata collected by index/Metadata creation module 42. This establishes how the Player(s) will respond to various user interactions. Specifically, the Navigation information is used to synchronize standard user interface controls, such as rewind, forward, play, and stop, to user interactions. Once the level of user interaction is defined, audio samples for any audio-based feedback are synchronized with the audio stream and with embedded Metadata that may provide additional verbal or visual cues to the user. If additional Metadata information has been set up, new audio, text, or visual feedback may need to be created for use with that Content. For example, if an additional indexing level has been created, e.g., for the review of proverbs in an Audiobook of the Bible, another set of Navigation commands have to be associated with that indexing level to allow the users to reach and Navigate that level (i.e. Proverbs) properly.

The compressed and indexed file is then passed to the Scripting module 50, which adds basic Scripts to control the interaction between the user and the Audiobook. The Scripts define the access of the user to Content based on the profile of the Player device being used, the kind of audio Content being processed, and the level of interaction desired between the user and the Player. For example, foreign language audio may require an additional level of interaction to support parallel use of the Audiobook in two (or more) languages. In addition, Scripting may support access to Content based on audience ratings predicated on the user's age. Additionally, Scripting provides a mechanism to trigger actions based on Content-specific or user-initiated events, making it particularly useful for highly interactive applications.

Audio Production System

There are at least two ways in which copies of Content can be reproduced on Storage Devices: (1) by direct burning of Content created by the Audio Mastering System 22 or, (2) by transferring the master file to a central site, such as a website, and downloading copies on an as-needed basis, in accordance with pre-determined parameters, to a end user, distributor or other customer.

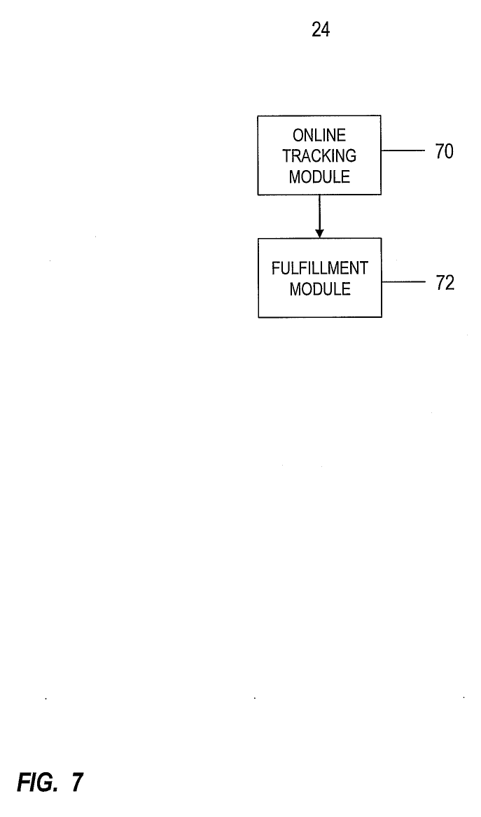

FIG. 7 shows a block diagram of such an audio production system 24 of FIG. 3. As shown in FIG. 7, audio production system 24, which is preferably implemented on a PC that provides Internet-based access and may optionally be the same PC that implements audio mastering system 22 of FIG. 4, has two functional modules: (1) online tracking module 70 and (2) fulfillment module 72.

Online tracking module 70 enables customers, such as end-users, distributors, and/or publishers, to browse, order, customize, and review Audiobooks generated by audio mastering system 22. This net-based facility contains the Content created using the audio mastering system, and permits commercial users, authorized to use the system to create multiple copies of Audiobooks on Storage Devices, to add custom formats and information, such as digital rights management (DRM), special messages to consumers, advertising, or other custom audio or visual feedback, which may be packaged with the offered Content. Audiobook offerings presented through this web portal are listed and described in an Audiobook catalog. Online tracking module 70 includes the following components: the Audiobook catalog, an ordering system, and customization features. These components are preferably integrated with a standard back-office system for tracking and billing of orders, customer databases, etc.

Fulfillment module 72 is used by an authorized Audiobook production site to fulfill orders created by online tracking module 70. The fulfillment module may be made available to Audiobook distributors, retail Audiobook vendors, or Audiobook readers, for the creation of instant inventory on Storage Devices, which for this purpose, would preferably be Memory Cards. The fulfillment module may be designed to deliver Audiobooks to customers in several different ways. For example, fulfillment module 72 may be implemented using a standard PC and associated standard Memory Card burner hardware (sometimes called a card reader) having the ability to master audio Memory Cards, such as Memory Card 26 of FIG. 3, and (optionally) associated printers having the ability to print out “collateral,” such as paper or plastic labels, packaging materials and advertising materials for product packaging. These hardware components are well known and commercially available. The fulfillment module processes a customer order, selects and modifies an appropriate Audiobook, either available from a secure server or internally, and then “burns” (copies) the Audiobook (including Content, Metadata and Client Applications, as described below) onto a Storage Device. The collateral and Memory Card(s) or other Storage Device(s) can then be assembled and shipped to the customer. This process manages specific details relating to destination platforms, media types, and copy protection issues.

The fulfillment module can also support a “Books On Tape” rental programs. These programs allow customers to receive a set number of Audiobooks as part of a subscription program. The customer returns the Audiobooks periodically and then receives new Audiobooks. A queue based model is a variation of this program, where customers can rent a set number of Audiobooks and keep them indefinitely, without late fees or other penalties. Both programs are greatly enhanced by the ability of the Platform to do fulfillment dynamically on open order, reducing or eliminating inventory requirements, to ship inexpensively using delivery options as inexpensive as postcards, and to provide Content on a Storage Device that is far more robust and durable than CDs or cassettes, which can wear out after a limited number of uses.

In addition, the Platform can provide the Audiobook or other Content vendor delivering Content to customers to ability to fine-tune its business model by adjusting the rules under which the Content can be played. For example, Content can be programmed to disable itself after a given period of time, or following particular user activity (such as completing one-time listening to the Content). The Platform can also be used to deliver commercials, previews or other sidebar material to encourage the customer to purchase or rent additional Content. Thus, the Platform can be used to institute “Books On Tape” or queue type delivery programs for radically lower costs and overhead than other solutions.

These production and fulfillment options can be implemented at the manufacturing level, the national or retail distributor level, the retail store, or even at each customer's home, where “fulfillment” can simply refer to writing Content and other necessary data on a Memory Card.

One implementation of digital rights management for the invention is useful in supporting the widest variation of Storage Devices and both retail and production on demand situations. The implementation, called the “Bullethole Method” relies on the limited read/write life of individual memory locations in flash memory. The Bullethole Method employs software to “brand” an Identifier by writing locations on the Memory Card to failure. These locations can be associated as an Identifier and thereby support a digital rights management system, without requiring the use of proprietary and incompatible digital rights management systems that may already exist on the Storage Device.

Audio Storage Device

The Audiobook (or other Content) mastered and produced using mastering system 22 and production system 24 of FIG. 3 can be platform-independent and can be distributed on various Storage Devices, along with optional executables that support automatic detection and operation on different host audio Players. For example, an appropriate Client Application stored on the Storage Device will, when inserted in a compatible Palm device, causes a PRC file to automatically trigger operation by the Palm operating system. Exemplary Memory Cards include MMC (MultiMediaCard), SD (Secure Digital), and SDIO (Secure Digital Input-Output) cards. With time, it is to be expected that these Memory Cards will evolve and that other Storage Devices will be commercially available and operable in accordance with this invention. These Memory Cards currently have a postage stamp form factor and are easily inserted and removed and used across a variety of Players, which may be computers, PDAs, cellphones, combined PDA/cellphones (such as the PalmOne Treo 600®), MP3 players, dedicated Audiobook players, such as Player 100 illustrated in FIG. 1a, or other hardware having appropriate built-in or peripheral equipment Memory Card slots and internal software, to respectively accept and execute information and instructions on Storage Devices. These Players use different operating systems, and it is within the purview of the systems and methods described herein to create and store on the Storage Devices more than one Client Application that will execute on one or more available operating systems.

FIG. 8 shows a block diagram of the data stored on audio Memory Card 26 of FIG. 3, according to one embodiment of this invention. As shown in FIG. 8, Memory Card 26 has the following modules:

Player Firmware 80.

One or more Player-operating system-specific Client Applications 82, each of which may be capable of executing on a different operating system, and individually labeled 82a through 82f (although it is within the purview of this invention that one or more Client Applications will execute on more than one operating system);

One or more Codecs (the Codecs may be incorporated in the Client Applications themselves or one or more discrete Codecs may serve one or more Client Applications);

One or more Metadata files 84;

One or more media files 88 containing the compressed Audiobook or other Content files;

Scripting file(s) 90; and

Stored user information 92.

The Storage Device may contain bootable software, including the Codec and other data processing algorithms that are loaded onto and executed by a Player that may not have a native operating system, such as audio Player 28 of FIG. 3. This software supports the Player, whereas additional Client Applications can be used to listen to the media files on many different hardware Players.

Each of the Client Application modules 82a through 82f is designed to enable the Storage Devices to work natively on a different, specific type of Player or Players. Exemplary device-specific Player software modules include those designed to enable the system of this invention, stored on a Storage Device, to be executed on (1) standard PCs, such as (a) a PC running a MICROSOFT WINDOWS operating system from Microsoft Corporation of Redmond, Wash., or (b) a PC running an APPLE MACINTOSH operating system from Apple Corporation of Cupertino, Calif., (2) a standard PDA or combination PDA/cellphone, such as a PALM ZIRE 31, or TREO 600 from PalmOne of Mountain View, Calif., (3) a POCKETPC/SMART PHONE from Microsoft Corporation, or (4) a cellphone with the capability to accept and execute instructions on a Memory Card, such as one from Nokia Corp. of Espoo, Finland.

In a preferred embodiment, Content can also be accessed by an inexpensive (compared to standard PDAs cellphones and the like), dedicated Player which does not require a cumbersome and expensive operating system and microprocessor, as the Storage Device desirably includes the Client Application and other software to boot and run the Player to play the Audiobook or other Content.

Metadata files 84 ensure compatibility with open standards, such as CE2003B, MusicPhotoVideo (MPV), and Daisy, a Metadata standard used in the production of Content for the blind and visually impaired. The audio production system described herein maximizes compatibility with multiple types of Players by including the standardized Metadata files in an unencrypted format, as by using the CEA2003 Specification. Metadata files 84 will contain indexing information conforming to the standard indexing specifications. Metadata files can optionally be included on the Storage Device, to enhance the user's experience. Metadata, as contrasted with local Metadata, is typically concerned with Content information that is used to identify the Content prior to its use. Such global Metadata includes title, author, narrator, publisher, and other information employed by users in order to select the proper product.

Metadata files 84 may also contain Navigation data, primarily narrative and book-oriented audio files that provide the backbone for audio-based narration for Audiobooks using the system of this invention, as well as music Content tagging and related information for musical Content.

Audiobook media files 88, contain the compressed Audiobook data generated by audio mastering system 22 and formatted by audio production system 24. These media files may optionally be encrypted for added security.

Scripting and other executables 90 contain optional Scripting information, used to access selected sections of audio files. For example, in the case of an Audiobook having ten chapters, the default Script is a track listing that identifies the ten tracks. Optionally, additional options can be offered to the Audiobook listener. An example is short question-and-answer sections (Q&A), inserted following the narrative for the listener's review. A short example of such Q&A would be an automated Script that replays portions of the audio section just listened to at the end of each chapter. At that point, questions can be asked that would not require manual Scripting, for example, “Did you hear this sentence in the last audio section?” Manual Scripting enables the creation of typical Q&A tests that more closely resemble tests that evaluate the listener's successful understanding of concepts. Finally, complex Scripts can be incorporated on the Storage Devices of this invention, to review, test, and report on users that are engaged with electronic learning Content. The modeling done in e-learning, e.g., time taken to learn a specific task or area, ability to remember information from prior sections, etc., can be stored on the Storage Device to fit learning exercises to the individual learner. This Q&A capability is of particular interest when Audiobooks are used as textbooks for blind or visually impaired students, but is also of interest for any user.

The Storage Device may also contain a user-information area 92, where information is stored about use of the Player, including minimal position information that describes the most advanced location that the Audiobook listener has reached. Other information could contain total hours used, number of times that the Audiobook has been “read”, results of tests or tutorial that are part of the Audiobook, commercials or other sidebar content experienced by the user, or other preference information for the reader.

One important aspect of the media processing system of this invention is its ability to protect the intellectual property of Content owners from unauthorized copying and/or use. Efforts to address this problem are called “Digital Rights Management.” As discussed elsewhere herein, the audio mastering system of this invention generates Client Applications and Content which can be uniquely paired to a specific Memory Card or other Storage Device. This prevents particular Content from being executed by software paired with other Titles, prevents Content from being moved and then used with another Storage Device. Content may be further secured on the Storage Device using well known public-key encryption methods.

Each Storage Device has a Unique Identifier or a Particular Identifier. In the practice of this invention, an Identifier must be incorporated in the Content and/or in the Client Application on each Storage Device and must also be present in the Storage Device. The Client Application has the ability to Correlate either two or three Identifiers (one in the Content and/or one in the Client Application and one in the Storage Device). If the Identifiers Correlate (either two or three Identifiers, depending on how the Platform is implemented), the Client Application enables the Content to be played on the Player that is attached to that Storage Device. If the Client Application determines that the required Identifiers do not correlate, the Client Application will not enable the Player to execute the Content, and therefore unauthorized use of Content is prevented. It is preferable to have Identifiers in the Content and in the Client Application because this prevents the unauthorized use of the data (Content or Client Application) that does not have an Identifier that is Correlated

Dedicated Player

Although Content created in accordance with this invention may be played on “off the shelf” Players, such as computers, PDAs, combination PDA/cellphones, cellphones and MP3 players that accept Memory Cards, in a preferred embodiment, Memory Cards utilizing this invention may also be played on a Player designed specifically for that purpose. A dedicated Player will be less expensive and easier to use as a single purpose device, as illustrated in FIG. 1a. The controls and operation of the dedicated Player are very similar to those of a conventional audiotape player. The dedicated Player is compact to handle and transport, and is easy-to-use by persons who are not comfortable with more complex Players. Dedicated Player 100 illustrated in FIGS. 1a and 1b is a cost-effective device specifically designed for playback of Audiobooks generated by audio mastering system 22 and audio production system 24. Dedicated Player 100 can boot and operate from Client Applications and instructions resident on the Memory Card 102 when it is inserted in the dedicated Player 100. This feature affords flexibility, for various Content types as well as for future enhancements and features that may become available in newer Content releases, so that a single Memory Card will allow the stored Content it contains to be played on a wide variety of Players for which the Memory Card contains suitable Client Applications.

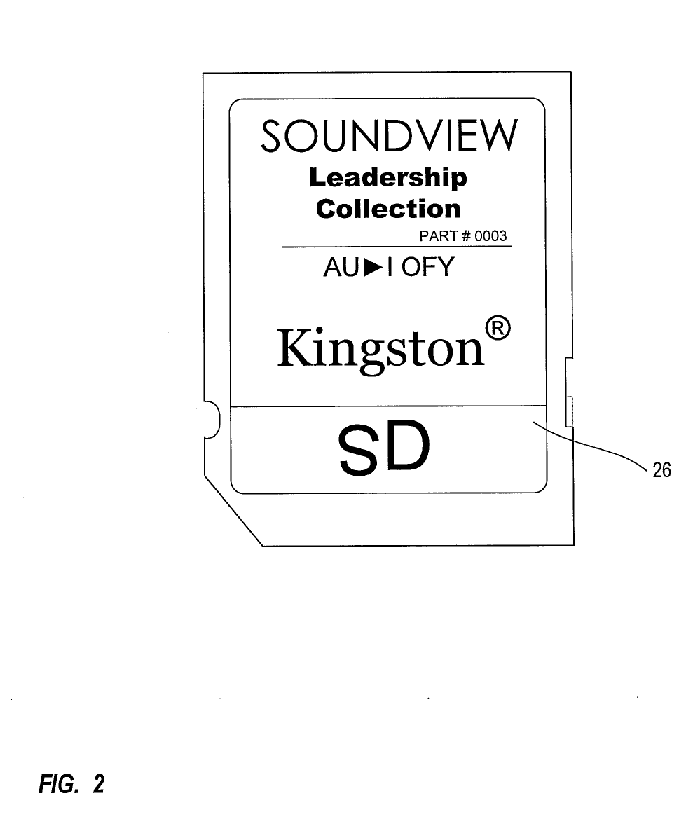

In one embodiment, the dedicated Player 100 provides sophisticated audio Navigation and playback capabilities using a four-button interface, as shown in FIG. 1a: a Pause/Play button 102, which also powers the unit, Backward and Forward buttons 104 and 106, and Info button 108. Info button 108 acts as a gateway to other features in the Player. The Player 100 also includes a knurled volume control knob 110; a standard Memory Card slot 112 for insertion (and removal) of an applicable Memory Card, such as an MMC card 26 (depicted in FIG. 2); a standard audio output jack 116 for the insertion of earphones (which includes earbuds and other listening devices) and/or FM or other transmitters (of a sort that is well known and commercially available) to enable the Audiobook or musical Content to be broadcast to and played on a nearby FM radio (such as a car radio) or wireless earphones; an (optional) small display (not shown) for displaying instructions when needed (in the version for blind and visually impaired persons, displayed instructions can also be played); and a suitable socket 114 for connecting a remote power supply to power the Player, or (optionally) to recharge the (preferably) internal battery(ies) (not shown) that power the Player in ordinary use and are accessible through a conventional removable or otherwise openable door 118 on the back of the Player, as seen in FIG. 1b.

An alternate implementation of the dedicated Player (not shown) may be designed for exclusive use in cars, trucks and other vehicles. The Player functionality and FM transmitter functionality would be integrated with a cigarette lighter plug-in device, of a sort that is well known in the art. Such a dedicated Player would broadcast through the installed speakers of the vehicle's FM radio. In another embodiment, it may have an internal speaker and an internal power source, to allow for dual use in the vehicle or away from the vehicle.

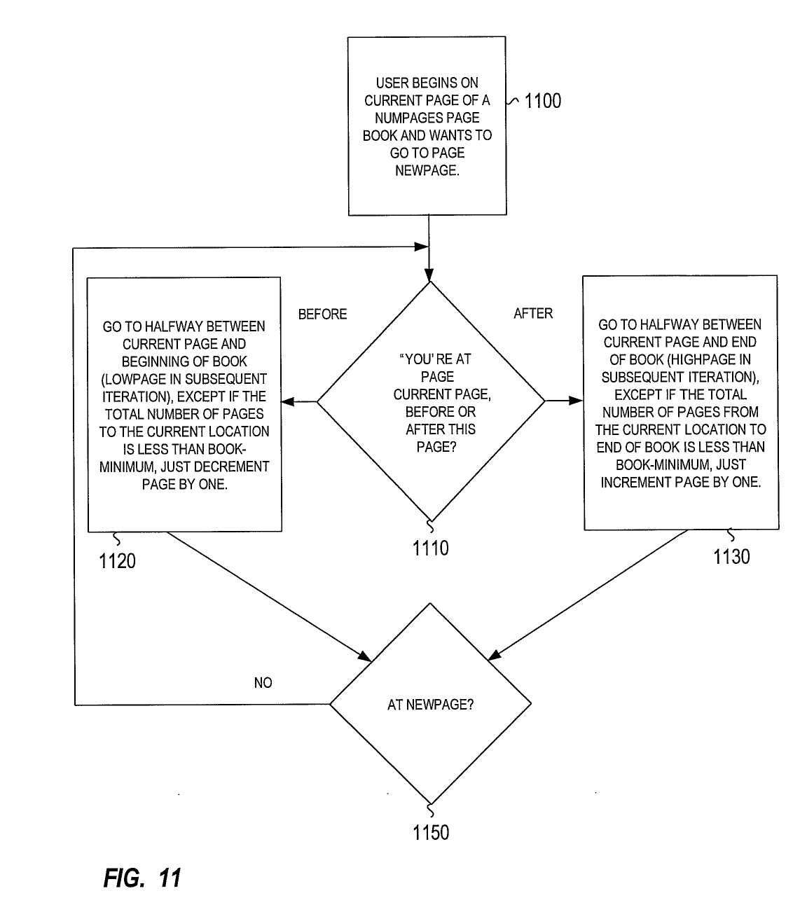

Each Memory Card contains suitable Content. Navigation through the Content is performed by the use of button 108 which executes a Script that offers an audible and optional visual (if there is a display) menu of Player actions, such as movement to specific pages or chapters, the setting or use of bookmarks, and the adjustment of playback speed, without the necessity for “chording” or “button timing.” Chording is the simultaneous operation of multiple buttons to perform different operations. Button timing refers to operations that are defined by the user's use of a delay in either pressing or releasing a button or buttons to perform a specific operation. An example of chording in typing software is the requirement that the shift key be depressed at the same time as a letter key to input a capital letter. Cell phones provide an example of button timing when they require the “end call” button to be pushed for several seconds or twice to turn it off. Chording and button timing are often difficult for users to understand and use, and are therefore optional. Efficient Navigation algorithms may be stored on the Storage Devices, to accomplish particular Navigation requests, including an optional Ping-Pong algorithm, described below and illustrated in FIG. 11, which supports quick page selection.

Each Client Application desirably (but optionally) includes a “pause” feature, to discontinue playback of a Content when the headset (not shown) is disconnected from the headphone jack 116. Playback will resume where it left off when the headset is reinserted in the headphone jack, offering convenience to the user and preserving Player power. Additional power preservation methods include estimating, when the dedicated Player is operated under battery power, the amount of battery power remaining and, if appropriate, reducing functionality and audio quality to attempt to ensure sufficient power to complete the current listening session. For example, search features that require additional processing power can be disabled, or specific bands of audio output could be skipped by the software interpreting the audio packets, reducing processing power. One example, in the case of the Speex codec, would be to play only portions of the Content that correspond to narrowband information, but not wideband or ultrawideband data.

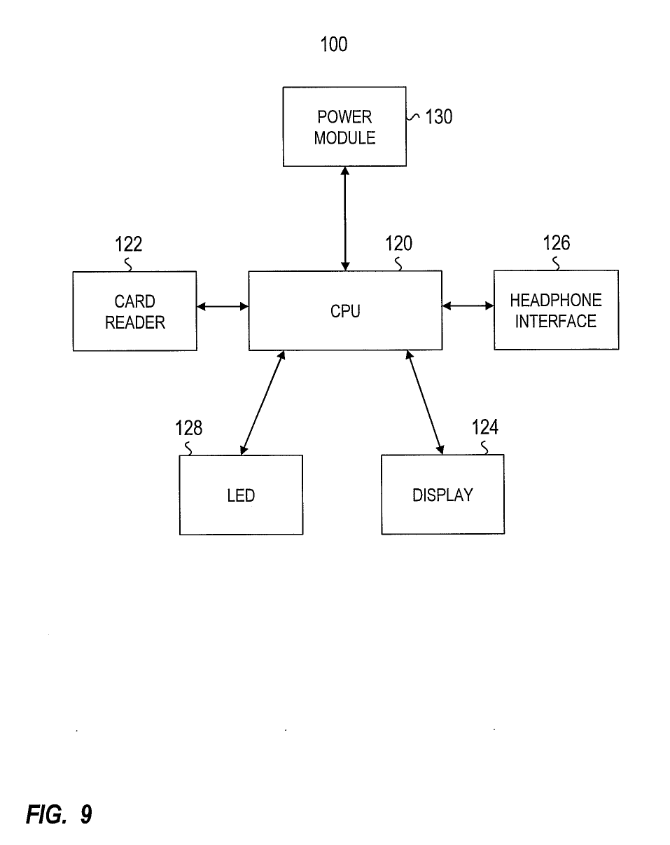

FIG. 9 is a block diagram of an exemplary implementation of a dedicated Player 100 in a preferred embodiment of this invention. Dedicated Player 100 has a central processing unit (CPU) 120 that interfaces with Memory Card reader 122, (optional) display 124, headphone interface 126, light-emitting diode (LED) 128, and power module 130. In one implementation, CPU 120 is an SPL161001 microprocessor, made by Sunplus Corporation of Taipei, Taiwan, having 128K.times.16 flash memory and 64K.times.16 SRAM. CPU 120 is desirably a low-functionality (and therefore inexpensive) CPU; its use enables the Player to be relatively low in cost, when compared to most PDAs, cellphones and MP3 players. Card reader 122 is capable of physically receiving a Memory Card, such as a MMC card 26 of FIG. 2. In implementations where the Storage Device is an SD or MMC card, card reader 122 has a standard SD/MMC card slot, which will accept both MMC and SD cards.

Headphone interface 126, which includes a digital-to-analog converter (DAC), receives digital audio signals from CPU 120 and converts them to analog audio signals for rendering on a set of headphones connected to the headphone jack 116 on dedicated Player 100. The Player can also use well-known Bluetooth or other wireless technologies that enable a wireless headset or speaker to be used with the Player. In a preferred embodiment of the invention, headphone interface 126 provides audio bandwidth of about 50 Hz to about 8 KHz, 40 mW of power for 16-ohm headphones, stereo output, and a signal-to-noise ratio greater than or equal to about 48 dB.

Headphone interface 126 is able to detect whether a set of headphones is connected to the Player's audio jack and provides a corresponding headphone status signal to CPU 120. The CPU uses the status signal to determine whether or not the Player is configured to play back audio. In particular, in a preferred embodiment, the Player 100 is designed to play audio only when the headphone status signal indicates that a set of headphones is properly connected to the Player. In one implementation, if the headphones are disconnected during playback of Content, play is paused and then automatically resumes where it left off when the headphones are re-connected.

In one embodiment, the dedicated Player can be operated with buttons and knobs 102, 104, 106, 108 and 110, as seen in FIG. 1a. As illustrated in FIG. 9, the Player may also or alternatively include a touch-sensitive display 124 that presents a user interface which enables users to control the operations of Player 100 with “buttons”, by applying pressure to appropriate regions (the “buttons” of the display), in a manner that is well-known in the art. LED 128 may be configured to indicate “off-on” status of the Player or it may be configured to have different intensity levels of illumination, in which each intensity level provides a visual indication of the status of the operation of the Player 100.

Power module 130 provides power for all of the active elements in Player 100. In one embodiment, power module 130 has two AAA batteries and a 4-9 VDC external power input jack, such as jack 114 shown in FIG. 1a.

In one embodiment for use with Audiobook Content, once the Content has been prepared by the production system, as described above, the Memory Card contains the following files: (1) compressed audio files, (2) Metadata files, (3) empty Journaling files, which are filled during use of the Player, and (4) one or more Client Applications.

When the Memory Card or other Storage device is placed into a Player, the Client Application associated with that particular type of Player (assuming that a Client Application is available for the Player) is automatically launched. In some cases, the Player does not permit the automatic launching of applications; in that case, the Client Application must be manually launched by the User.

Once the Client Application is launched, it attempts to determine whether or not the requirements of digital rights management have been met. In one embodiment, for optimum security, the Client Application checks for Correlation between the Client Application Identifier, the Content Identifier and the Storage Device Identifier. As described above, the Bullethole Method may be used to create a Memory Card Identifier in a more flexible way. It can also be used with flash media that has no build-in digital rights management system.

In an alternative to this DRM approach, the Client Application will not have its own Identifier. In that case, the Client Application checks to see if the Content files contain an Identifier that correlates with the Memory Card Identifier.

If Correlation exists, the Client Application attempts to load the Content, consisting of audio, Metadata and Journaling files (if any). The user is provided with audio and/or visual cues to help him or her begin to play the Content.

User Interface

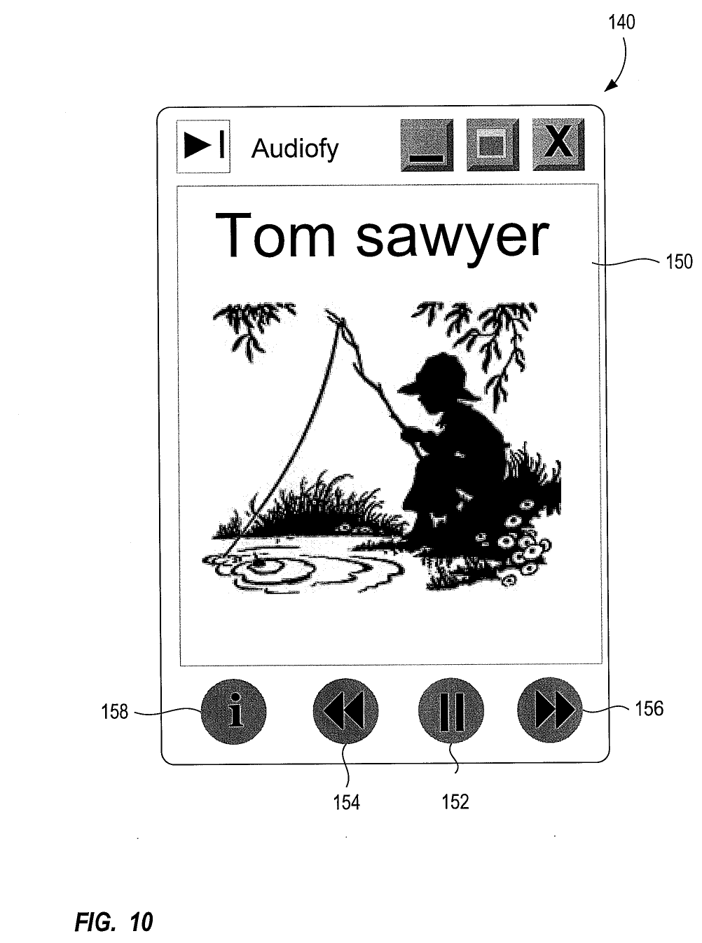

FIG. 10 shows one possible user interface 140 presented on the optional touch-sensitive display 124 of dedicated Player 100. This user interface 140 has the following regions: graphics window sector 150, information (Info) button 158, Backward button 154, Forward button 156, and Pause/Play button 152. These “buttons” correspond to the physical buttons 102, 104, 106 and 108 of FIG. 1a. Optionally, a touch-sensitive volume control feature (not shown) can be included in user interface 140, in a manner which is well-known in the art.

Graphics window sector 150 can be used to present the Player's user with illustrations or other visual information related to the Content. The buttons control the operations of the Player. When the Player is powered off, pressing the Pause/Play button 152 turns on the Player. In the normal listening mode, pressing the Pause/Play button 152 toggles between playing the Content and pausing the audio playback. Pressing the Backward button 154 moves the current location of the audio playback by a pre-defined duration, which, in the preferred embodiment, is defaulted to six seconds for most users, while pressing the Forward button 156 advances the audio playback by the same pre-defined duration. In one implementation, the Player is set to automatically turn itself on, if a Memory Card is seated in the Player and play button 152 is depressed. The Player automatically turns off when the Memory Card is removed or if the Player is in pause mode for a predetermined period of time.

Player 100 stores historical information on Player and Memory Card usage, and optionally includes a time-based record of button presses, Content read, and bookmark information. This archival information may be stored in the dedicated Player 100 (the CPU includes some archival memory and a small outrider chip with additional memory can optionally be provided) and on the Memory Card as well (if the card is inserted and can be written to). This is done to ensure that this information can be used independent of either the Player 100 or a particular Memory Card.

When the user presses Info button 108 (FIG. 1a) or 158 (FIG. 10), the narrative flow of the Content is suspended and the Info mode is entered. The Info mode is designed to quickly and easily allow the user to explore and Navigate the Content, while ensuring that the user can return to the narrative flow with one button press. The Info mode has different functional stages, available upon successive Info button presses. The Info mode can be terminated by pushing Play/Pause button 102 (FIG. 1a) or 152 (FIG. 10), while each particular Info mode stage is ended by pressing the Info button again. If the user does nothing for a set period of time, typically 5-10 seconds, the user will be returned to the normal listening mode at the most recent position accessed in the Content. If the user does not actively change the Content position during the Info mode, then the normal listening mode resumes at the Content position that existed when the normal listening mode was previously terminated.

In one embodiment, for unsophisticated users, the dedicated Player 100 provides no “special” modes from timed button presses or chording.

This mapping of functionality upon the buttons and other input and output channels of the Player is defined by the Scripts. Different stages of operation of the Player can be Scripted to implement different navigational features. For example, a Client Application and Content configured to switch between an abridged version and an unabridged version of the same Content.

In one Player embodiment, five Info mode stages are supported with a simple four-button interface consisting of the Pause/Play, Backward, Forward, and Info buttons, as illustrated in FIGS. 1a and 10, which enable several different modes of interacting with the audio Content. The Stages activated with successive presses of the Info button are:

Stage 1 (one press of the Info button). Book Information

Stage 2 (two presses of the Info button). Chapter/Page Navigation

Stage 3 (three presses of the Info button). Bookmark Navigation

Stage 4 (four presses of the Info button). Set/Delete Bookmark

Stage 5 (five presses of the Info button). Adjust Reading Speed

When the user presses the Info button once while the Player is in the normal listening mode (whether the player is paused or playing at that time), Stage 1 of the Info mode is entered and an announcement identifying the Stage is audibly rendered to the user. If the Info button is pressed again while the player is in Stage 1, then Stage 2 is entered and an announcement identifying that Stage will be audibly rendered, and so forth. If the Info button is pressed when the Player operation is in Stage 5, the Player loops back to Stage 1. It will be appreciated that only one set of “buttons” and one manner of pre-programming the operation of the “buttons” has been described, but that the number of buttons, their operations and sequence can be varied considerably, as desired. What is described above is intended to present a four button (and one volume control knob) Player design which is inexpensive to build, simple and easy to use and provides a reasonable range of functions to meet the user's needs. This design is motivated in part by the fact that many Audiobook users are not technically sophisticated and cannot or will not use computers, PDAs or cellphones to listen to Audiobooks. Therefore, the design presented is intended to be easy-to-use by the unsophisticated (about consumer electronic equipment) user and reasonably functional to meet the user's needs.

In one embodiment, each Stage may automatically insert a statement, such as: “You can return to your reading material at any time by pushing the Play button, or you can access other features by pushing the Info button again.” This “Choice” prompt may be rendered about 5-10 seconds after the user has entered the Stage, to ensure that the user is not at a loss about what to do next. In addition, each Stage will play a statement, such as: “Returning to your reading material” to announce the return to the normal listening mode. This prompt may appear once it is apparent that the user is not going to execute another operation.

The following is a description of operation of the various Stages.

In Stage 1 (“Book Information”), general information about the Audiobook, such as the title, author's name, narrator, ISBN, genre, legal information, copyright information, and retail information (e.g., price, retailer) may be played. In addition, specific information can be played indicating the user's current location in the Audiobook and optional historical information pertaining to the user, such as the number of bookmarks saved, the number of times read, and time-out (if the book has been restricted in some way). Timeouts are commonly used to limit the period of time that the customer has to read the book, which may be useful when the Audiobook is rented. One example of the audio playback during Stage 1 is:

“You're on Page 53 of ‘The Adventures of Tom Sawyer’ by Mark Twain. Narrat26 by Bill Fox. Copyright 2002, by Brilliance Corporation. This Book has 578 pages. The UUID Number is 2322123D. The ISBNNumber is 123456789. The ISSN is A-123444555 More information about this Audiobook is available from Brilliance Corporation. Please see their website at www.brilliance.com. For more information about the Audiofy format, please visit our website at www.audiofy.com. You can return to your reading material at any time by pushing the Play button, or you can access other features by pushing the Info button again. Returning to your listening material.”

If the end of Stage 1 is reached before the user presses the Info button again, the player will automatically return to the normal listening mode.

Stage 2 (“Chapter/Page Navigation”) allows the user to change the current location in the audio Content and proceed to another chapter or a specific page. Note that, for Audiobooks, the concept of page can be defined in (at least) two different ways: (1) as the actual positions of page breaks in a particular edition of the text book that was converted into an Audiobook or (2) as a set amount of time, typically 60 or 90 seconds, that acts as a guide to users as to how far they have listened. While in Stage 2, the Backward and Forward buttons are used to move through the Content. An example of audio feedback during Stage 2 is:

“You're currently in Chapter 4, on page 53. Press Forward to move to a different chapter or Backward to go to a particular page. You can return to your reading material at any time by pushing the Play button, or you can access other features by pushing the Info button again . . . . Returning to your listening material.”

Pressing the Forward button enables the user to move to another chapter within the audio Content, while pressing the Backward button enables the user to move to another page in the audio Content. The following describes the approach used to move between pages; a similar approach can be used to move between chapters as well.

When moving to another page, the user might hear the following prompt sequence: “Page 33—Press Forward to go to a later page, or press Backward to go to an earlier page. If the user fails to press anything, then the prompt is repeated in, e.g., 10 seconds, followed by the prompt describing their options, followed 10 seconds later by a prompt that notifies the user that they are returning to their Audiobook.

When the user presses the Forward or Backward button, an algorithm for choosing a page is activated. If the user is close to the beginning or end of the book, then each press of the Backward or Forward button will move the current position by one printed equivalent page toward the Beginning or end of the book, respectively. For example, if the current position is printed page 10, then, as the Backward button is repeatedly pressed, the user might be prompted with the page numbers: “Page 9”, “Page 8”, “Page 7”, etc. The user can resume playback at the desired page at any time, by pressing the Pause/Play button. At any time during this procedure, if there is no user activity for more than a few seconds, then the user is prompted to move to a particular page; if the user chooses a page, the audio playback begins again at the new position.

When the user is more than ten pages from the beginning or end of the book, a Ping Pong algorithm, as shown in FIG. 11, can be used to move through the Content. Each press of the Backward or Forward button moves the page position to halfway between the current page position and the previously selected low or high page of the Content, respectively. This approach is illustrated in the following sample of audio navigation, which assumes that the user is originally on page 33 of a 300-page book and wants to advance to page 223 (synthetic speech in quotes):

“Page 33. Press forward to go to a later page, backward to go to an earlier page” (Player Moves to Later Page)

“Page 172. Press forward to go to a later page, . . . ” (Player moves to later page using the following formula) [172=(300.times.)/2.+−.3−3]

“Page 236. Press forward to go to a later page . . . ” (Player moves to later page using the following formula) [236=(300−172)/2.+−.172]

“Page 204. Press forward to go to a later page . . . ” (Player moves to later page using the following formula) [204=236−(236−172)/2

“Page 220. Press forward to go to a later page . . . ” (Player moves to later page using the following formula) [220=(236−204)/2.+−.204

“Page 221. - - - ” (Player moves forward one page)

“Page 222 - - - ” (Player moves forward one page)

“Page 223 - - - ” (Player moves forward one page)

Note that the Forward/Backward buttons may be pressed at any time to interrupt the playing of the prompt.

Navigation to a new chapter can be handled in an analogous manner. Note that, for books having fewer than, e.g., 20 chapters, the ping-pong approach might never be implemented. In that case, the current chapter is always incremented or decremented by one chapter for each press of the Forward or Backward button, respectively.

In Stage 3 (“Bookmark Navigation”), a user can move to a specific location that has been designated earlier by a bookmark. Bookmarks can be fixed by the publisher or dynamically created by the user (see Stage 4 described below). The following dialog illustrates typical bookmark navigation:

“You're currently on page 53 of Chapter 4. Press Forward to move to a bookmark after that position, or press Backward to move to a bookmark before that position.

You can return to your reading material at any time by pushing the Play button, or you can access other features by pushing the Info button again.

Returning to your listening material.”

In response to a Backward or Forward button press, the chapter and page numbers associated with the corresponding bookmark may be announced along with the playing of a short excerpt (e.g., a sample six-second segment) from that location. At any time, if the user presses Play, then the player will accept the new location and begin playback from that position. Otherwise, the user might hear the following: “Press play if this is the right location. Otherwise, press Backward/Forward to go to the next bookmark.”

In Stage 4 (“Set/Delete Bookmark”), a user is permitted to create a new bookmark or delete an existing (e.g., user-created only) bookmark. The Backward button is used to delete an existing bookmark, while the Forward button is used to set a new bookmark. This is illustrated by the following dialog:

“You're currently on page 53 of Chapter 5. Press Forward to set a bookmark here, or press Backward to delete a bookmark here.

You can return to your reading material at any time by pushing the Play button, or you can access other features by pushing the Info button again.

Returning to your listening material.”

If the Forward button is pressed, a bookmark is set at that location and the player announces: “Bookmark set. Returning to reading material.” If a bookmark exists at the current location and the Backward button is pressed, the bookmark is deleted and the player announces: “Bookmark deleted. Returning to reading material.” If there is no bookmark at the current location, the option to delete a bookmark is not offered; or, alternatively, when the Backward button is pressed, the player announces: “There is no bookmark at your current reading position. Press Backward to delete a bookmark before this location, or press Forward to delete a bookmark after this location.”

In Stage 5 (“Stage 5. Adjust Reading Speed”), the reading speed can be adjusted to suit the individual user, as illustrated in the following dialog:

“If you'd like the reading speed to be faster, press Forward; if you'd like the reading speed to be slower, press Backward.

You can return to your reading material at any time by pushing the Play button, or you can access other features by pushing the Info button again.

Returning to your listening material.”

When the Backward or Forward button is pressed, the player reduces or increases the reading speed and announces: “Reading Speed is now at the <Slowest/Slower/Normal/Faster/Fastest>speed. I'll play a short excerpt.” The excerpt would be played at the new reading speed followed by the following prompt: “Press Play to return to your reading material; press Forward to increase reading speed; press Backward to decrease reading speed.”

An alternative Script to control Navigation for Audiobook Content is described below. In this description audio prompts are designated by a suffix .afy to indicate that they are compressed using the Platform protocol.

Prompts are currently saved in folders on the root level of the Storage Device, and also within the audiobook TOC.MAU file, also placed on the root level of the Storage Device.

Note that Stages 2 and 3 largely share the same logic; they just have different prompts. As such, when Audiobook levels are treated as a series of bookmarks, or bookmarks are treated as an alternate set of Audiobook levels, the logic can be shared by both stages.

When the user first presses the “info” button, the previous listening position is recorded and an “at bat” listening position is set to the same time as the previous listening position.

The “at bat” listening position is where playback will resume if the user navigates away from the previous listening position, and then presses “play” or allows the entire prompt sequence on the current stage play through in its entirety (without pressing any additional buttons).

### ALTERNATE EMBODIMENTS

The features described above correspond to a relatively basic embodiment of audio processing system 20 of FIG. 3, in which much of the processing by the audio mastering and production systems is manually controlled. This section description optional features that may be included in alternate embodiments of audio processing system 20, Alternate embodiments typically will contain many or even all of the features of the basic embodiment described above, but will have one or more additional or alternative features that extend the functionality of the Player and system described herein beyond that of the basic system.

Audio Mastering System

Audio mastering system 22 creates Audiobooks or other Content that requires unique software to play the Content. For example, the audio mastering system can convert Audiobooks, using more than one audio compression algorithms where different compression approaches are implemented to support different parts of the target Content. This can be done to maximize compression without compromising quality of playback, as noted below. Some examples of such a design are described below.

1. If the Content contains spoken audio and music, the audio mastering system can compress the audio and music with two different compression approaches, such as MP3 for music and Speex for spoken audio.

2. If the Content contains spoken audio of two different narrators, the audio mastering system can compress differently passages narrated by each narrator, by creating Slices of audio sections that contain only one narrator, and then combining the Slices using one of the approaches described above.

3. If required by the target compression file size requested by a customer, Content can be more highly compressed within sections of the Content deemed to be less likely to result in a negative user response (for example, several hours into a narrative).

When creating Audiobook files for a given Title, the Title is evaluated using different compression techniques. Once a model is selected that delivers optimal compression, Client Applications that can decode only the Codecs and compression techniques used for a specific Title can be created. With a loss of “portability” and a small increase in the audio decoding module file size, a significant reduction in Audiobook file size can be achieved. Portability means that the audio decoding module can only decode the particular content of the Audiobook for which it was designed. Storage Device 26 may contain a series of Client Applications, each of which can play Audiobooks on a variety of Players, each of which has a different operating system, including the dedicated Player 100. These Client Applications are not generic, but are dynamically created for each Title. The dynamic creation is motivated by the selection of the many options available while mastering the Content, including an optimized Codec or Codecs, Scripting, Metadata, and so on. As a result, if the Client Application is copied to another Storage Device, the second Storage Device cannot play any other Audiobook or other Content.

The audio decoding module can use Speech Recognition to build Metadata, Script the mastering process, and monitor quality control. The audio decoding module uses speech recognition to build text-based files of the original audio. This is done for several reasons.

First, the operation allows Metadata to be created more easily, by converting the audio tags for Title, author, and narrator number onto a text and subsequent text-to-speech basis. For example, a commercial Audiobook on a CD has most of the Metadata needed to create audio files. However, the Metadata is in the form of analog tags spoken by the narrator at the beginning of the book, at the beginning of each track and/or chapter, and/or at the end of the book. Since the locations of the non-digital audio Metadata are pretty well understood, a speech recognition operation at the right points can (a) confirm that it is Metadata and (b) create a Metadata starting point by taking that speech recognition data and placing it into the audio Metadata structure. When the narrator says: “You're listening to Tom Sawyer,” the system will have time stamps that relate the Content with the text. As a result, the Audio Mastering System should be able to select the “Tom Sawyer” audio data.

Second, speech recognition will support the creation of Scripts for tagging or audio linking as described below.

Third, using speech recognition to recreate the text version of the Audiobook content should provide “hints” for the recreation of a specific author's name or title, if the Text to Speech software does not have hinting in its internal dictionary. Finally, the Text To Speech text may be used to auto-test the level of success in compressing audio content by looking at the success in using Text to Speech on already-compressed speech and comparing the results with Text To Speech on the original content.

The audio mastering system uses Text to Speech software to build audio navigation automatically from existing audio navigation on audio CDs or cassettes. As noted above, the audio mastering system uses speech recognition software and Text to Speech software to convert and create Metadata on the fly, while reducing content size and improving navigation. The content size reduction comes from eliminating those portions of the spoken audio that are supporting the CD or cassette navigation, which also improves navigation.

Optionally, the audio mastering system can use psychological metrics to improve perceived audio quality. In one implementation, the audio quality is adjusted to match a typical listener's perceived level of attention. For example, listeners typically are more sensitive to audio quality at the beginning of an Audiobook, and to a lesser extent at the beginning of chapters and/or sections within the Audiobook. In addition, the audio mastering system can use usage profiles to vary levels of compression without affecting perceived audio quality. In particular, this applies to the case where, in a just-in-time scenario, usage information is available for a specific customer, and the Storage Device is being built for that customer. This could also apply to genres where there is a stronger interest in the Audiobook content and less concern for audio quality. This might be appropriate for religious sermons, for example.

The audio mastering system is designed to simplify and automate the creation and/or conversion of content into the audio format. In particular, the audio mastering system solves problems of converting between standard audio CDs and the compressed and protected files needed for the audio processing system of this invention, as described above. The audio files mastering system also allows or implements Metadata, both global and local information about the audio content. Typically, the audio mastering system operates with standard audio CDs without any information/Metadata to designate them. Most audio CDs are simply a series of WAV files, without tagging or other information.

The Audio Mastering System has the Following Optional Features:

1. A speech recognition program, which is used to tag audio files. The CD audio files are run through the speech recognition module, and text is tagged to the applicable audio segment. The audio mastering system then uses a list, database, or process to determine preface, chapter, and/or appendix or post-content information. This is done by comparing the text database with the standardized narration used by the industry to begin or end content, using that information to create Metadata for the Audiobook

2. Software to remove non-Content material automatically. For example, using speech recognition software, the audio preface to a book could be removed by reviewing the text version of the Content.

3. Software to replace non-Content material with replacement Navigation audio that is either created by a separate narrator or created “on the fly” using a text-to-speech program. Once the two databases of text and audio are created and correlated, superfluous Content can be removed. One example of superfluous Content is the standard verbal cues at the beginning and end of audio tracks: e.g., “You are at the end of Side A of Cassette 1. Please turn the Cassette over.”

4. The use of the speech recognition software to create a word database that uses total number of words, word complexity, and word/time ratio to optimally compress the audio. The two databases, audio and text, can be used to select or create a speech algorithm optimized for that particular subset of words and audio.

5. Use of the Speech Recognition software to create a word database that, together with the associated time tags, can be used to take advantage of silences in the narration in an optimal way.

6. Use of the speech recognition success rates to determine whether or not extraneous information (such as music) is in the original content. For example, if success in capturing text is low in the original content, it may be that music or other non-narrative audio is confusing the speech recognition software.

7. The use of speech recognition to remove the music as identified in item (6). Following the removal, the audio mastering system runs speech recognition software again to determine the success of the removal. For example, if the Audiobook contains an introduction which combines spoken audio with music, standard audio tools (e.g., Sound Forge) can remove the music, and speech recognition software can be run on the resulting audio to evaluate the intelligibility of the resulting audio.

8. The system can then recombine the music with the spoken audio in separate channels for the optimization of later processing. Once the automatic mastering system of this invention has created a text analog that correlates with the audio information, the system can create Metadata files, both for global information, such as the name, title or narrator of the Audiobook, and for “section”-specific data, where “sections” can be chapters, appendices, articles, or even Audiobook compilations of multiple Titles. The audio mastering system uses the information thus created to create the Navigation elements, which includes text and/or audio files that will be used to navigate the audio stream.

9. The audio Navigation elements may then created with a Text to Speech using the text created by the previous operations using speech recognition software.

10. A human narrator may alternatively be used to narrate the text created by the previous operations.

11. The audio is compressed using speech recognition software to define acceptable levels of audio quality. If speech recognition software success rates drop significantly, that drop-off point defines the minimum acceptable level of any particular compression approach.

12. The system uses Text to Speech software to define acceptable levels of audio quality. If the success rate of the resulting compressed audio does not exceed the success rate of the Text to Speech sample, then the audio quality is probably too poor to use.

13. The system compresses audio based on a computed “curve of interest,” where perception of audio quality is rated against the time count within the Audiobook. As described above, typical listeners are often more sensitive to audio quality at the beginning of chapters. One implementation uses a “curve of interest,” which provides a mechanism to slowly reduce audio quality within a chapter without affecting the listener's perception of audio quality.

Audio Production System

The Audio Production System is the part of the system of this invention that takes the mastered audio created by the audio mastering system, and burns it on Storage Devices or copies it on Audiobook servers for use by consumers. Once the Audiobook has been captured, together with Metadata, by the audio mastering system, it is handed over to the Audio Production System, which actually creates the final encrypted files and optionally encrypts the navigation information to protect the Audiobook in the future. The Audio Production System also builds the information onto the Storage Devices. Digital rights management/copy protection is then linked to physically unchangeable aspects of the Storage Device.

One way to create an Identifier for the Platform is the Bullethole Method, described above. Storage Devices that are composed of flash memory, or any hardware media that has a limited Read/Write capability are particular suited to this method, in which the Identifier is written into the Storage Device by writing individual memory locations until a write failure occurs. The Identifier can be written by creating a series of write failures that can later be tested for. One simple example would be to write area memory locations 3030 and 5010, which can be combined to create the Identifier 30305010. Any number of operations can be employed to create an Identifier.

A Storage Device may (and they usually do) come from the manufacturer bearing an Identifier. If the Storage Device does not come with an Identifier, and copy protection or DRM is desired for a product (which is usually the case), the Bullethole Method described earlier can be used to create an aftermarket permanent Identifier. Another Identifier can be developed using other characteristics of the Storage Device that together may comprise an Identifier. One example might be the use of free and used storage, volume ID, or other permanent characteristic of a Storage Device. In either case, the Identifier can be used to create or modify the Client Application and/or Audiobook Content, so that they will only operate on one specific Storage Device (when there is a Unique Identifier on the device) or that series (e.g. model or manufacturer) of Storage Devices, when there is a Particular Identifier on the series of devices. This operation of creating and comparing Identifiers is described in more detail below.

Audio Production System 24 creates Audiobook or other Content using a unique encryption for each piece of spoken content. The Audio Production System may use public key encryption with the Identifier of the Storage Device to encrypt the Content on the Audiobook

In one embodiment, additional security and digital rights management is provided by the Audio Production System by encrypting Audiobook or other Content. Use of the Content requires a Client Application, also on the Storage Device, that contains an Identifier that Correlates with the Storage Device Identifier. Since the Client Application won't run if it is on a Storage Device with an Identifier that it isn'table to Correlate with the Identifier(s) on the Client Application and/or the Content, the Content and Client Application can't be used on other Storage Devices. This interaction ensures that the Storage Device, Client Application(s), and Content are integrated in a way that makes it difficult to use the Content in an unauthorized way (e.g., by using the Content on a hard drive), or by using the Client Applications to read different Content (e.g., by moving different Content to the Storage Device with the Client Application.

The Platform has a number of different ways to Correlate the Identifiers for the Content and/or the Client Application(s) and the Identifier for the Storage Device:

1. The first Correlation method establishes an identical Identifier in all necessary or desirable elements. Usually, this approach is used if the Storage Device is dynamically branded (as in production) with an Identifier, e.g., with the Bullethole Method described previously, or by using characteristics of the Storage Device as described previously. In this method, the production system determines an Identifier, brands the Storage Device with the Identifier, and also Stripes the Client Application(s) and/or Content with the same Identifier.

2. The second Correlation method uses an “Operator” to match to different Identifiers. Usually this approach is used when the Storage Device used already has an Identifier provided by the manufacturer or distributor. In this case, the production system determines an Identifier or Identifiers (they may be the same or different for the Content and Client Application) and an Operator for the Client Application(s) and/or Content. The Storage Device Identifier in this case is Particular or Unique. If it is Particular, copying can be enabled for a particular group of Storage Devices that have the same Identifier. If the Identifier is Unique, no copying is possible, and the Content and Client Application(s) are enabled only for one individual Storage Device. The operator defines an operation that can transform the Identifier for the Client Application(s) and/or Content into the Identifier for the Storage Device. In this method, the Client Application(s) uses the Identifier for the Client Application(s) and the Operator to compare with the Identifier for the Storage Device. If using the Operator on the Client Application(s) Identifier results in a match with the Identifier for the Storage Device, they Correlate and the Client Application(s) is enabled. In the same way, if the Identifiers for the Content and the Storage Device Correlate the Content is enabled.

As an example, the Client Application(s)/Content Identifier (CACI) can be the same for both and is 100. The Storage Device Identifier (SDI) is 3300. The Client Application(s)/Content Operator (CACO) could be defined as “multiply by 33”. If CACI(CACO)=SDI, then use of the Content and Client Application(s) on the Storage Device is enabled.

3. The third Correlation method is similar to the second method, but the Identifier for the Client Application(s) and/or Content can be Particular or Unique. If it is Particular, copying can be enabled for a group of Storage Devices even if the Identifier for the Storage Device is Unique. This is only possible if the manufacturer or distributor for the Storage Device provides an Operator that can define a particular group of Storage Devices. In this case, the production system creates an Identifier for the Client Application(s) and/or Content and a Client Application(s)/Content Operator that, when used with the Storage Device Operator, can determine whether or not there is a Correlation with the Storage Device Identifier.

As an example: The SDI is 3300 and the Storage Device Operator (SDO) is “divisible by 30”. The CACIO is 100. The CACO could be defined as “multiply by 30”. So if CACIO (CACO) is a member of the group defined by SDO, the Identifiers Correlate and the use of the Content and Client Application(s) with the Storage Device is enabled.

A production system making many products would require a more sophisticated algorithm in creating CACI and CACO. Such an algorithm is dependent on a number of variables, including the number of Unique Identifiers needed and variations on the Storage Device Identifier.

As previously described, a number of methods can be used to Correlate an Identifier associated with the Storage Device with Identifiers associated with Content and/or Client Applications. In addition to the direct Correlation of the Identifiers or use of an operator as part of the Correlation, other stored data, executable code, pointer, address, calculation (e.g. CRC or hash) or other value may be used as a link between the Identifier in the Storage Device and the Content or Client Application. As such, this link, when accessed by a Client Application or other applications capable of execution, addressing, comparing or other operation on or utilizing the link, supports comparison of the Storage Device Identifier with a value or quantity associated with the Content or Client Application. If the comparison is successful the Content is allowed to be accessed or the Client Application is enabled or permitted to play the Content.

As an example, a calculation or other processing step may be applied to a portion or all of the Content or Client Application and the resulting value or operand compared or Correlated to the Storage Device Identifier to determine if the system should permit or enable playing Content on the Player. In this example, the link comprises the processing instructions and data that are used to generate a value or operand that is subsequently compared with the Storage Device Identifier.

In one embodiment, playing Content is either fully or partially enabled subsequent to Correlation of (1) the Identifiers or (2) the Storage Device Identifier and the link. Under certain conditions, playing Content is “fully enabled” and the user can play all portions of the Content using all of the features associated with that Content, Client Application, and Player. In some instances—such as when the user has not completely paid for the Content or has the Content on a trial basis—enablement is more limited, and warnings will take place such that the user has access to the Content but sees or hears warning messages indicating that use of the Content must be registered or paid for. Alternatively, time-limited (e.g. next 30 days) or partial access (e.g. 1st five chapters) (and therefore Content that is not “fully enabled”) may be permitted based on the result of the Correlation or comparison.

The Audio Production System creates an assured way to protect Audiobook or other Content even while moving production from centralized manufacturing facilities to regional warehouses or even individual consumers. “Keying together” the Content and the Client Application on a Storage Device can be done virtually, in the sense that the production can be pushed down to regional warehouses, retail partners or even individual consumers As long as the creation of Content keys Storage Device together with Client Applications and Content on that device (when each Storage Device has a Unique identifier) or category of devices (when a group of Storage Devices have a Particular Identifier), risk of piracy is low, since, unlike a digital download, the Content and Client Application can only work on the Storage Devices to which they are being sent. In one embodiment there is no intermediate stage, typically called a “synchronization” stage on a PC, where the Audiobook or other Content can be pirated. Synchronization stages provide a way to move Content from a PC to a PDA or other device.

For example, once a user purchases Content on a website, the user is are provided with a way to download the Content to a Storage Device attached to the user's PC. Since the Storage Device has an Identifier, and the Identifier is known to the website's production system, the Client Application (which may also include the bootloader and embedded) for the applicable operating system and Content are prepared for download by Striping the Client Application and/or Content with the Identifier that Correlates with the Storage Device Identifier.

Since Content is thereby created to work with the Storage Device identified on the PC, there is no intermediate synchronization stage, the Client Application and Content are moved directly to the Storage Device and are ready to be used either on the PC or on any other Player.

The boot process also minimizes improper copy risks. In one embodiment the boot process establishes a secure path to the Player to load a certified operating system or run a certified Client Application on the Storage Device. Information on the Storage Device, Client Application and Audiobook or other Content must all agree before any operation is begun.

The Audio Production System has uniquely flexible features for publishers. Specifically, the Audio Production System works interactively and iteratively with Audiobook- or other Content-publishing customers. Content is reviewed and compressed on the client side to reduce bandwidth cost. The resulting files are then transferred, reviewed, and, when ready, downloaded directly to a Storage Device which is inserted in a PC directly connected to the web for downloading. In this manner, synchronization issues and further copying are eliminated.

The Audio Production System works interactively with customers, building up features, additional Content, and advertising, based on customer profiles. The Audiobook or other Content on a Storage Device can be built automatically based on the user's profile, adding Content, Metadata, and scripting information, so that topical, useful information could be available in a system that rewrites a card daily. For example, if the user's listening history shows that the user is listening to science fiction audiobooks, new Audiobook Content could be customized for the system, as with Amazon's web-based personalization.

The Audio Production System Stripes Identifiers into the Client Application(s) and/or the Content. In one implementation of this invention, Content is created on and streamed from the Audio Production System to a customer's Storage Device as it is being created. Since the Content has already been Striped with the receiving Storage Device's Identifier, intercepting the downloaded Audiobook or other Content is useless, because the Content cannot be played until it arrives on the one Storage Device with which its Identifier Correlates.

In one embodiment the Audio Production System has the following features

1. It creates an Identifier (preferably a Unique Identifier) for each individual copy of Content, optionally derived from an internal database, or alternatively from an existing Particular or Unique Identifier of the Storage Device. The Identifiers are Striped into the Content and Client Application(s).

2. In the case of the audio Player, the Audio Production System optionally creates a unique serial number based on information on the first Storage Device inserted into the Player. This serial number can be based on random number generation available from a number of sources such as Wolfram's algorithms, or other random number generation code or hardware The serial number is unique, but contains identifying information about the model and date of manufacture. This information is stored on the Memory Card being played.

3. The Audio Production System optionally uses the Identifier defined or identified in item (1) to encrypt the Content.

4. It employs a “just-in-time” approach to uniquely create prerecorded Content based on information provided by the customer or distributor.

5. It may place “audio watermarks” in the Content by manipulating the word list.

6. It may place “audio watermarks” in the Content by incorporating the Identifier on the Storage Device in a series of frequencies that can be played by the audio software/hardware, but cannot be heard by human ears.

Audio Client Applications (Software)

In one embodiment, the Client Applications exist only on the Storage Devices. Multiple Client Applications may be incorporated on a single Storage Device to support playback of the Audiobook on many kinds of Players, such as PDAs, cell phones, combined cellphone PDAs (like the Treo 600), MP3 players and PCs, having different operating systems. The practice of the invention provides a different Client Application corresponding to each applicable Player operating system on which the Audiobook is expected to play. It is also possible to provide one or more Client Applications, each of which supports two or more operating systems.

Each Storage Device contains Content with one or more Titles that can be listened to on a Player by the use of any of the Client Applications stored on the Storage Device. This allows the Audiobook to be listened to on any Player with an operating system supported by a Client Application on the Storage Device. All Client Applications may share the same audio Navigation interface. Audio Navigation can be generated from synthetic prompts that include Audiobook information (e.g., page number), Metadata information (e.g., “page”), and Navigational prompts (e.g., “You're listening to . . . ”).

Either or both of the Client Applications and Content may be Striped by the Audio Production System for particular Content and particular Storage Devices to ensure high quality, great compression, and good security. Since each Client Application plays only one digital “copy” of an Audiobook or other Content on one Storage Device, the Client Application can be optimized for quality and compression, and piracy is complicated by the fact that the Client Application and the Content Identifiers must both be compromised (when Identifier are present on Content and Client Applications, as is preferred) to enable that piracy. Audio Client Applications are not “one size fits all.” Rather, each Client Application is built for a specific set of audio files that are optimal for one type of audio Player operating system.

The Client Application software uses audio Navigation, which uses a unique and proprietary superset of the C20-2003-B and Daisy specifications. That audio Navigation, described above, delivers friendly, interactive access to multimedia Content.

The Client Application supports a variety of control options, including time-to-use, times-read, and successfully-understood (in the case of station-level testing). Time-to-use restrictions in the Client Application limit the user to a specific period of time, like a video rental at Blockbusters. Times-read restrictions limit the listener to a specific number of playthroughs of the Audiobook or other Content. Successfully understood restrictions can limit the user's access to an Audiobook as the user navigates through the Audiobook, unless the user (e.g. a student) can pass tests presented at the end of each section, as done in most computer-based training. The Platform supports Storage Devices that restrict the use of the Storage Device based on a variety of static and dynamic settings. For example, for use in the library market, the application can limit the Audiobook to one read-through. For Audiobook rentals, time-to-die settings can be used to encourage the return of the book on time. There are a number of approaches to automated creation of section-level testing of Audiobooks based on quantitative analysis of the Content, where rules are applied to create question-and-answer tests that can qualify the user's understanding of the current section—as is described below.

One approach to automated testing is to use two sound segments: one near the current listener location in the Audiobook and one earlier in the section of the Audiobook or, alternatively, in an earlier section. The user determines which sound segment came first and validates the choice using the Backward/Forward buttons of the Player. Other approaches can also be automated, but require additional information about the Content, typically derived from text versions of the Content. For example, if there is an alternative text/xml track, questions can be created and synthetically generated, which can use the meaning of the narrative for questions. This enables simple automated testing to be used to enhance Content; Content that include text data as well as audio data can be used with better automated testing.

The Client Application also supports different user options and navigation based on user history and preferences. User options can allow a user who is more comfortable with the software and/or hardware to have additional features made available via stages in the Info button. Additional stages may be made available for certain kinds of content. A hypertext stage can be used to define a single hypertext level for the purpose of definitions, translations, or access to information that is not part of the main path (i.e., footnotes or sidebars). Or, the hypertext stage could be used to convert web pages directly, where clicking on the Info button acts as a standard hypertext operation. This assumes that the Info button selection occurs during or shortly before or after the hypertexted audio enables the operation. For example, a converted web page could be read by the Player, e.g., using a synthetic voice. The conversion process builds in a short alert sound that would play just before or during a word or phrase that had a hypertext link in the original document. The feedback would allow the user to click the info button to listen to the text from that link.

If there is repeated use of an Audiobook, user preferences and history may be developed. This feature is particularly useful with frequently re-read books, such as the bible. Contextual advertising could use preferences, history, and/or text of the Audiobook for advertising or other placed messages. For example, as is done with Google, “ad-words” relevant to the audio text could be visually or audibly tagged so that users could receive advertisements relevant to the Audiobook text being heard.

Testing stages may include tests based on the material covered since the last test. Results are stored, optionally used to enable or deny access to new Audiobook content, e.g., the next lesson.

Content mastery can be enhanced by the enabling of new, even extraneous information as a reward for the success in reading particular content, something like giving a typical Audiobook the signaling, messaging, and user-history analysis seen in an advanced videogame.

Dynamically created user logs that store details about low-level user interaction can be used to improve future products, to improve use dynamically for an individual user, and/or to reduce power usage. For example, features that are not popular, or user actions that indicate that the feature is not being used efficiently (e.g., repeated use of a search function) may suggest improvement or replacement of those features. User logs can also be used to improve the operation of the player, by adjusting the user interface, but also by improving the efficiency of power usage in smaller devices, in particular, the dedicated Player 100. Features that prove popular can be recorded in firmware to reduce power usage, either by improving the user interface, or by increasing the efficiency of the code, thereby reducing processor usage.

Audio File Format

Once the Audiobook master has been created by the automatic mastering system and copies produced on Storage Devices by the Automated Production System, the Audiobooks can be released for sale or rental to customers. With the flexibility available from the multiple Client Applications of the Storage Device, customers can listen to the Audiobooks on the dedicated Player 100 or on other platforms, such as Palm PDAs, Pocket PCs, Smart Phones, and Windows PCs, which are supported by the Client Applications on the Storage Devices.

The Audiobook files and their locations make up the File Format.

The file format can have Metadata embedded in it. The File Format also contains flow control information similar to a typical VoIP (Voice over Internet Protocol) stream. Control information is also embedded in the File Format: in particular, Metadata and navigational and informational audio prompts are stored in the data stream, to be played or skipped as necessary. Instead of a series of different files, each containing a particular type of information, the File Format is just a very few files, with code, control, and data all stored together. The Metadata is preferable stored at a location closest to where the user is most likely to request it, thereby reducing navigation time and power usage.

The File Format may have scripts embedded in it. Unlike VoIP data flow, the File Format can contain scripts that can act on the data flow of the Content dynamically, adjusting playback speed, granularity, access to additional layers of Audiobook content, etc.

The File Format includes one or more Client Applications, each application supporting one or more Player operating systems. The Client Applications are unique to a particular Player, Content, and Storage Device. Including the Player's operating system in the File Format ensures that new Audiobooks are not constrained by old standards, leaving future open for new features, media and capabilities.

For example, file formatting can be dynamically improved on a title-by-title or even memory card-by-memory card basis, because the Storage Devices of this invention include both Content and the means (Client Application) to play the Content. By storing the supported operating systems, application code, scripting, Metadata, and Content information on each Storage Device, the Storage Device can be used with a wide variety of audio-based products, from standard spoken audio and Audiobook systems to audio-based games, tutoring, and easy conversion of net-based Audiobooks or other Content.

The File Format can be configured to enable the system of this invention to provide one or more of the following features:

1. The Client Applications for a variety of hardware platforms/operating systems can only be played from the Storage Device. The Client Applications will not operate if copied to another Storage Device or medium.

2. The Client Applications will play only Content that exists on the memory card on which the application is loaded—or from one specific memory card, to fulfill publishers' requirements for Digital Rights Management systems, which includes mechanisms to track and restrict copying of Content. This allows publishers to accurately track and report how many copies of the Content were distributed and to whom.

3. The Client Applications can operate on Audiobook Content by emulating the hardware environment of the Player.

4. The File Format supports the ongoing removal of Content from a Storage Device as it is played (self-destruct option).

5. The File Format supports the use of a radio frequency identification (RFID) code for the creation of a public key encryption system. For example, if the player has an RFID chip, or has the ability to read RFID chips, the Identifier used on to establish digital rights management could be based on the unique RFID number.

Audio Player

In the preferred embodiment of the invention, dedicated Player 100 can be used only with Storage Devices like Memory Card 26. The dedicated Player preferably uses no ROM and maintains a copy of the last operating system loaded into flash memory. If a new version fails to load properly, it defaults back to the previous operating system. The boot process loads firmware from the Storage Device to the Player, so long as the version of the firmware on the Storage Device is compatible with the version of the operating system on the Player. The boot process is designed to ensure a reliable mechanism to quickly determine the latest firmware, and load the firmware in the Player if the firmware is a later version than the last firmware used on the audio Player. Before loading the firmware, however, the firmware's checksum may be tested against an internal list in the audio Player 100 to determine that it is authentic and complete. Once that has been determined, the upgraded portions of the firmware on the Storage Device, including the Client Application are downloaded from the Storage Device into the Player's flash memory.

The audio Player uses audio feedback to deliver information about Navigation, the Audiobook content listened to, commercial messages, settings, and even the record of user activities. The Player can replace a visual interactive system with an audio-based one. For example, audio-interactive systems have existed in the blind and visually impaired market for some time. This apparatus is typically expensive and hard to use, and requires the use and handling of the multiple cassettes or CDs needed to store one Title. The low cost of the dedicated Player described herein and its simple design and limited number of “buttons” to operate it, make it easy for anyone to use. Of course, Braille markings can be incorporated in the Player body or the buttons, to facilitate the use of the buttons by blind or visually impaired user.

The Player uses synchronized visual (via the LED) and audio feedback to simulate non-digital players, to simplify user operation, and/or to accelerate user mastery of both basic and advanced operations. The LED of the Player plays an important role for sighted users, by providing detailed visual information in response to operations and activities on the Player. For example, during normal operations, the illumination of the LED can be proportional to the volume of the audio playback. When the volume is moved up and down, the LED flashes brighter or dimmer, based on the volume setting. If the Memory Card is not installed properly in Player 100, the LED presents a warning, e.g., flashing “SOS” in Morse code. When moving backward through the audio Content, the LED presents a “reverse whirr (cassette) emulation” profile in which, for one possible implementation, the illumination of the LED decays from 100% to less than 10% over a 0.4-second interval. Similarly, when skipping forward, the LED, for example, presents a “forward whirr (cassette) emulation” profile in which, for one possible implementation, the illumination of the LED increases exponentially from less than 50% to more than 90% over a 0.4-second interval. When the audio play is paused, the LED presents a “breathing” profile in which, for one possible implementation, the illumination of the LED increases from 0% to 100% in about 6 seconds and then decreases from 100% to 0% over the next six seconds. Other LED sequences can be designed to indicate the current Player status.

The Player may alternatively use components that measure acceleration and inclination as complements or replacements to other user inputs. For example, navigating a audiobook metadata tree can be accomplished by flicking the wrist holding the player to the right and left to replace forward and rewind button functionality, and/or to incline the user's wrist forward and back to place the player on pause, or to turn it on again. This can be accomplished through incorporation of accelerometers and/or inclinometers in the Player.

Memory Card Packaging

Memory Card 26, containing Audiobooks or other Content, Metadata and Client Applications can, if desired, be shipped to different locations using a postcard or credit-card sized package. Depending on the implementation, audio Content can be played by:

(1) removing the Memory Card from the package, inserting the Memory Card in the card slot 112 of the Player 100 and playing the Memory Card; or

(2) Creating a larger slot in the Player (not shown) that will receive the Memory Card while still in its package holder, in which event the Player could “read” the Memory Card through the packaging material.

MMC and SD cards are about the size of normal postage stamps. In one embodiment of the invention, the package for an MMC or SD card could be the size of a credit card, and include suitable “slots” in which the Memory Cards could be securely held. In that way, the package with the “encapsulated” Memory Card (or Memory Cards) could be inserted in the slot 112 (which would have to be appropriately re-sized). Alternatively, the Player could have two slots, one of postcard size and one of credit card size for appropriate Memory Cards.

The credit card size package may be desirable in some instances because its size makes it easier to handle and insert in the Player slot. This is especially important in the blind and visually impaired market and for persons who have arthritis of their hands. Memory Cards could be created using a wide variety of different shapes and sizes and different size containers. In those events, the receiving slot (or slots) 112 in the Player would have to be sized accordingly.

Memory Card

Memory Cards, such as Memory Card 26, store pre-recorded Content which is integrated with a media-unique identification for each individually produced card. Most media formats have a standard way to map information. The media map for Memory Card 26 is non-standard, because the mapping is different for each version of the Client Application that accesses the information. Since the Audiobook Content and the Client Applications are written at the same time on the same medium, Content-software incompatibilities are removed. Since the Client Application is on the Memory Card, the software only needs to support the audio Content of the Memory Card. No Client Application needs to support more one Title (the single book narration usually recorded on a single Memory Card), which eliminates incompatibility. In one embodiment it is possible to store more than one Title on Content on one Memory Card. For example, MMC and SD cards come in various storage quantities, such as 16 MB up to 2 GB and even more. The physical size of the Memory Card is unchanged for these storage amounts; only the price changes, with more storage costing more than less. However, it is well within the scope if this invention to put more than one Audiobook on one Memory Card. It is certainly feasible to put an anthology of books by one author, a partial anthology, one or more magazines or any combination of recorded Content desired on a one Memory Card.

Since a Memory Card may be mastered from an Internet-based system, the Memory Card may also contain a unique log of the server and version of the Audiobook or other Content written onto the Device.

In one embodiment, the preferred Storage Device is the Secure Digital (SD) Memory Card, created in accordance with standards established by the Secure Digital Memory Association (SDMA). SD cards have the widest acceptance in digital devices and have a sufficient storage size and security feature set to be used in accordance with this invention. MMC cards, SDIO cards and other cards that are relatively inexpensive, small in size, have the capabilities to store large amounts of data, and can read and write information quickly and reliably, can be used in accordance with this invention. Different Storage Devices have different capacities. For example, MMC cards can come with capacities of 16 MB, 32 MB, 64 MB and up to 1 GB and more. As a general rule, the larger the storage capacity, the more expensive the Storage Device. A typical fiction best seller, in Audiobook form occupies about eight cassettes or about ten CDs. Such a book, with a full set of four Client Applications, Codecs, Navigation information and Metadata can be stored on a 32 MB MMC card. The Audiobook for the New Testament Bible occupies about 25 CDs, would require a 128 MB MMC card to store the Content, Codecs, Metadata, Navigation information and four Client Applications.

For a typical Audiobook on a 32 MB MMC card, the Metadata and firmware for the dedicated Player 100 and the Client Applications for PCs, PDAs and other devices requires about 1 MB of memory. The balance of the memory may be used for the Content.

In one embodiment the system and method described herein are realized as an Audiobook storage medium, player, mastering and production system. However, the principles of the methods and systems described herein are also applicable to a variety of other media, such as still pictures, movies, video, music, software or other audio information, as well as vector-based or other imaging solutions, such as Macromedia Flash, and the systems and players of this invention can be modified to accommodate a broad variety of Content. The functionality described below illustrates this flexibility.

Audio Data Manipulation

Compression

Audio processing system 20 is Codec independent. The platform's preprocessing, optimized for narrative quality playback for spoken audio and Audiobooks, is applicable to a wide variety of compression solutions. The platform supports the compression of multiple Codecs to be used for handling Content that may require different levels of compression, or different compression approaches for optimal sound quality, as described previously.

Decompression

The audio playback is built on the assumption that Content may be delivered to the playback mechanism in a lossy fashion. For a variety of reasons, the audio data might not be (1) complete, (2) in order, or (3) include appropriate indexing information. The playback software employs a global model to make a “best guess” as to the best approximation for the audio stream. That “best guess” may be made up of the following information, created as part of the mastering process:

1. Envelope information: The mean parameters of the audio stream created by the mastering system, such parameters including frequency information stored over varying periods of time. This refers to the attack, sustain, and decay envelopes mentioned earlier.

2. Metadata information: A parallel stream of text information that relates to the audio stream may be used in place of missing audio information. For example, synthetic speech might be used to replace the missing audiotext, or even audio that is similar from a text-based point of view could be substituted.

3. Scripting information: An alternative path may be supplied by scripting information if, for some reason, audio data is not available in the default location. For example, if multiple audio tracks are available, then another track could be switched to, for example, moving from an unabridged stream to an abridged one to skip over the damaged or missing area.

Indexing

In one embodiment, the indexing system includes such basic information as is contained with standardized Content-oriented databases, such as C202003, CE2003B, MPV or other standards. However, in one embodiment, when the indexing system is developed to support specifically one piece of Content, it can be used to create a large variety of user experiences, including:

1. The ability to create and deliver learning materials that can be used at different levels of difficulty, based on user feedback or profiling. For example, if a particular user has a profile that indicates difficulty in understanding a certain kind of Content, additional Content can be added or the default speed of playback can be lowered.

2. The ability to interact with knowledge-based databases, both locally and remotely, to deliver a superior experience. Web-based databases may also contain profiles about specific users, which would enable the audio player to personalize the experience, as described earlier.

3. The ability to synchronize different multimedia streams for simultaneous or timed presentation based on static or dynamically obtained data. For example, if audio Content was topical in nature, then some of the data can be dynamically updated via an Internet connection.

4. The ability to update index information during usage based on access to other local and remote indexed information. The fact that the user has access to other information may affect his or her actions as stored in his or her profile.

Scripting

Scripting is an optional, but desirable, capability of the Platform described herein. It is typically independent of the hardware that the Platform is running on, although it is dependent on the specific capabilities of that Platform. New features can be developed for global use with many Titles, or specifically designed for one Title, or even be conditionally created based on other factors. For example, a simple Script could be created dynamically by using user parameters, for example, a Script that adjusts audio playback speed based on a heart rate monitor might combine with a Script that is tracking a global positioning system. The result might be a Player functionality that adjusts playback speed only when the user is not moving in place. Scripting ability can be used in a variety of ways to enhance the functionality of Content use. Some of those ways include:

1. Self-modifying Scripts: A Script can modify itself on the basis of user response as is done in computer based training (CBT) systems, so that an ongoing and non-repetitive user experience is possible. In one implementation, the Script has a series of components that are used only if certain user responses are made, such as the use of the buttons to answer test questions or play simple games.

2. Modeling the user experience: The Platform of the system described herein enables users to modify internal scripts to their liking. For example, Scripts could remove usages of a specific word in Content (as is done in Community Management Systems), where particular words may be considered inappropriate, or periodically switch languages, or speed up or slow down playback of Content.

3. Scripts can be used to create models of acceptable usage. For example, a library could support the ability to deliver “G,” “PG,” “R,” and “X”-rated versions of Content by supplying user age.

Customization

Using the automated publication system of this invention, Content can be reformatted to include information that makes interaction with the Content more desirable. Some possibilities include:

1. Digital Content with a unique signature, which contains information, such as time of creation, value, time for use, number of authorized usages, conditional use of different stations of Content, graduated difficulty (of source material) of stations (e.g., for language-training courses). The storage of this historical information enables the Platform to “customize” its operation for a particular user, similar to the way that historical information is used by e-commerce sites such as Amazon.com to guide the presentation of each user on a dynamic per-use basis.

2. Digital Content that also contains more detailed information about the customer and/or user. Information could include a profile on the preferences of the users, or specific capabilities of the user (educational background, suitably abstracted), specific digital rights of the customer and/or user, specific geographic or other location-based data that could be used to personalize the use of the audio Content or applications. Such information is derived from customer surveys, similar to other surveys filled out by consumers purchasing products or as part of web-site registration.

3. Digital Content that is dynamically based on punctuated or ongoing network interaction with data sources, other users and/or customers, and/or telemetry from the local or remote devices. Such combined information becomes far more useful when combined with user historical information, as is done successfully with devices that combine positional information (from a GPS), with user derived information (where they want to go), and Content (the map that connects the GPS information with their intended destination).

Digital Rights Management

The ability of Content providers to deliver Content in a way that suitably protects the intellectual property rights of the Content owners by reducing or preventing unauthorized copying is an important feature included in the methods and systems described herein. The discussion presented below describes DRM that may be used on Storage Devices, including digital downloads from the Internet.

DRM for Storage Devices

MMC ROM are MultiMediaCards that store their Content in Read Only Memory, which is permanent and cannot be erased.

In the case of MMC ROM cards, common methods used to establish DRM include the use of non-standard file systems, non-standard file formats, and the linking of the Content to a unique key that is stored on each card. Alternatively, a specific location can be established just for use by the audio platform to link Content to a specific physical memory device.

An alternative approach is to have the audio platform confirm that the audio Content is being played on an MMC ROM, which the Client Application software of this invention will do by examining the physical parameters of the memory device. In this situation, if the Content is removed and placed on a computer or another memory card, the Content will not play, since these devices will have different physical parameters (e.g., storage size, created date, modified date, volume name, manufacturer's data, free space, used space, and so on).

Since MMC ROM cards are loaded with content by burning the Content onto the physical memory chips, it is unlikely that pirates will go to the trouble of burning new ROM cards, which is a difficult and expensive operation, unlike Flash or OTP (One Time Process—analogous to CD-R optical media).

An example of DRM used in these systems is implemented by MacroPort, a subsidiary of the Macronix Corporation. This company creates MMC-ROM cards that can use a media-based Identifier to restrict copying.

OTP MMC

OTP MMC Cards are write once memory cards, just as CDRs are write-once audio CDs. DRM may be done in the same way as with MMC ROM, with the caveat that dynamically linking the Content with a specific chip is more desirable since the ability to write to an OTP chip is significantly simpler and cheaper than an MMC ROM card. Having said this, OTP MMC cards available to date use a proprietary solution that requires special software to support writing to the card. It generally difficult for users to be able to casually copy OTP cards onto another OTP card, required for the DRM described above.

MMC and SD

MMC and SD Memory Cards are versatile rewritable solutions for use with the Platform of this invention and with the dedicated Player 100. Dynamically writing unique Identifier information as described above is workable; however, but it is possible that a skilled hacker could replace the serial number of an Identifier in the Content with information specific to another MMC card. This work is of a technical and time-consuming nature, making this type of copying less attractive to most hackers. In one embodiment, the Client Application software of the system described herein requires that Content be placed on a Memory Card and not just on a PC hard drive or similar alternate Storage Device, which makes the economic decision to copy the Content much less attractive. There are many manufacturers of SD and MMC cards. One embodiment of the system described herein uses the Kingston 64 MB SD card, available from Kingston of Fountain Valley, Calif. Other size Memory Cards, from 16 MB to 2 GB are also available from Kingston and other manufacturers.

DRM for Digital Download and Upload

The preferred delivery mechanism for dynamic delivery of Content is based on the delivery of Content through a network like the Internet directly to a Storage Devices that is attached to the computer on the network. This solution, where the Content is delivered directly to an attached Storage Device, is one implementation of the Platform on the web.

An alternative delivery mechanism is an Internet-based delivery system to a computer for subsequent playback on the computer, or on a handheld following synchronization. Although eliminating the Memory Card from the operation makes the resulting product more flexible, it also adds a number of hurdles to users who simply want to listen to an Audiobook or enjoy another form of Content.

Typical methods to protect software downloads include the ability to dynamically create signatures in the content that link usage to a specific customer, environment, computer, or some combination of the three. Also, usage can be linked to time of usage, duration of usage, a specific end date, or combinations thereof. The mechanisms could be implemented with the signature stored in headers of the data, obscured in content data, encrypted as a keyfile, or some combination of these means.

Usage could be limited to one time or continuous access to an enabling mechanism on a local or inter-network. Other potential DRM approaches can utilize more subtle data provided by customer, user, or usage profiles to limit or prohibit usage. As done by websites today, preferred access (or the inverse) can be granted to listeners who fit a marketing profile, as described earlier for computer-based training systems.

Client Application Software

The Client Application allows users to interact with the audio Content. This software is typically specific to a particular operating system, such as Windows, Palm OS, etc., so that multiple versions of the Client Application (typically, but not necessarily, one Client Application for each operating system) are stored on each Memory Card to assure compatibility of this invention with a variety of operating systems. For example, a user with a Memory Card that contains Content will need different software on the Memory Card to be able to play the Content on a Palm PDA, Nokia cell phone or Windows-based PC. The dedicated Player 100 also requires its own dedicated Client Application. Thus, in the preferred embodiment of this invention, the Storage Device may have five Client Applications, each of which supports one of the following: the dedicated Player 100, Windows OS, Palm OS, Pocket PC, SmartPhone, or Symbian. It is within the purview of the system described herein to include on the Storage Device other Client Applications that support other operating systems.

Media Format

Any media format can be supported by the Platform, but some embodiments allow appropriate versions of software to be enabled on their respective Platforms. A variety of partitions or stations of the media may be needed to make this possible. The Content itself is platform independent and can be placed on a Storage Device using a standardized media format such as FAT (“File Allocation Table”, a simple file system in wide use by many companies, including Microsoft Corporation.), where the media may be reformatted to more efficiently store the Content. The FAT system is designed for better real-time access at the cost of efficient storage of data; alternative solutions can emphasize storage size over access time.

One approach is to create a unique media format based on the Content to be placed on the media. Given the serial-based nature of much Audiobook Content, audio media could be formatted without indexes, since media format compatibility is not necessarily required and in fact may increase the price without adding any additional playback features to the Audiobook Content. This is based on an analogy to optical media, which typically has substantial space set aside for error protection. As mentioned in an earlier section, error protection can be omitted and the Storage Device treated like a network audio stream, where the receipt of audio data is uncertain.

File Format

Audio File Format 1

The AFF1 format is designed for use on high-end devices, including PCs, Tablet Computers, laptops and other devices that have high-end processors and sufficient memory to contain a substantial portion of audio control information. The AFF1 file format consists of several different files, either located in folders or concatenated to simplify download and access to the Audiobook. These files can be either in a hybrid XML/binary format, binary only, or XML only, where the data may be on local, remote, or both local and remote systems.

The AFF1 Metadata file contains the structure of the Content, including labeling information for chapters, author information, etc. This file is accessed first by the audio programs to initialize the book structure and load in audio and other information.

The AFF1 audio files is an audio file with C202003 Metadata tags, which are similar to the Metadata information used for most music files on the Internet (see www.cddb.com for details). The AFF1 audio file is a basic audio platform file that requires a TOC.MAU file, a Metadata file defined in the C20-2003 specification, to be used properly.

The AFF1 proprietary file is the central file for the use of Audiobooks on digital media. This small file contains basic ownership information and DRM support. The sovereign file may be combined with files consisting of the data listed in the previous station. This combined file contains all the information necessary for use without fear of piracy.

The AFF1 narration files contain narrative feedback typically, in the form of audio files, but which could alternatively contain instructions for visual or other feedback.

The AFF1 scripting files contain scripting information that allows the audio program to interact dynamically with user choices.

The AFF1 extension files are an important part of the audio Content. Since the audio Content is playable on a variety of devices in a variety of connected and unwired situations, it is possible that different capabilities, such as the ability to display video or recognize audio input, may be desirable. Extension files may be in XML format or in binary format, depending on the extended functionality of interest.

Audio File Format 2

The AFF2 format is designed for use in low-memory, embedded device usage. The AFF2 format minimizes memory overhead and access time by creating a data stream composed of Content, Metadata and software that together define functionality at any particular time. The format contains all of the different file types in Audio File Format 1, with the difference that the data stream is placed sequentially in a file to ensure low response times and low memory requirements for satisfactory user interaction. For example, narration files about a specific chapter may be placed at the head of the chapter to minimize access time to read and play back those narrative files.

In addition, the AFF2 file format defines all data as either global or local. For example, high-level information about the book, such as book title and author, is global, allowing users to request that information at any point in the listening experience. On the other hand, page information or word definitions could be placed near the word in question so that a user request could be economically supported.

Audio File Format 2 is also optimized to support fallback functionality, as described below.

Fallback Functionality

The Player 100 will support a variety of fallback modes, to ensure that users can be provided with some level of functionality even if the batteries are running low, or if, for some reason, the card or card reader is damaged.

Lossy Playback

If a Content file is damaged, the Client Application will minimize the effect of that damage to the user. For example, in the case of failure in the audio stream, the Client Application will cause the Player to recreate the missing bytes and play the closest possible approximation to the audio stream as possible. This technology is well-known and is used in real-time communications, such as Voice over Internet protocol (VoIP). In VoIP, the audio stream is delivered in a way so that it can survive the loss of n audio data packet or packets, and to use the audio in the packets that preceded and followed the missing packet to approximate the missing information. If the audio platform has reduced memory and/or processor capability, the playback operation can selectively reduce or remove the capabilities of the Content. For example, Scripting beyond track-list information could be disabled to reduce processor overhead, or Metadata access could be disabled.

User Feedback

The audio format provides detailed information about the user, so that simple calculations about forecast usage can be made. For example, if the user is listening to an Audiobook for three hours, the platform can make the simple deduction that the additional usage in the near term will be approximately the Audiobook length (e.g., three hours) and make decisions accordingly on power usage or fallback. In the case of more complex devices, such as a PocketPC, power conservation decisions can be brought to the user's attention. It is possible in many situations to let the user know that he can choose to disable certain operations to ensure playback to the end of the title.

Hardware Capability Model

In the case of the dedicated Player of this invention, or in the case of other Players for which the Platform presents a suitable Client Application, the hardware status of the device can be used to more aggressively control power usage, since the firmware has complete, low-level control of the player, unlike Content played using software Players on Palms or Pocket PCs. For example, the Audiofy Player is a single task device that player Audiofy Audiobooks. Therefore, the capabilities of the Player are completely controlled by the platform. With a Palm device, a software player has far less control over the functionality of the device, since a Palm has many software processes running at the same time.

Audio Player

Device Modeling

In the preferred embodiment of the invention, the hardware design of the dedicated Player 100 is optimized for use with an internal design consisting of a bootloader, an embedded OS, and a Client Application. The Player can implement different functionality by simply reading a new Memory Card containing a new Client Applications.

The Player starts up when the Storage Device is inserted or connected, and the boot startup (bootloader) code in the Player tells it to boot off the Storage Device, which loads the embedded operating system and Client Application, which can perform different operations, from language learning to reading Audiobooks to gaming or other operations. The embedded operating system interacts with the Client Application(s) on the card to support user requests for interaction, such as button pressing, adjusting volume, putting the unit on standby, and other operations.

Power Modeling

The power modeling allows the operating system to:

1. Pause operation when the headset jack is removed from the player or when the power jack is removed from the Player.

2. Reduce functionality in order to ensure sufficient power to complete a listening session.

3. Reduce audio quality to reduce power requirements of the microprocessor.

4. Notify the user about the device low power status to prompt changes in user interaction to minimize power usage.

Hardware Player Functionality

Functionality of the audio Player is based on the operating system/Client Application/hardware model interaction created when the Memory Card 26 is inserted in Player 100. This creates a system that can be applied to a variety of multimedia operations as well as a number of different capabilities for the user.

1. Journaling: the platform, including Content, Storage Device, and Client Applications, can support the inversion of multimedia operations; that is, the unit captures audio, video, or other information instead of playing it out. In certain embodiments, the audio player supports such capability in the ability to capture a snapshot of user operation

2. Device interaction: Audio players can be made capable of interacting with other devices. Possible interactions include requests for information, such as GPS, localization information, Content availability, services available, etc. Other interactions may involve the sharing of Content on players or the transmission of Content or other information to other devices or to other networks. Such audio players would have hardware mechanisms that enable such interaction, such as infrared, wireless Ethernet, or Bluetooth. Device interaction can be constructed through the use of “personality” modules within Memory Cards that can be swapped in or out, as needed, as done with SIM cards in GSM cell phones.

Audio Packaging and Storage

This section describes ways to physically deliver audio Content. Prior sections have discussed the Automatic Production System, with which the product can be dynamically created. The Platform of this invention enables particular business procedures, delivery systems, storage solutions, and user-oriented mechanisms, to enhance the Content usage.

Fulfillment and Use

When Content is stored on a thumbnail-sized Memory Card, such as MMC or SD cards, these memory cards are small and may present a handling problem to users. This invention includes a Memory Card holder, which can be about the size of a credit card. Many packages use this size, although not any media Content. Audio Content can leverage this existing technology to deliver its media in a compatible and convenient way.

Credit-Card Form Factor

An easy to handle credit-card-size package that can store one or more Memory Cards is a convenient way to package, deliver and even play Content, if the Player is constructed to accept the package. The package can take several forms, such as:

1. Card pouch: Memory Card is stored in a pouch on the package.

2. Card sandwich: The package has a cutout for the Memory Card(s), which is (are) sandwiched between two layers.

3. Card tray: The package is thicker than a credit card and has a molded recess or recesses for the Memory Card(s).

Content Creation

Using the Automated Production System of this invention, Content can be created and stored on a Storage Device containing information that makes the interaction with the Content more desirable, including one or more of the following:

1. Customized packaging for the delivery of Content. For example, unique information is printed on the memory card label, on the memory card itself, on the package, or on other materials that are included within the package.

2. A system that models the audio memory card as a “book on a chip” that draws on customers' mental modeling of the product as a replacement for the cassette tape. For example, the system would use visual, audio, and tactile references to cassettes in the system. Audio feedback directly recorded from cassettes could be used, or cassette art on the physical medium of a new system could be used.

3. Packaging that suggests a relationship with the cassette tape, including the use of the graduated circle, either graphically or as a shaped part of the package.

4. Packaging that can use the existing delivery mechanism utilized by credit-card systems, such as vending mechanisms, credit validation devices, smart memory card creation or editing systems, etc.

Storage

The use of Memory Cards, in particular MMC cards and other memory cards of similar size and functionality (SD cards, or Compact Flash, SmartCards, and other formats), may need storage solutions that can reduce or remove the problems associated with the physical size of the card as well as the use by the consumer of multiple cards. The use of a credit-card-size storage container for memory cards has many advantages including the ability to use all containers that are currently optimized for the credit-card format, including wallets, kiosks, frames, organizational devices, etc. In addition, the manufacturing hardware that is already in use for the creation of this paraphernalia can be used with little or no modification to create accessories and/or storage systems for the audio Content on Memory Cards.

Designs that incorporate the credit-card form factor can be used to simplify and/or amplify the general user capabilities of the audio Content, players, and/or other devices.

Such designs include:

1. A credit-card-size and shape “holder” that supports the active mastering of Audiobook Content, while the Memory Card is in the holder. For example, in the case of an audio-Memory Card vending machine, each vending machine will have a supply of holders, each with one or more with Memory Cards securely inserted, so that the Memory Cards could be written in the machine while in their holders and dispensed with the Content loaded on by the machine.

2. The holder can enable the Content to be played, while the Memory Card is on the holder, which is inserted in a suitable-sized slot (not shown) in the Player.

3. A holder that supports inventory and other organizing operations, while inserted in either an audio Player or some other device or container that can be made aware of the Storage Device and/or Player. For example, a system could be created that uses the magnetic strip on the holder to store the typical Metadata—book title, publisher, price, etc. Alternatively, such information could be place on the holder and ready from a UPC symbol or an embedded RFID tag.

4. Embedding an RFID chip in the holder, to support passive and/or active reporting of the Content to other devices for inventory or other operations. For example, using well-known RFID technology, the RFID chip could be used to activate the internal Content or, alternatively, to activate an authorized Player.

Unique Fulfillment Hardware

A variety of systems can be created to deliver Content for customers in many different environments and situations. The following describes a number of different variations that the audio Content could use in final fulfillment to customers or distributors.

Vending systems, similar to those used for gift certificate or token operations, could be modified to be used to deliver either existing Content on Storage Devices. Some systems could have the ability to create some customized level of Content based on user preferences either made clear manually at the vending machine, by use of profiling information available at the machine level, or over networks, or in some combination.

A kiosk system could be even more powerful, creating Content and/or packaging, or portions of the Content or packaging dynamically. Content could be reformatted to different Codecs, levels of difficulty, number of uses, functionally limited, or with other unique and customized capabilities depending on the customer use. The abilities to add Metadata about the Content delivered is also possible, such as the ability to add a dictionary tailored and synchronized to the Content or geographically relevant information to a travelogue, etc. In addition, other materials such as topical information could be added to the card to create a uniquely fulfilled product.

Audio Media

Possible audio media include standard off-the-shelf Storage Devices, such as MMC, SD, SDIO, and other standard media. It is possible, however, to substantially reduce the costs of Memory Cards by removing from the Memory Cards the functionality and compatibility with other packaging; and by retaining only those minimal features that are relevant to the audio platform as described below.

If compatibility with existing Memory Cards is not required, a Memory Card could be designed without a controller, making it less expensive to use. The controller loss can be compensated for in part by the Platform's ability to use lossy streamed data.

It is possible and/or desirable to use Storage Devices that have higher-than-normal latency, or defects that would make them undesirable for standard card usage, but would be acceptable for Content that would accept a file format designed around those specific problems. Such a solution would work for the audio Content, but since the audio Content has no particular limitations for a specific media format, such as FAT16 or NTFS, this is not a limitation. NTFS is a file system designed by Microsoft Corporation and used on most Windows PCs.

### ALTERNATIVE EMBODIMENTS

The Platform can reduce or eliminate the problems that exist with static products currently in use. The Platform is designed to work reliably with different Content, Players and Storage Devices, while minimizing conversion costs.

One approach for the Platform is to completely dispense with audio reproductions of Content and rely on algorithms to deliver audio playback from a combination of text Content and “hinting” technologies described above that would improve text-to-speech technology to the extent that it could adequately replace spoken narration. In addition, scripting could perform more complex functions, such as tests, games, or simple database or utility applications. For example, the Text to Speech servers from Rhetorical Systems, have a “deep” model that outputs phonemes, along with time stamps for the original text. Using those phonemes, the text, a usage dictionary, and a compression engine like Speex could enable a text to speech system to directly output a “hinted” phoneme stream that could be interpreted directly by Speex.

Discussion

Audio Player systems become more attractive as Storage Device and player costs are reduced. Media costs can be reduced by increasing the compression of the Content or changing the Content medium. For example, the Memory Card can be replaced with a paper-based medium. Advantages to a paper-based system include the ubiquity of the medium and the ready availability of production systems for such a medium. However, unlike Memory Cards, paper is analog, so that the reading mechanism becomes substantially different, as do the methods of creating and reading the Content.

One system that can be used to create paper-based Storage Devices is the Logitech “io” Digital Pen by Logitech Inc. of Fremont, Calif., a pen-type system that captures writing as a way to enter notes or emails into a PC. This system can be used to capture existing text by tracing. The disadvantages of this system include hardware expense, the requirement of special paper for storage of information, and the tethered nature of the device, because work done with the io pen is not particularly accessible until the pen is connected to a PC for uploading.

Another series of paper-based systems that can be used as Storage Devices include systems made by WizCom Technologies Inc. of Acton, Mass., that can scan a word directly by swiping the pen on the text, read the text, provide dictionary definitions, and capture the text for later use, like the Logitech “io” pen. These devices are also rather expensive and are very sensitive to the kind of text being read. For example, as with page scanners, the quality of the text being read, including font size or type, paper quality and other variables, reduce the likelihood that the process is correctly reading information.

One of the goals of the method and system described herein is to maximize the efficiency of interaction between the Storage Device and the Player, so that the Platform is less expensive to implement, simpler to use, more reliable, and better suited for production and use, when compared to prior art devices and systems.

Other Devices

Many products exist for the purpose of aiding the visually impaired. In particular, several devices exist that can play back, via Text to Speech, the text content that they read, such as Expert Reader by Xerox Corporation of Stamford, Conn., or the Kurzweil 1000 by Kurzweil Technologies, Inc., of Bedford, Mass. These devices are typically expensive and not portable, drastically limiting their usefulness to the general public. Other devices, such as the Scan 'N Talk by Colligo of Bellingham, Wash., are significantly less expensive but require a connection with a PC to work. The dedicated Player described herein is less expensive, more flexible, and supports the same capabilities as these other devices, as is the use of Memory Cords containing Content in accordance with this invention and used with other Players, such as standard PDAs, computers, cell phones and MP3 players, that are ubiquitous and available without additional cost to those persons who have them. This is possible because the Platform described herein better distributes the data flow in and out of the Player in a way that is similar to Internet-based server software that uses decentralized scripts that require less power, maintenance, and space to operate.

Using Paper Media as an Audio Digital Storage Medium

There have been many different systems that bring digital information from a paper surface. The most popular are bar-coding systems, such as the Universal Product Code (UPC), that enable a relatively inexpensive device to reliably capture a small amount of digital information reliably. The UPC system was created almost twenty years ago, with a primary goal the identification of items for sale. It is impractical for information which is more than a few hundred characters of information.

Another solution is Optical Character Recognition (OCR), where a scanner captures information from typed or printed text on a page. OCR systems suffer from the fact that they are “after-the-fact” systems that are forced to deal with an existing marking system (type) that is optimized for human, not digital use. In fact, OCR fonts that are optimized for machines are typically harder to read by humans.

A more-practical solution is a higher-density paper-based solution such as Xerox's Glyph solution. Glyph provides higher compression together with a minimally distracting appearance to a human user. It can be placed on images, in the background of text, or below or to the side of associated text (if there is any).

It is possible to use memory cards as an analog medium as well, where audio processing system 20 can interact with a user in a variety of ways, as described below.

Spoken Audio Output

Using paper for storage enables support for audio playback of Content using Text to Speech technology or using a phoneme-modeling language. A typical data rate for either Text to Speech or phonemes is low, less than 30 to 40 bytes per second typically. This section discusses some of the other potential data streams that could be supported within the audio platform model.

Unlike a Memory Card, paper is essentially an analog medium. As a result, a substantial amount of the “bandwidth” of paper is taken up by error handling. However, in the case where the audio system is supporting an analog audio output, it is possible to create a lossy stream of audio that contains its own mechanism for handling packet loss, etc., as is done in VoIP or other net-based audio solutions. Since lossy streams have effective handling for packet loss, some or all of the paper “bandwidth” taken up in error handling can be more efficiently handled within the VoIP-type stream handling. Assuming a lossy model internal to the data results in an effective rate of 700+ bytes/square inch or 1.5K for every two square inches, which can correlate to an equivalent line of text on a page (typically 6 inches or 4 seconds of read content). This assumes a minimum bandwidth for highly compressed CELP-type audio streams. This means that the audio solution can effectively play compressed audio Content using a paper-based solution.

Music

The audio solution of the system described herein is not limited to spoken audio output. MIDI-based solutions have bit rates well within the bandwidth suggested by the information above. The MIDI model that abstracts the musical structure from an analog recording is similar to the Spoken Audio alternate embodiment approach described above. In fact, combined streams of MIDI plus spoken audio are reasonably possible. At the lowest quality settings, a three-minute song can be compressed to as little as 300K or less. Such a song could be encoded on a page or less of encoded lines.

Video

Even video streams are a possibility for utilization as Content within the purview of the system described herein. For example, typical streaming rates for a video stream for a PC-modem combination do not usually exceed 30 KBs or 4 KBs. Short video clips could be played back from several encoded lines in a book.

Since video is also a lossy medium, the same arguments for using net-based videoconferencing solutions for handling packet loss, instead of incorporating them into the encoded lines, means that effective data-throughput is improved by pairing lossy inputs with lossy outputs.

Such a solution could mean that paper could encode spoken audio passages, music, video, or any combination thereof. It could also mean that a simple, inexpensive device employing the audio technology could act as an audiovisual training device. For example, a few encoded lines on a car repair manual could display the location and installation of a part, or encoded lines acting as a background in a book could provide dictionary definitions for a word, pronunciation, translations into other languages, and so on.

Web Pages and the Internet

Finally, the Platform described herein can leverage its Metadata component and add an additional dimension to reading a textbook. Strategically placed encoded line segments could be used to add hypertext capability to the text, without web access. Although such segments would typically be static, it is possible to use them to “link” different parts of the same book, books in a series, or even in the same library. It is even possible to personalize or customize a response given user modeling. Given a simple survey before a book, the reader/user can customize global questions like volume control, language, “terse/talky” options, etc., and can also provide additional information about previous books written, the user's capabilities, etc.

Programming

As with the present audio system on Memory Card, a paper-based OS provides unique flexibility to create different features and products with each Title, while providing a standardized application program interface (API) for “bookware” creators with which to adapt their Titles. Initial uses of the present audio API would be to “read” a book using a simple phoneme player, or provide simple enhancements such as a static hyperlink to a definition. One example would be to take a standard text dictionary and add encoded Content so that the words could be read, where the definitions are provided as encoded Content to be played back.

Additional features would include the ability to leverage the spatial location of the encoded Content within the book to support the reader's ability to make connections between one piece of text and another (a simple test), between graphics (analogy-type tests or puzzles), or even to use a page filled with encoded lines to support drawing and sketching tools (e.g., using a “Glyph-type” encoding approach). A user might sketch on the page and be directed to another page with the shape closest or otherwise connected to that shape.

Other simple applications include MIDI (Musical Instrument Digital Interface)—enabled sing-along. Using a coordinate system set up by the encoded Content, it would be possible to create a game employing dynamic audio/video feedback against a static text page or pages.

Using a “middleware” approach, where the encoded Content is an analogy to “applets” on a PC system, the present audio firmware in the reading device captures a few lines of encoded information at the beginning of the book. These lines provide the base application from which further lines within the book are interpreted and acted on. Each simple applet can accomplish a few things very well, but the interpretation of the Content is up to the user, who can select each successive applet based on his interest and understanding of the Content. One way to describe this is as a “treasure hunt,” where each cache of treasure contains instructions on how to find the next cache, but the treasure hunter isn't constrained to those instructions.

A mechanism for encrypting Content would be similar to the approach described previously. However, the easy availability of individual scripts suggests that some kind of header should be used that will independently coordinate and guide the user. For example, in the event that a user fails to read in the required applet at the beginning of the book, subsequent scripts would remind the user to go back and do so.

When digital Audiobooks can be downloaded on the Internet, additional capabilities can be added to ensure security for content, simplify the acquisition and management of content and to create and build relationships between an operator of an Audiobook company and consumers, publishers, and third party vendors. This section of the specification describes some of features of an implementation of a Relationship Manager (RM) for Internet download. In one embodiment, the RM aggregates, downloads, and manages Audiobook content.

The RM is designed to support the management of all kinds of multimedia data in many formats. The RM is designed to manage content that has different levels Digital Rights Management. The RM is designed to manage content that is local, remote (i.e., on another PC), distributed using a P2P client such as BitTorrent, or aggregated using Really Simple Syndication (RSS).

At the heart of most ecommerce systems, that relationship is very simple: has the consumer paid for the product or not? The RM is designed to establish and maintain a broader and deeper relationship between consumer and content.

As described earlier in this specification, the platform supports a number of features in the mastering, production and use of Audiobook titles, such as the ability to limit playback to support different business models: a queue based model (in which a certain number of titles are always available to the consumer), Book Club (a certain number of titles are delivered on a periodic basis), Library (titles are available for a certain period of time), DIVX (titles self destruct after a specific number of usages, typically over a particular

However, these business models all presuppose a very static relationship with the customer. The customer has paid money for access to the publisher's content; that access has been restricted in a variety of ways, and those restrictions limited customer access to the content by publisher, a lower level of interest by the customer, and loss of revenue on the part of the publisher.

The advent of digital copying and piracy has complicated these business models, and has made some of them less profitable to use. For example, the combination of audio digital CDs and the Internet has strained the relationship between music consumers and publishers to the extent that music publishers are suing customers that have violated publishers' copyrights on their products. Although there are many ongoing discussions about the meaning of fair use, the clear answer for the moment is that there will not be one answer that individual publishers, authors, countries and association will agree with. As a result, the RM can support the different business models, both using the platform described herein and other platforms as well.

The RM augments this static financial/IP relationship with new dynamic mechanisms that enable an ongoing relationship between the customer and the content's publishers. These new mechanisms establish value in a way that removes (or at least reduces) the problems created by a static relationship. These new mechanisms are:

Provenance

Provenance of content is a critical part to establishing value for it. The history of content and the trust that you can establish about that history becomes more and more important to the extent that the content is in some way commentary on other content. In an extreme example, a paragraph stating that a movie is “thumbs up” has little or no value unto itself. A paragraph stating that a move is “thumbs up” has substantial value if “Siskel and Ebert” is added to it.

There is often confusion regarding the value that “Siskel and Ebert” brings to the content. In fact, if there is no provenance to establish the relationship between the movie, “thumbs up”, and “Siskel and Ebert”, there is no value to the content.

In a similar way, Barnes and Noble has released many books, the contents of which are in the public domain. The success of these releases is due to the fact that Barnes & Noble has established the provenance of those titles in a way that a generic title (publisher) cannot do.

The RM establishes provenance for all titles not only through ISBN/UPC, but also via the CEA-2003 standard which supports a more detailed description of the ongoing provenance of a title through edits, reviews, translations and so on.

The ability to review, comment on and add additional information to content is a vibrant part of Internet communities, but that vibrancy cannot be reflected in a static relationship between content and consumer. As the content changes through editing, commentary and so on, so does the consumer, as they talk to people, read books and watch videos.

The RM establishes a commentary mechanism by supporting content deep linking and review, similar to what it currently done in most blogging systems. The difference is that the RM is aggregating commentary from multiple sources regarding particular media titles.

Trust

The ability to evaluate the trustworthiness of a file based on provenance, commentary and other tags, including popularity.

The RM includes information that creates a relationship between the customer and publisher or artist/author. With respect to Provenance, the metadata for each title includes a nested recorded of prior versions and ownership. Optionally, this metadata record can include a way for the publisher to notify all customers of changes in the content (a new version, for example, or correction to appendices, etc.). Similarly, metadata record is created that contains information about available Commentators and Trustees for the Title.

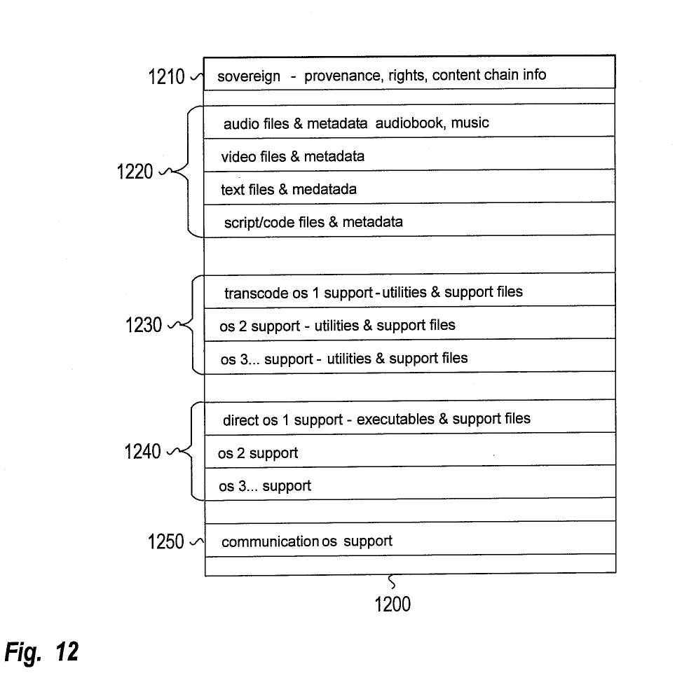

In a further embodiment of the invention a “Sovereign Link” is used to implement the RM and other features. FIG. 12 illustrates the contents of an Information Unit 1200 or container in which the Content and Metadata are stored. The Information Unit 1200 can be a virtual (existing in a larger storage media) unit or can describe the contents of a particular memory card or device. As illustrated in FIG. 12, a sovereign section 1210 can contain a Sovereign Link and other data indicative of provenance, rights, and Content Chain information. As depicted, included in the Metadata is a Sovereign Link. As described herein, a “Sovereign Link” is a unique, authoritative link for parties in the Content chain (including author, publisher, renter(s), customer(s), commentator(s), etc). Like more conventional links, such as those used in blogging, a Sovereign link permits tracking back of content changes. However, a Sovereign Link tracks back in a manner that is moderated by its definition. Thus, by way of example, the author of the Content can define a Sovereign Link in a manner to preclude comments, or to limit comments in some manner. In this manner the Sovereign Link permits separation of the information content, the person making the comment, and the subject matter.

As illustrated in FIG. 12, a media file section 1220 is included which contains media files and associated Metadata. A first support section 1230 can be included in Information Unit 1200 which includes layers that typically transcode and transfer media/Metadata to a given operating system or dedicated device environment. This is typically done when direct control of the operating system or environment is unavailable. In a preferred embodiment the first support layer is optional.

Also as illustrated in FIG. 12, a second support section 1240 can be included that contains layers that are typically recognized directly and which execute media/Metadata in the recognized OS or dedicated device environment. This is typically done when direct control of the operating system or environment is available.

As depicted in FIG. 12, the unit contains a communication support section 1250 which contains one or more layers by which user generated Metadata can be communicated with one or more files associated with the Sovereign Link. In alternative embodiments of the invention, this layer, as well as each of the various other layers depicted in FIG. 12 may not necessarily be present in the unit—with the exception of at least one media file being required.

In a further embodiment of the invention, the Sovereign Link incorporates deportilization. That is, the Sovereign Link merely points to a place where the information is available, which place is not necessarily portal based. In this manner the Sovereign Link provides a means where people can share content. For example, users can link to information to create mashups or to provide content or comment.

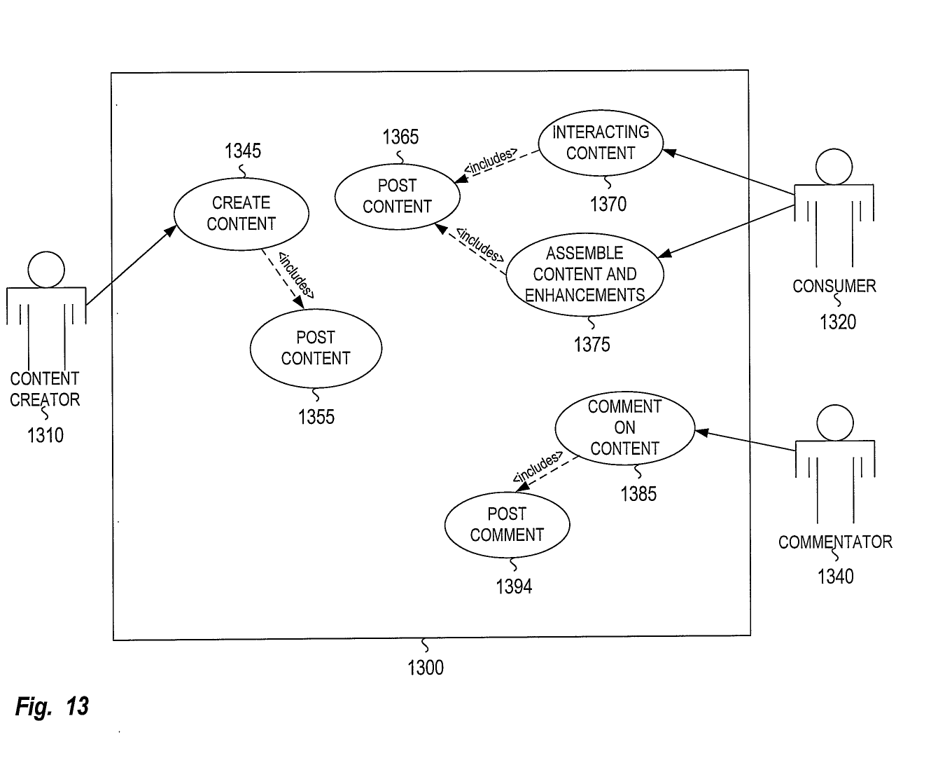

FIG. 13 is a Use Case Diagram, employing Unified Modeling Language format, which depicts a content creation system 1300. Actors that interact with content creation system 1300 include Content Creator 1310, consumer 1320, and commentator 1340. In content creation system 1300, Content Creator 1310 can create Content in the format depicted in FIG. 12 (and thus having a Sovereign Link) by invoking the create content action 1345. The create content action can include a post content action 1355. By way of example, this Content may be 20 minutes of audio data. Consumer 1320 can interact with the Content through an interacting comment action 1370 and assemble content and enhancements action 1375. Interacting comment action 1370 and assemble content and enhancements action 1375 can include a second post content action 1365. In one embodiment the content and enhancements are posted via the Sovereign Link. The Consumer's interaction with the Content is also posted. It should be noted that the Consumer's interaction with the Content includes acts by the consumer such as the manner in which he views or even purchases the Title, in addition to more explicit acts such as providing commentary. Similarly, commentator 1340 would provide comment or Content which is also posted. Commentator 1340 can provide comments through a comment on content action 1385 which can be posted through a third post comment action 1394. It should also be noted that the characters as depicted in FIG. 13 are interchangeable.

Through the use of the above described Sovereign Link, the present invention permits Metadata to be created and permits comments to be made to that data that is separate (e.g., in time) from the original content. It further permits, by defining the Sovereign Link, the filtering of comments.

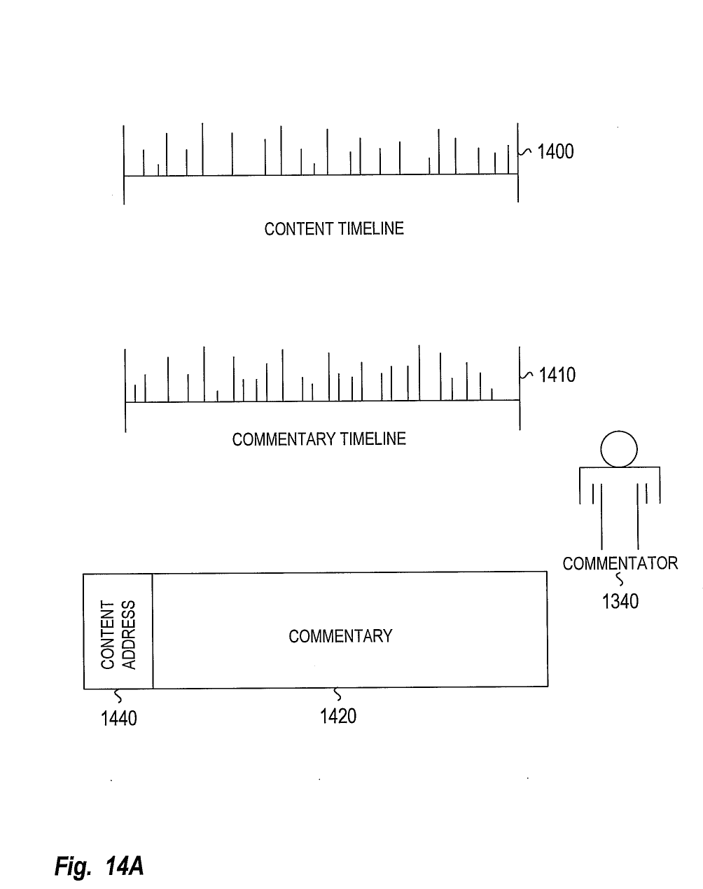

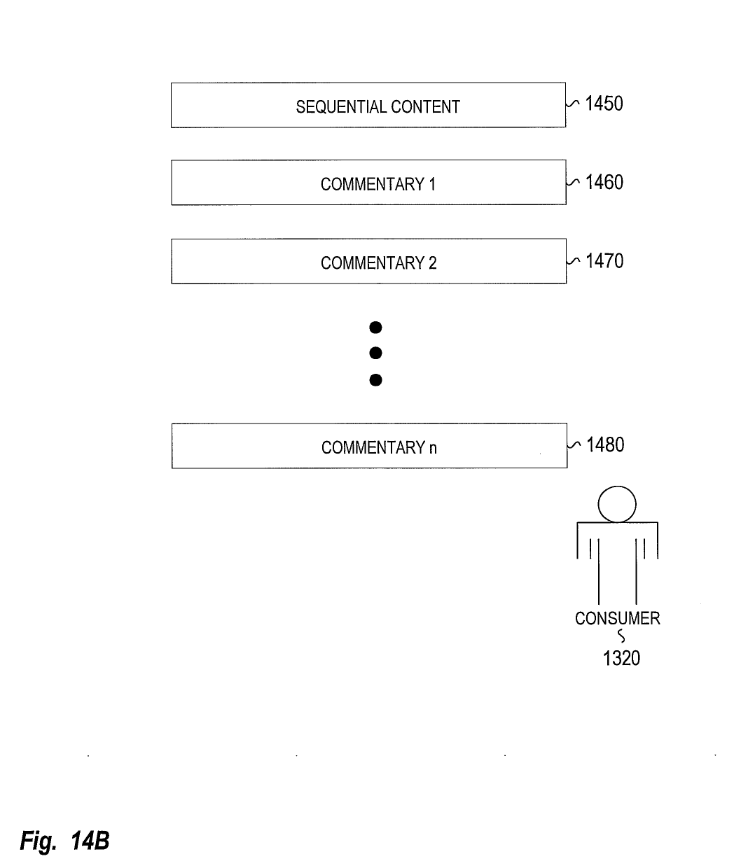

FIG. 14A depicts a further aspect of the invention in which the original, sequential Content (e.g., an audio or video presentation) is expressed using a content timeline 1400. As illustrated, commentary is provided via a Sovereign Link. As further shown, the commentary itself can be provided with respect to a timeline in commentary timeline 1410, whereby information is provided relative to specific points in time of the original presentation. Content commentary can be provided in a package comprised of commentary 1420 and a content address 1440. The content address can serve as a sovereign link. FIG. 14B illustrates how a consumer, using a set of parameters, can access the sequential Content and any number of commentaries that have been posted via the Sovereign Link. This feature of the invention can be used to synchronize text to an audio book. It can also be used (e.g., utilizing two tracks) to listen to posted audio comments at the same time as the original audio Content. A further embodiment of the invention permits the “time line” to utilize video image content or spatial information—thus accessing information relative to scene(s) as well as a function of time.

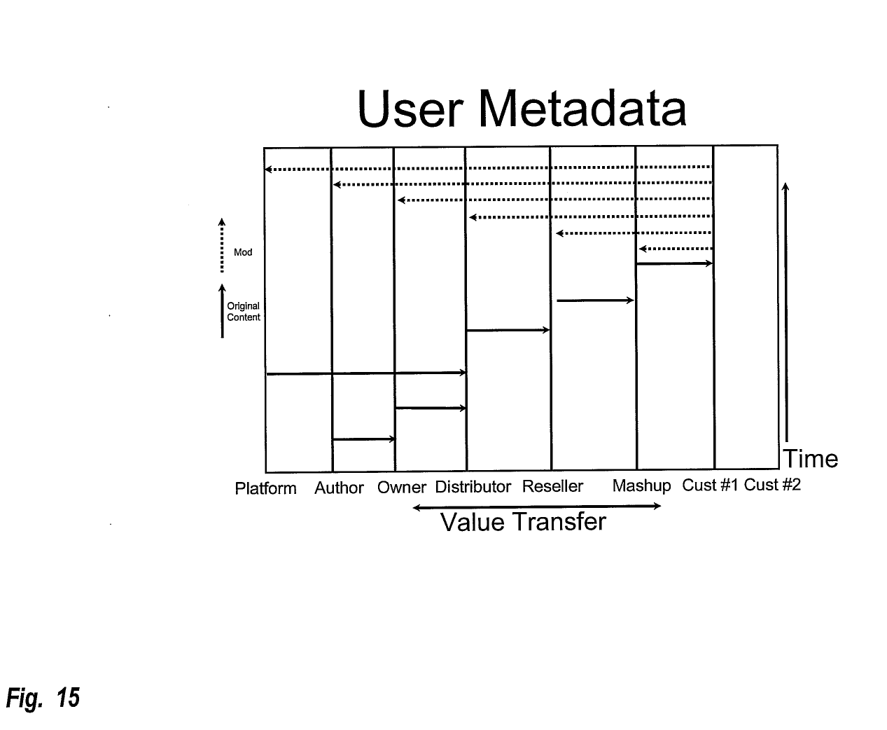

FIG. 15 illustrates an example of how value is added to the Content as data is added to a Title via the Sovereign Link. Various actors are depicted on the bottom horizontal scale, and time is depicted on the vertical scale. The Original Content is represented by solid lines and additional or modified Content is represented by dotted lines. In the example illustrated, subsequent transfers of the original Content occur (e.g., from the author to an owner, then to a distributor, and then to a reseller). It should be noted that FIG. 15 is merely illustrative of the various types of transfers that occur. In use, not all of these transfers need occur (in particular, with respect to transfers relating to modified Content). Moreover, other types of transfers are possible. Still further, these transfers can occur at various times and are not necessarily in the sequential manner depicted.

Of significance is that data, in particular User Metadata, is capable of being added at various times by various actors. This data represents potential economic opportunities. By way of example, various types of merchandising can be linked to the Title via the Sovereign Link. Content Owners (e.g., movie owners) thus gain an opportunity for additional revenue. Further the Sovereign Link provides them with access to customer blogs and other customer interaction data with respect to the Title. This latter information is of significant potential value in subsequent marketing of the movie and/or decisions as to investments in future movies.

As described above, the present invention supports the many paths the Title can take once created. One might think of the present invention as an enabler of a ‘title ecology’. Previously, title ecology was simple: each Content title is born of a Content creator, author, director and so on. The title is then matured and sent out into the world by a publisher or agent. A distributor or retailer completes the cycle when it is sold to a customer. With the digital world of the present invention, however, the sale of a Title to a customer is potentially only a beginning of a much longer, more complex story. In this digital world, the Title is never complete. The initial drafts, revisions, first publishing, subsequent “printings,” adaptations, changes, commentary, satire, reviews, error corrections, etc. are potentially all a part of the Metadata related to the Title. The present invention contains dynamic elements as well as passive media Content. These dynamic elements consist of executables for a variety of platforms that support the playback of a variety of medias. Moreover, these elements also contain the ability to establish and support business rules, capabilities and features that enable the implementation of Title history, Title ownership, Title usage, and the every changing structure of the Title.

In further embodiments of the invention, use of the Sovereign Link permits linking Metadata back to a Metadata database directly. The information in that directory contains details for every individual version of that Title sold. This enables the unique tracking of one instantiation of that Title. Further, it also creates a database which can be accessed for various issues such as validation, DRM issues, ownership transfer, etc.

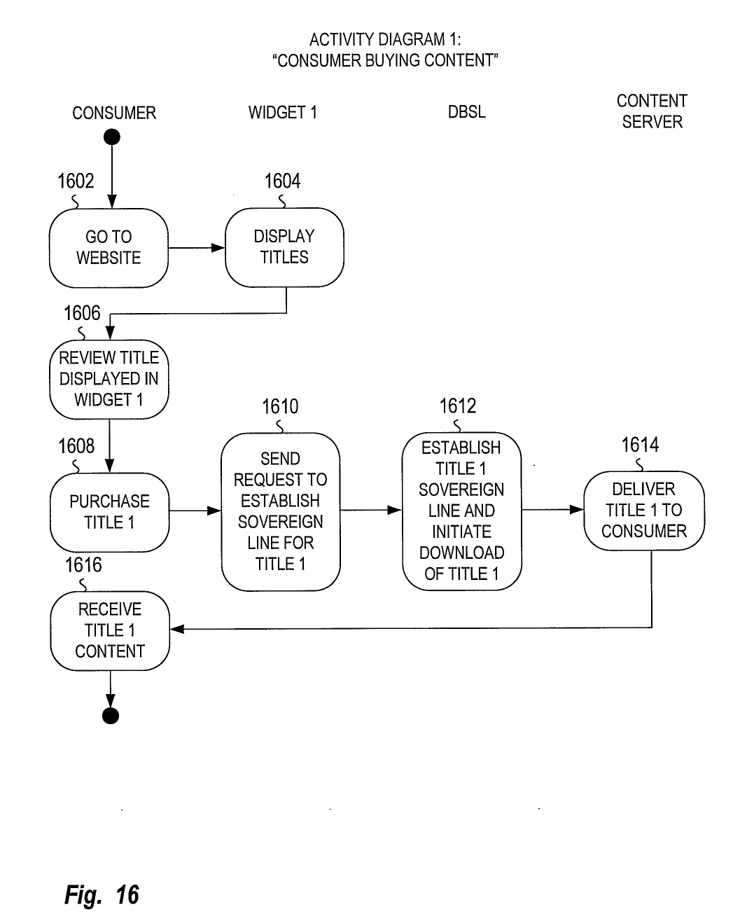

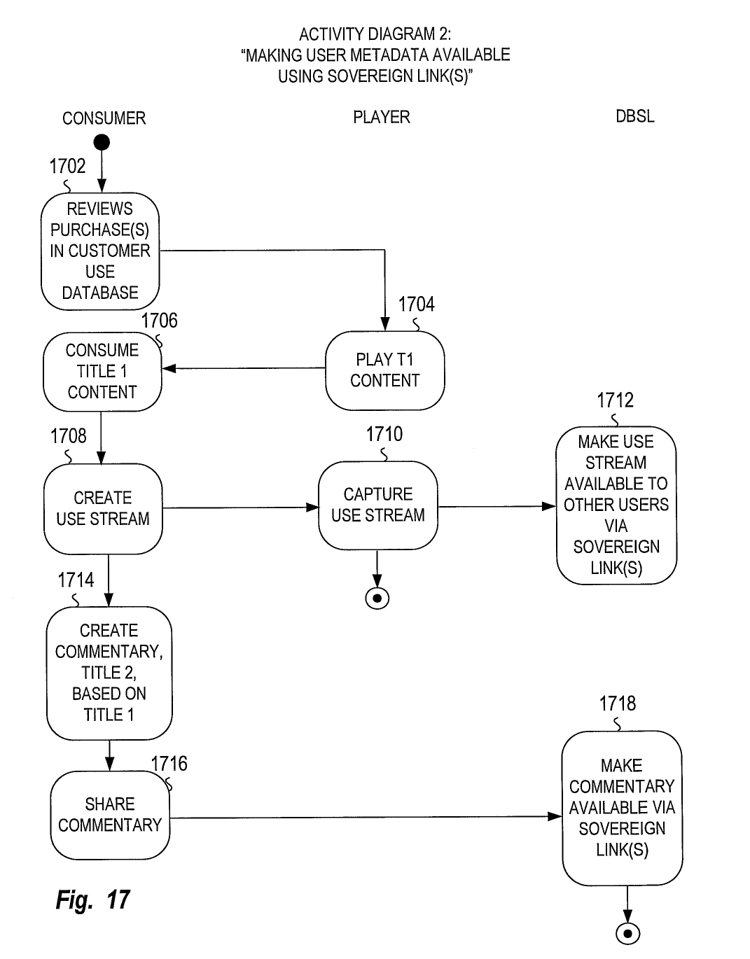

FIGS. 16 and 17 portray Activity Diagrams (depicted in Unified Modeling Language format) which illustrate various exemplary interactions of various Actors in utilizing the current invention. These Actors are:

ACTORS

Consumer 1 (C1)
Website 1 (W1)
Widget 1 (Wi1)
Database of Sovereign Links (DBSL)
eCommerce provider (eC)
Title 1 (T1)
Title 2 (T2)

The Actions which are performed include:

ACTIONS

Watch (View/Consume/Listen To)
Tag
Comment
Buy
Share

FIG. 16 depicts the following use cases, “Buying Content” and “Getting Content”:

USE CASE 1: BUYING CONTENT
T1 is part of Wi1, which is part of W1
C1 goes to W1
C1 reviews T1 displayed in Wi1
C1 purchase T1 using eC1
USE CASE 2: GETTING CONTENT
After C1 purchase T1
Wi1 sends request to database to DBSL
to establish sovereign link to T1
DBSL points to server containing Content;
initiates download/order/stream to C1
C1 receives Content, typically using helper
application on browsing device.

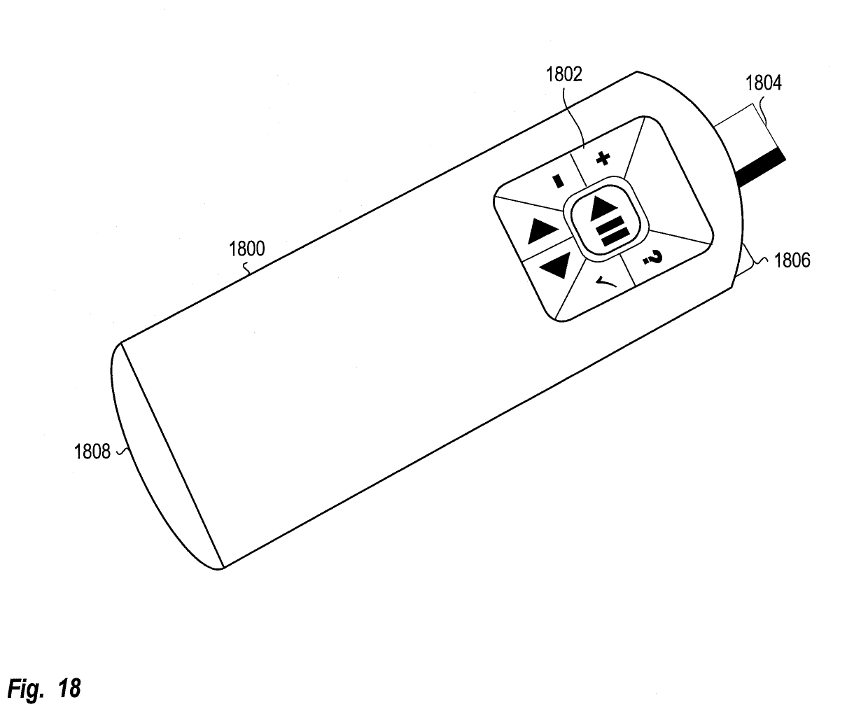

As illustrated in FIG. 16, a GUI user interface, Widget Wi1, is part of the Website (W1) which is accessed at 1602 by Consumer 1 (C1). At step 1604, Wi1 displays various titles to C1. C1 reviews Title 1 (T1) and at step 1608 purchases T1 by employing an eCommerce provider, eC (not illustrated). At step 1610, a request is sent by Wi1 to the DBSL to establish a Sovereign Link for T1. The DBSL responds to this request at step 1612 by both establishing a Sovereign Link and initiating deliver of T1 to C1. While FIG. 16 depicts that this delivery is effected by “Download” of T1, it should be noted (as discussed throughout this application) that delivery can also be performed by various alternative means, to include streaming of T1 Content and shipment of a information unit containing the Content—to include a hard copy in the case of a book, or a device containing the Content (an example of which is described below with respect to FIG. 18). Step 1614 depicts a Content Server delivering T1 to C1 and step 1616 illustrates C1 receiving it.

FIG. 17 depicts the following use cases, “Consuming Content”, “Tagging Content”, “Commenting on Content”, and “Sharing Content”:

USE CASE 3: CONSUMING CONTENT
C1 reviews purchase(s) within the customer use database
C1 consumes Content
USE CASE 4: TAGGING CONTENT
In the process of consuming T1, C1 creates a ‘use stream’ - information
including reading speed, forking decisions, time and link history.
Includes the manual and automated creation of tags that serve to
add additional structure to T1
capture of information done on the Player, browser or server upon which
T1 is being consumed
USE CASE 5: COMMENTING ON CONTENT
C1 uses tools to manipulate the data structure of T1 to create T2,
commentary that is separate from T1, but relies on T1's use
stream created when C1 consumed T1
USE CASE 6: SHARING CONTENT
C1 shares T2 which is then potentially available on all Wi(X) es
Sharing occurs when the created Content T2 is selected by C1 for sharing.
The tool used in creating Content automatically places T2, with associate
sovereign links for author, title, publisher, etc.

As illustrated in FIG. 17, C1 reviews his purchase(s) at step 1702 utilizing the Customer Use Database. At step 1704 a Player is employed by which C1 consumes the Content of T1 (step 1706). C1's manner of consuming this Content generates a Use Stream (step 1708) which is captured by the Player (step 1710) and made available to other users via one or more Sovereign Links (step 1712). At step 1714 T2, commentary, is created which is separate from T1. This commentary is potentially shared by T1 at step 1716 by being made available to other users via one or more Sovereign Links (step 1718).

FIG. 18 is a top view of an embodiment of a player device 1800 according to the present invention. Item 1802 is a touchpad by which various user functions are invoked. Item 1804 is a USB connector. Item 1806 is a SD card installed in a memory socket (not shown). Item 1808 is an output audio jack. Once a USB connection is made, power can be supplied to the depicted device through the USB port.

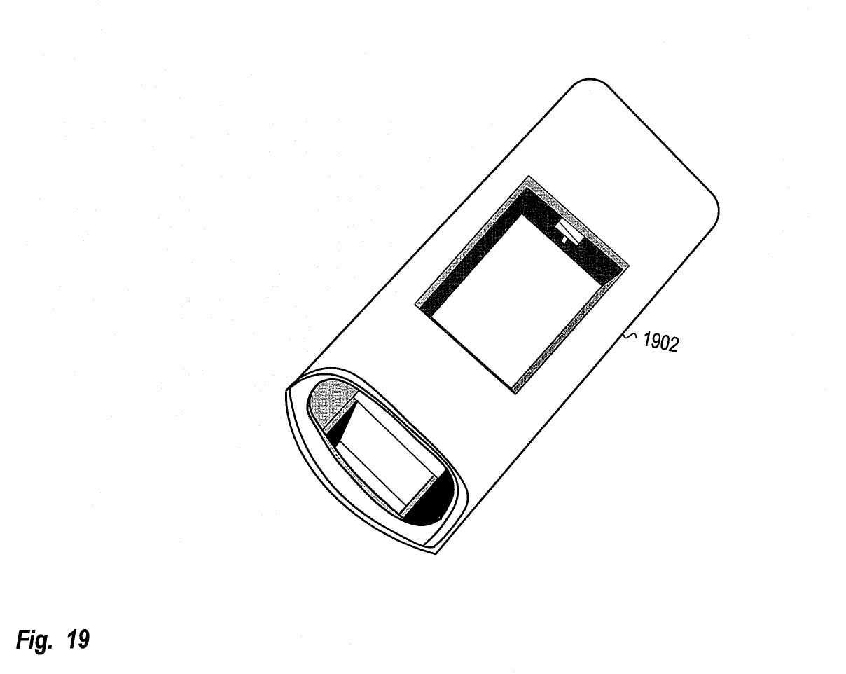

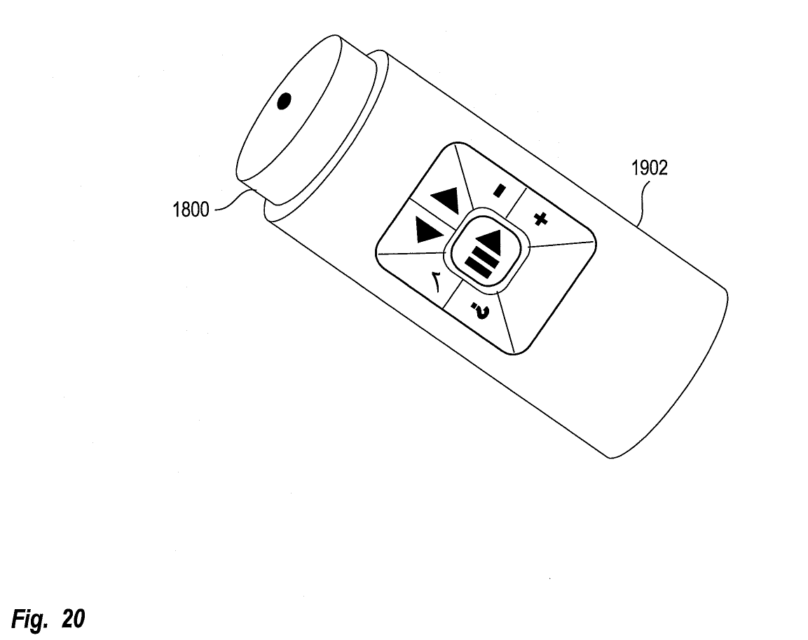

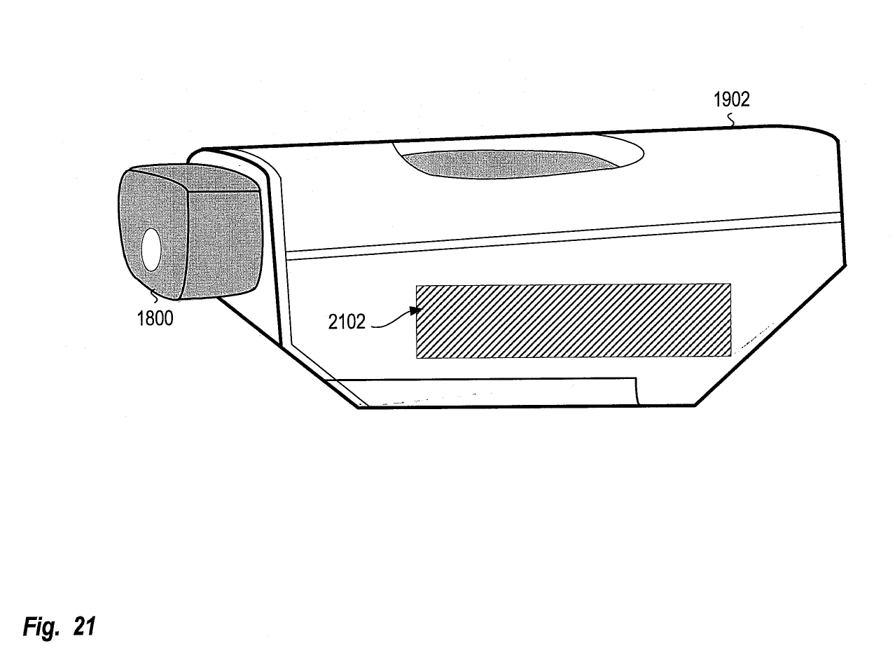

FIG. 19 depicts a sleeve 1902 into which the player 1800 can be inserted in a further embodiment of the invention. FIG. 20 is a ¾ top view of the player/sleeve combination. FIG. 21 is a side view of this combination in which a battery compartment area 2102 is referenced.

The above embodiments of the invention separate the battery compartment from the player part. Consequently, the player part of the device can plug into a device (such as a PC or Mac computer) and draw power from there, or use the battery compartment power source which feeds power into the USB connector.

As noted above, an alternative means of delivery of Content to a user employs the use of one or more Widgets. A Widget is an item which allows a customer to buy Content from any page on the Internet without needing to leave their browsing experience at the main site. By way of example, a Widget may offer sample audio, an excerpt about the Title, and a graphic. Additionally in the present invention, it allows a user to become a seller.

Widgets allow any party to offer Content for sale on any website. As contemplated herein, use of Widgets permits various means for conducting sales, those sales not being limited to transactions involving the transfer of funds but also including transaction in which other types of payment (e.g. points or redemptions) serve as the method of attribution. Uses of widgets include the ability of a publisher to sell their Content that has been converted; the ability of an individual that enjoys an item of Content to put a Widget on his blog so others can buy this Content. In general, Widgets can be used to allow anyone desiring to be paid for a form of Content to offer that content on any website.

One embodiment of the invention implements the aforementioned functionality by permitting potential users to visit a Widget registration home site. An alternate embodiment permits users to sign up for their own Widget(s) when visiting an existing Widget. In these embodiments, signing up for a Widget is accomplished by providing an e-mail address. Subsequent Widget sales can be automatically tracked and applied to the seller's account. The seller can subsequently withdraw funds by entering Paypal, Google checkout, personal banking data, or other data sufficient to facilitate a transaction.

Tracking of purchases of Content via a Widget is of the utmost importance and is provided for by a Widget management system. By way of example, money from a purchased Title via a Widget can be divided between the publisher, the seller, and one or more intermediaries. In one embodiment the creator/publisher receives 50%, the seller 20%, and the channel operator 30%. These values are exemplary only, and other values or systems which allow revenues to be divided among any number of parties. In one embodiment the Widget management system enables a seller of Widgets to view statistics showing the number of sales, amount earned, and other parameters related to each individual Widget.

The Widget management system can also facilitate signing up for a new Widget by a potential seller, either with an account management Web site or on another party's site which offers a Widget. In the latter case, an embodiment of the invention permits the user to click on a displayed icon which results in the Widget displaying two fields: an e-mail address field and a verification field (for typing in the letters/numbers from an image). Once the user does this, he is presented with a new and dynamic Widget assigned to his e-mail address. If he has an existing account, a copy of this Widget is added to his account by the Widget management system. If he does not have an existing account, he will have one created and details on logging in can be e-mailed to him. Snipped code is offered within the Widget itself which the new seller can plug in. If sales are generated from this new Widget with the new seller's account, the sales are applied to his account. The new seller can claim them when they next log in to his account or allow them to accumulate for later access.

In a further embodiment of the invention, additional security is provided in accessing a user's account via another party's site (that site offering a widget). That is, a Widget embedded in such a Web site will only display account information if the user is already logged in to the Widget management system or has their system cookied with a saved password (for a Widget accessed in an iFrame or other cookie accessible area).

As noted above, a user can access his account via the Widget management system Web site or via somebody else's site. In either event, when the user first logs in to their account, they are presented with links to useful areas and are presented with a summary of information from their Widget(s). Other options include the ability to add Widgets, remove Widgets, manage existing Widgets (e.g., change the price of a Title), and adjust payment options (along with the typical account information—password, contact information, etc.).

In the event a potential seller wishes to add one or more Widgets for sale, the Widget management system guides him in performing the necessary steps. In various embodiments these include selection of one or more Titles for sale; selection of one or more sites where his Widgets will be placed and setting prices for the selected Titles. For the selected sites, code snippets are offered which can be plugged in to embed a widget in a site. If supported, the ability to auto-submit the Widget is offered as well. Depending on the level of restriction by a selected site, varying levels of power within a Widget can be offered. For a site such as Myspace, which has significant restrictions, raw HTML for a static widget is offered. Ideally, an iFrame or embedded object is offered.

In one embodiment of the invention all offered Titles are considered to be downloadable. In a further embodiment, a chip version is offered as a backup and as an upsell. Publishers typically set a MSDP (Manufacturers Suggested Digital Price). This price is stored in the an ICDB (Inventory Control Data Base). Typically, the publisher will receive 50% of the MSDP. Administration of this price and further content details can be added to the ICDB. A seller is offered the default price for a Title, which is the MSDP. In one embodiment, the seller will earn 20% of the MSDP whenever a Title is sold from his or her widget. The seller may, at their discretion, adjust the price of the Title within that 20% range. If the price is adjusted, it has an effect only on the seller's cut. In one embodiment of the invention, the Widget management system retains the 30% of the MSDP for itself. In yet a further embodiment, a buyer of a Title via a Widget can acquire the Content on a backup SD card in addition to the downloadable version. The buyer's cost of this card is kept by the Widget management system.

The present method and system thus provides for the creation and transmission of data which contains Content as well as Metadata, and wherein the Metadata can contain multiple sets of executable code for executing the presentation of the Content and/or Metadata on the device. This allows the Content to be readily distributed to a number of operating system platforms. Delivery to a device can include streaming such as the transport of the data over the Internet to one or more devices (unicast streamed or multicast streamed information) and may also include the transcoding of material in which Content and/or Metadata is decoded/decompressed into an intermediate format and re-encoded into the target format. As an example, it may be desirable to create a new Title which incorporates a preexisting title, but which has additional content in the form of Metadata, that additional content enhancing the value of the original title in some manner. The additional content is correlated to the preexisting title in that it may be played in an appropriate time sequence (e.g. before or after the original title) or in conjunction with the time sequence or other organization of the preexisting Title including spatial organization, indexing, or other structure of the original Title. When used herein, the term play also includes interactions with Content and Titles such as making selections, answering questions, and other actions which comprise utilization of the materials contained within the Content or Titles.

Digital Rights Management (DRM) can be implemented through the use of a first identifier and a second identifier, identifiers being associated with the Storage Device, a copy of Content, a copy of a Client Application, or a Player. Playback is only authorized under proper matching of the identifiers.

Navigation features on a device can be created by placing Navigation data in the Metadata, which upon execution of appropriate playback code results in the ability to access various parts of the Content using the Navigation data.

A physical player device can be created by having a socket for receiving an Information Unit containing Content and Metadata, controls for actuating user functions and for transmitting signals corresponding to the user functions, and a microprocessor for executing code to allow playback of the Content as dictated by the signals received from the user function controls.

User generated data can be added to Content through the use of Sovereign Links in which data related to the Content (e.g. user comments) is associated with the original Content. As such, the additional data related to the Content can be authoritatively tracked and as such, becomes part of the content itself.

Integration can be performed by taking Content and creating an associated Content index describing that Content, obtaining other data (e.g. commentary) and integrating the Content and other data to create a playback index that allows the other data to be accessed in a meaningful manner and in association with the Content.

Content can be sold by a number of parties including parties who are not the original owner/producer of the content. The third party can register at a service provider to obtain a method of payment (in currency or by another mechanism (e.g. points). Widgets can be used to allow the offering to appear on a web site not controlled by the third party. In several of the embodiments described herein Content can be monetized by allowing sale of the Content or Title and associated Metadata, and distributing the payments relative to both Titles. The distribution of payments can be determined by a number of mechanisms including, but not limited to, relative popularity of the Content or Titles, relative popularity of the creator of each piece of Content or Title, the creation date of the Content or Titles, update date, media type, time parameters related to the publishing or availability of the Title, previous revenues generated by the Title, or other monetary parameters associated with the Titles.

Unless explicitly stated otherwise, each numerical value and range should be interpreted as being approximate as if the word “about” or “approximately” precedes the value of the value or range.

It will be further understood that various changes in the details, materials, and arrangements of the parts which have been described and illustrated in order to explain the nature of this invention may be made by those skilled in the art without departing from the principle and scope of the invention.

Systems and methods described herein has been described most particularly in connection with its application to Audiobooks. It should be understood, however, that whenever Audiobooks or audio data are mentioned, the systems and methods can also be applied to other forms of Content. A person having ordinary skill in the art, with the disclosure herein, will understand how to make necessary modifications to implement the features of this invention for other forms of Content, such as music, video and software.

What is claimed is:

1. A system for creating a new Title that incorporates a preexisting Title, wherein the preexisting Title comprises Content and a first associated Metadata file, and wherein the new Title comprises Content and a second associated Metadata file that has been correlated to the preexisting Title; the system comprising:
a presentation system for playing the new Title in context with the preexisting Title.

2. The creating system in claim 1 wherein the new Title is instructed to play simultaneously with the preexisting Title.

3. The creating system in claim 1 wherein the new Title is instructed to play before the preexisting Title.

4. The creating system in claim 1 wherein the new Title is instructed to play after the preexisting Title.

5. The creating system in claim 1 wherein the new Title is instructed to play at a specific time-based offset from the preexisting Title.

6. The creating system in claim 1 wherein the new Title is instructed to play at a specific spatial offset from the preexisting Title.

7. The creating system in claim 1 wherein the new Title is instructed to play based on operations executed by any given user.

8. The creating system in claim 1 wherein the new Title is instructed to play based on information in the Metadata file correlated to the preexisting Title.

9. A method for creating a new Title that incorporates a preexisting Title, wherein the preexisting Title comprises Content and a first associated Metadata file, and wherein the new Title comprises Content and a second associated Metadata file; the method comprising:
correlating the new Title to the preexisting Title, and
playing the new Title in context with the preexisting Title.

10. The method of claim 9 wherein the new Title is instructed to play simultaneously with the preexisting Title.

11. The method of claim 9 wherein the new Title is instructed to play before the preexisting Title.

12. The method of claim 9 wherein the new Title is instructed to play after the preexisting Title.

13. The method of claim 9 wherein the new Title is instructed to play at a specific time-based offset from the preexisting Title.

14. The method of claim 9 wherein the new Title is instructed to play at a specific spatial offset from the preexisting Title.

15. The method of claim 9 wherein the new Title is instructed to play based on operations executed by any given user.

16. The method of claim 9 wherein the new Title is instructed to play based on information in the Metadata file correlated to the preexisting Title.

17. A system for monetizing a Title created by combining two Titles comprising:
a) A first Title comprising Content and a first associated Metadata file;
b) A second Title comprising Content and a second associated Metadata file that has been correlated to the first Title; and,
c) a presentation system for playing the first Title in context with the second Title.

18. A method for monetizing a Title created by combining a first Title with a second Title, wherein the first Title comprises Content and a first associated Metadata file, and wherein the second Title comprises Content and a second associated Metadata file that has been correlated to the first Title; the method comprising:
playing the first Title in context with the second Title, and
distributing payments relative to both Titles.

19. The method of claim 18 wherein payments are made in part based on the relative popularity of both Titles.

20. The method of claim 18 wherein payments are made in part based on the relative popularity of the creator of each Title.

21. The method of claim 18 wherein payments are made in part based on the relative creation date of both Titles.

22. The method of claim 18 wherein payments are made in part based on the relative last updated date of both Titles.

23. The method of claim 18 wherein payments are made in part based on the media type of each Title.

24. The method of claim 18 wherein payments are made in part based on the period of time that a Title has been available, or the time remaining before a Title is withdrawn.

25. The method of claim 18 wherein payments are made in part based on the attributes of an activity or event that can be identified by the system.

26. The method of claim 18 wherein payments are made in part based on the total value of previous payment created through the monetization process.
